(19) United States
(12) Patent Application Publication
(10) Pub. No.: US 2026/0365763 A1
(43) Pub. Date: Nov. 19, 2026

(54) Gas Phase Polymerization Reactor Restart

(71) Applicant: ExxonMobil Chemical Patents Inc., Spring, TX (US)

(72) Inventors: Anne A. Bernard-Brunel, Le Havre (FR); Ryan W. Impelman, Houston, TX (US); Michael G. Tribo, Humble, TX (US); Corrine L. Brandl, Humble, TX (US); Rachel E. Masluk, Mont Belvieu, TX (US); Shayan Karimipour, Katy, TX (US)

(21) Appl. No.: 19/133,001

(22) PCT Filed: Dec. 7, 2023
(86) PCT No.: PCT/US2023/082941

§ 371 Date: May 27, 2025

Related U.S. Application Data
(60) Provisional application No. 63/476,416, filed on Dec. 21, 2022.

(51) Int. Cl. C08F 10/02

(52) U.S. Cl. CPC C08F 10/02; C08F 2400/02

(57) ABSTRACT

Provided is a method for restarting a. gas phase polymerization reactor after operational interruption to a portion of the feed and/or product withdrawal systems while producing a first polyethylene under a first set of operating conditions. The method comprises terminating the polymerization reaction using a polymerization neutralizer and terminating the addition of catalyst and monomer feed to the reactor and/or the withdrawal of the first polyethylene. The reactor is then idled by maintaining recirculation of cycle fluid to maintain fluidization of the fluidized bed. Restart is effected by adding the catalyst and monomer feed to the fluidized bed under a transitional set of polymerization conditions, and withdrawing a. transitional polyethylene for a threshold number of bed. turnovers. Rates of addition of the catalyst and monomer feed to the fluidized bed are adjusted, and a. second polyethylene is withdrawn from the reactor under a second set of operating conditions.

### CROSS-REFERENCE TO RELATED APPLICATION

This application claims the benefit of U.S. Provisional Application 63/476,416 filed on Dec. 21, 2022, entitled “Gas Phase Polymerization Reactor Restart”, the entirety of which is incorporated by reference herein.

### FIELD OF THE INVENTION

This disclosure relates to a method for restarting a gas phase polymerization process after shutdown of polymerization due to operational interruption to the reactor feed and/or product withdrawal system, wherein such restarting is implemented without emptying and/or opening the reactor.

### BACKGROUND OF THE INVENTION

In gas phase polymerization, a gaseous stream containing one or more monomers is passed through a fluidized bed under reactive conditions in the presence of a catalyst. A polymer product is withdrawn from the reactor. Fresh monomer is introduced to the reactor to replace the removed polymer product, and unreacted monomer is recycled back to the reactor. Process upsets in an ancillary system upstream and/or downstream of the reactor may require the polymerization to be shut down or “killed.”

When restarting the process, it is desirable to minimize the complexity and amount of time required for the transition back to stable operation and to minimize the amount of off-grade resin product produced. Many restart procedures are directed toward accomplishing these goals. However, typical kill procedures still often require the reactor to be opened, purged of hydrocarbons, emptied of polymer and catalyst particles, cleaned, and reloaded with the removed bed or a new bed to provide a “seed bed” of polymer. This process is time consuming, expensive, and allows impurities, such as moisture and air, to enter the reactor. Such impurities necessitate another time-consuming procedure to remove.

U.S. Pat. No. 6,838,532 discloses a method for transitioning from one catalyst system to an incompatible catalyst system, in a gas-phase reactor. In particular, the method provides terminating a first polymerization reaction and removing substantially all the contents from the first polymerization reaction without introducing contaminants into the reactor, followed by adding the components for a second polymerization reaction into the reactor without introducing contaminants and without purging the reactor, and conducting a second polymerization reaction.

U.S. Pub. No. 2015/0315315 discloses a process for stopping and restarting polymerization in a system comprising a gas phase fluidized bed or stirred bed reactor, a degassing vessel, and a seed bed storage silo. The process comprises stopping a first polymerization reaction and removing at least the majority of the first polymer from the reactor to the degassing vessel. The process is restarted by either adding a seed bed of a different material compatible with a second polymerization reaction to the reactor from the seed bed storage silo and conducting a second polymerization reaction to make a second polymer, or passing to the reactor at least a portion of the first polymer from the degassing vessel to form a new seed bed in the reactor and conducting a polymerization reaction in the reactor to produce polymer.

U.S. Pub. No. 2015/0322249 discloses a process for transitioning from the production of a first polymer to the production of a second polymer in a gas phase fluidized bed or stirred bed reactor. The process comprises conducting a first polymerization reaction in the reactor using a first catalyst system to produce a first polymer, stopping the first polymerization reaction and removing at least the majority of the polymer in the reactor, introducing into the reactor a seed bed comprising at least 50 ppm but less than 500 ppm of contaminants during storage, treating the seed-bed in the reactor to reduce the amount of contaminants, and conducting a second polymerization reaction in the reactor to produce a second polymer.

U.S. Pub. No. 2018/0079836 discloses a method for transitioning a gas phase polymerization reactor between metallocene catalysts. The method comprises reducing the superficial gas velocity and increasing the height of the fluidized bed within the reactor prior to stopping a feed comprising a first metallocene catalyst. The method further comprises introducing a first polymerization neutralizer to the reactor, wherein the first polymerization reactor does not comprise water, and then introducing a second polymerization neutralizer different from the first polymerization neutralizer. The reactor is then purged with an inert gas prior to introducing a feed comprising a second metallocene catalyst to the reactor.

Shutdown or transition procedures in gas phase polymerization reactors are often accompanied with a buildup of catalyst and polymer on the walls of the reactor, which is known as “sheeting.” Another common problem is the buildup of catalyst and polymer on the internal distribution plate, injection nozzle(s), and/or product discharge nozzle(s), which is known as “plugging” or “plate fouling.” Sheeting, fouling, and plugging can force a complete reactor shutdown for cleaning and removal of the polymer chunks, which could take several days. This undermines the efficiency of any process designed to minimize shutdown or transition time.

It is particularly difficult to control sheeting, fouling, and plugging with metallocene catalysts during reactor shutdowns or transitions because they are known to exhibit unpredictable static tendencies. For instance, EP 0 811 638 describes metallocene catalysts as exhibiting sudden erratic static charge behavior that can appear even after long periods of stable behavior. It has been found that many of the known methods of shutting down or transitioning a reactor from one catalyst to another fail to prevent sheeting and the like with transitions between or reactor start-ups with metallocene catalysts.

Gas phase polyethylene reactors running metallocene catalysts have been restarted without opening and reloading a new seed bed with success, under the condition that the seed bed (polyethylene grade being produced at unplanned shutdown) be a “standard” narrowly defined melt index and density to mitigate sheeting and/or plate fouling. With that constraint, most unplanned shutdowns require opening and cleaning the reactor to reload an acceptable seed bed. In addition to downtime and resources for such reloading, reactor start-up on such limited “standard” products requires additional time to transition other desired product grades.

There is a need for improved methods for restarting a gas phase polymerization reactor without opening the reactor and with less restrictions on polyethylene grades suitable for such reactor restarts.

### SUMMARY OF THE INVENTION

The present disclosure provides a method for restarting a gas phase polymerization process after a processing interruption. The gas phase polymerization process comprises adding a catalyst, an ethylene monomer, and optionally a comonomer and/or hydrogen, to a fluidized bed in a polymerization reaction zone under a first set of polymerization conditions and withdrawing a first polyethylene having a first density and first melt index (I₂). The method disclosed herein is applicable when the polymerization process must be shut down due to an upset in an ancillary system upstream and/or downstream of the reactor while the cycle fluid recirculation compressor is still operational.

Upon failure of an ancillary system upstream and/or downstream of the reactor requiring shutdown of the polymerization process, the method for restarting comprises terminating the polymerization reaction using a polymerization neutralizer. In some embodiments, the method further comprises terminating: the addition of the catalyst, the ethylene monomer, and the optional comonomer and/or hydrogen to the fluidized bed; terminating the withdrawal of the first polyethylene; or a combination thereof.

The method further comprises idling the polymerization zone by maintaining recirculation of cycle fluid to maintain a superficial velocity sufficient to maintain fluidization of the fluidized bed. Such idling is continued until ancillary systems upstream and/or downstream of the reactor are ready to resume normal operations.

After resolution of conditions that triggered the shutdown of the polymerization process, addition of the catalyst, the ethylene monomer, and optionally the comonomer and/or hydrogen, to the fluidized bed in the polymerization reaction zone are resumed under a transitional set of polymerization conditions, and a transitional polyethylene is withdrawn for a threshold number of bed turnovers.

The rate of addition of the catalyst, the ethylene monomer, and optionally the comonomer and/or hydrogen, to the fluidized bed in a polymerization reaction zone are adjusted and the transitional set of polymerization conditions are ramped to a second set of polymerization conditions to permit withdrawal of a second polyethylene having a second density and second melt index (I₂).

In some embodiments, the first set of polymerization conditions and the second set of polymerization conditions are associated with one or more metallocene catalysts, including, but not limited to, an unbridged bis-cyclopentadienyl Group 4 and substituted versions thereof, a bridged bis-cyclopentadienyl Group 4 and substituted versions thereof, a substituted bulky ligand hafnium transition metal metallocene-type catalyst compound and substituted versions thereof, and a dual catalyst system comprising a bridged bis-cyclopentadienyl Group 4 metal catalyst and an unbridged bis-cyclopentadienyl Group 4 metal catalyst.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying processes for carrying out the same purposes of the present invention. It should also be realized by those skilled in the art that such equivalent constructions do not depart from the spirit and scope of the invention as set forth in the appended claims. The novel features which are believed to be characteristic of the invention, both as to its structure and method of manufacture, together with further objects and advantages will be better understood from the following description.

### BRIEF DESCRIPTION OF THE DRAWINGS

FIG. 1 depicts a schematic of an illustrative gas phase polymerization system for making polymers.

While the disclosed process and system are susceptible to various modifications and alternative forms, the drawing illustrates a specific embodiment herein described in detail by way of example. It should be understood, however, that the description herein of a specific embodiment is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### DEFINITIONS

“BTO,” as used herein, means bed turnover or when the amount of fresh catalyst and monomer added to a fluidized bed of a gas phase polymerization reactor equals the volume of the fluidized bed. During a restart, prior to restarting addition of the catalyst and monomer, the fluidized bed is 100% the first polyethylene. As catalyst and monomer are added to the polymerization zone, the amount first polyethylene in the fluidized bed follows the relationship:

e⁻ⁿ=fraction of bed that is the first polyethylene,

where n is the number of BTOs, and the amount of second polyethylene in the fluidized bed follows the relationship:
l−e⁻ⁿ=fraction of the bed that is the second polyethylene,
   where n is the number of BTOs.

“Catalyst,” as used in the method disclosed herein, is the same catalyst throughout the method. That is to say, that the catalyst used for making the first polyethylene will be the same catalyst used for making the second polyethylene, and inherently any transitional polyethylene produced during the first few BTOs after restart of the polymerization process.

“Chunking,” as used herein, means agglomeration of adjacent polymer particles where such agglomeration forms polymer chunks withing the polymerization zone of the reactor. Chunking occurs when one or more sections of the reactor lose effective fluidization or mixing. Without adequate mixing, the rate of heat removal from these sections is diminished. With the diminished heat removal and continued reaction in these sections, overheating of the polymer can result. The overheating can cause agglomeration or melting or agglomeration of the polymer material, which results in the formation of solid masses, or chunks of polymer. In some cases (such as that described by DeChellis in U.S. Pat. No. 5,352,749) fluidization and mixing can be lost throughout the entire fluid bed, resulting in a large chunk comprising essentially all of the reactor contents.

“Cₙ” as used herein, and unless otherwise specified, the term means hydrocarbon(s) having n carbon atom(s) per molecule, wherein n is a positive integer.

“First polyethylene,” as used herein, refers to a polyethylene polymer product having a first density and a first melt index (I₂) and is the polymer grade being produced when shutdown of polymerization is required due operational interruption to the reactor feed and/or product withdrawal system. In the context of the method disclosed herein, the first polyethylene may also be referred to as the shutdown grade or polyethylene or the seedbed grade or polyethylene. The first polyethylene is associated with a first set of polymerization conditions including one or more of a first reactor temperature, a first reactor pressure, a first ethylene monomer feed rate, a first comonomer type and feed rate, a first catalyst type and feed rate, a first comonomer/ethylene (C₂^{═}) mol ratio, a first rate of addition of hydrogen, a first hydrogen (H₂)/ethylene (C₂^{═}) mol ratio, a first amount of one or more induced condensing agents, a first delta melt initiation temperature (dMIT), and a first amount of one or more continuity additives. In some embodiments, a polymerization condition parameter includes a tolerance above and below the specified value to form a range for such parameter. Tolerances and/or the ranges are set to accommodate normal fluctuations in a controlled polymerization process while still producing a first polymer that meets the product grade specifications for such polyethylene product.

“Fluidized seed bed,” as used herein, a polymer product in the fluidized bed of a gas phase polymerization reactor at the time of a shutdown of the polymerization process. The fluidized seed bed remains in the fluidized state while the reactor is idled with the cycle fluid recirculating.

“Fouling,” as used herein, means agglomeration of adjacent polymer particles where such agglomeration forms resin deposits in holes, piping, and/or tubing that restrict flow in the reactor system. Distributor plate fouling is one of the leading causes of downtime with commercial fluidized bed polymerization reactor systems. Fouling is generally caused by deposition of polymer resin in the numerous small holes in the distributor plate, resulting in reduced fluid flow therethrough or complete blockage thereof. Good mixing of the fluidized bed is needed for uniform temperature control. As the holes in the distributor plate become partially or fully blocked, the ability of the cycle gas entering the fluidized bed to carry heat away from the reacting materials is reduced. Moreover, “hot spots” can develop in areas of low fluid velocity in the fluidized bed (particularly those areas immediately above the partially or fully blocked holes), leading to chunking. Fouling may also occur in the cycle line and/or cycle fluid exchanger.

“Idling,” as used herein, means maintaining circulation in the reactor system to maintain a fluidized bed in the reactor. In some embodiments, idling can include a brief period wherein the cycle fluid compressor is shut down and the bed in the reactor is slumped. Preferably, the period of compressor shutdown is less than 6 hours, 4 hours, or 2 hours. In other embodiments, idling includes no period in which the cycle fluid compressor is shutdown, and no period of time in which the bed in the reactor is slumped.

“Induced condensing agent (ICA),” as used herein, means one or more inert condensable fluids which are readily volatile liquid hydrocarbons, which may be selected from saturated hydrocarbons containing from 2 to 10 carbon atoms, preferably 3 to 10 carbon atoms. Some suitable saturated hydrocarbons are propane, n-butane, isobutane, n-pentane, isopentane, neopentane, n-hexane, isohexane, and other saturated C₆ hydrocarbons, n-heptane, n-octane and other saturated C₇ and C₈ hydrocarbons or mixtures thereof. A class of preferred inert condensable hydrocarbons are C₅ and C₆ saturated hydrocarbons. Another class of preferred hydrocarbons are C₄ to C₆ saturated hydrocarbons. Preferred hydrocarbons for use as condensable fluids include pentanes, such as isopentane. The condensable fluids may also include polymerizable condensable comonomers such as olefins, diolefins or mixtures thereof including some of the monomers mentioned herein which may be partially or entirely incorporated in the polymer product.

“Kill temperature (Tₖ),” as used herein, means a temperature which is a threshold value below the melting temperature (Tₘ). The kill temperature (Tₖ) is the temperature at which the polymerization reaction will be terminated in order to prevent reaching the melting temperature (Tₘ). The threshold value can vary based on polyethylene grade, particular reactor configurations, and/or preference of the operator of a particular reactor. In some embodiments, the threshold value is 9 °F (5.0 °C), 10 °F (5.6 °C), 11 °F (6.1 °C), or 12 °F (6.7 °C).

“Melting temperature (Tₘ),” as used herein, means that temperature at which a polymer (polyethylene) begins to melt and/or becomes sticky, thus creating a risk of agglomeration of the polymer particles, in particular, creating a risk of sheeting.

“Olefin,” alternatively referred to as “alkene,” is a linear, branched, or cyclic compound of carbon and hydrogen having at least one double bond. For purposes of this specification and the claims appended thereto, when a polymer or copolymer is referred to as “comprising” an olefin, the olefin present in such polymer or copolymer is the polymerized form of the olefin. For example, when a copolymer is described as having an “ethylene” content of 35 wt. % to 55 wt. %, it is understood that the mer unit in the copolymer is derived from ethylene in the polymerization reaction and the derived units are present at 35 wt. % to 55 wt. %, based upon the weight of the copolymer.

“Operating temperature (Tₒₚ),” as used herein, means the target operating temperature for the polymerization zone in a gas phase reactor to produce a desired grade of polyethylene. The operating temperature (Tₒₚ) is the target reactor temperature of within the set of polymerization conditions associated with the desired grade of polyethylene. The operating temperature (Tₒₚ) is a threshold value below the kill temperature (Tₖ). Operating Temperature (Tₒₚ) is the temperature at which the polymerization reaction is operated in order to prevent reaching the kill temperature (Tₖ). The threshold value can vary based on one or more of polyethylene grade, particular reactor configurations, and/or preference of the operator of a particular reactor. In some embodiments, the threshold value is 14 °F (7.8 °C), 15 °F (8.3 °C), 16 °F (8.9 °C), or 17 °F (9.4 °C).

“Operational interruption,” as used herein, means an upset in an ancillary system upstream and/or downstream of the reactor. Said another way, an operational interruption is a deviation from routine steady state operations and/or planned changes to operation of the polymerization zone in a gas phase reactor to produce a desired grade of polyethylene. In some embodiments, the deviation can include, but not be limited to, one or more of a higher than expected flow of one or more inputs to the reactor, a lower than expected or loss of flow of one or more inputs to the reactor, a higher than expected flow of one or more withdrawals from the reactor, a lower than expected or loss of flow of one or more withdrawals from the reactor. Such deviation can be caused by one or more of failure of mechanical equipment, failure of electrical equipment, failure of instrumentation, failure of control systems, and/or operator error.

“Polyethylene,” as used herein, means an ethylene homopolymer or a copolymer comprising at least 89 wt. % ethylene. The terms “polyethylene polymer,” “polyethylene,” “ethylene polymer,” “ethylene copolymer,” and “ethylene-based polymer” have the same meaning as polyethylene copolymer, except where otherwise indicated (e.g. where a polyethylene homopolymer is referred to, this means a polymer formed from ethylene monomer without comonomer units, e.g., 100 wt % ethylene-derived units).

A “polyethylene grade” is a discrete polyethylene product having a consistent set of properties and is produced using the same catalyst and a unique set of polymerization conditions. “Polyethylene grade slate,” as used herein, means a discrete number of polyethylene products produced in a selected polymerization reaction zone, wherein each polyethylene product has a consistent set of properties and is produced using the same catalyst and a unique set of polymerization conditions.

“Polymerization conditions,” as used herein, means conditions conducive to the reaction of one or more olefin monomers when contacted with an activated olefin polymerization catalyst to produce a polyolefin polymer, including a skilled artisan's selection of temperature, pressure, reactant concentrations, optional solvent/diluents, reactant mixing/addition parameters, and other conditions within at least one polymerization reactor.

“Reactor restart,” as used herein, means starting polymerization using a first polyethylene, without opening the reactor, as a fluidized seed bed for initiating the process of polymerization of the second polyethylene.

“Reactor start-up,” as used herein, means starting-up production after opening a reactor and loading a new seedbed into the polymerization zone.

“Reactor system,” as used herein, means the reactor and piping and equipment containing the circulating loop of cycle fluid, including, but not limited to, the cycle fluid heat exchanger.

“Second polyethylene,” as used herein, refers to a polyethylene polymer product having to a second density and a second melt index (I₂) and is the polymer grade to be produced after idling the reactor when shutdown of polymerization was required due operational interruption to the reactor feed and/or product withdrawal system (that is, the target polymer grade for production upon start-up of the reactor after said shutdown). In the context of the method disclosed herein, the second polyethylene may also be referred to as the startup grade of polyethylene or the target grade of polyethylene. The second polyethylene is associated with a second set of polymerization conditions including one or more of a second reactor temperature, a second reactor pressure, a second ethylene monomer feed rate, a second comonomer type and feed rate, a second catalyst type and feed rate, a second comonomer/ethylene (C₂^{═}) mol ratio, a second rate of addition of hydrogen, a second hydrogen (H₂)/ethylene ((C₂^{═})) mol ratio, a second amount of one or more induced condensing agents, a second delta melt initiation temperature (dMIT), and a second amount of one or more continuity additives. In some embodiments, a polymerization condition parameter includes a tolerance above and below the specified value to form a range for such parameter. Tolerances and/or the ranges are set to accommodate normal fluctuations in a controlled polymerization process while still producing a second polymer that meets the product grade specifications for such polyethylene product.

“Sheeting,” as used herein, means agglomeration of adjacent polymer particles where such agglomeration forms polymer sheets. In sheeting tacky particles gather on a surface of the reactor system, such as the walls and/or dome of the reactor vessel, forming a sheet of polymer particles. Progressive cycles in this process may eventually result in the growth of the sheet and its falling into the fluid bed. These sheets can interrupt fluidization, circulation of gas and withdrawal of the product from the reactor and may require a reactor shutdown for removal.

“Shutdown” of polymerization reactor, polymerization, or polymerization reaction zone generally refers to cessation of polymer production, and especially on-grade polymer production, but note that a reactor can be “idling” even after shutdown (that is, shutdown, as used herein, does not necessarily mean halting operation of all components of the reactor system, unless noted otherwise).

### Polymerization Process

The present disclosure provides a method for restarting a gas phase polymerization process after a processing interruption. During normal operations, a gas phase polymerization process comprises continuous addition of a catalyst, ethylene monomer, and optionally one or more comonomers and/or hydrogen, to a fluidized bed in a polymerization reaction zone under a first set of polymerization conditions and withdrawing a first polyethylene having a first density and first melt index (I₂). The method disclosed herein is applicable when the polymerization process must be shut down due to an upset in an ancillary system upstream and/or downstream of the reactor while the cycle fluid recirculation compressor is still operational.

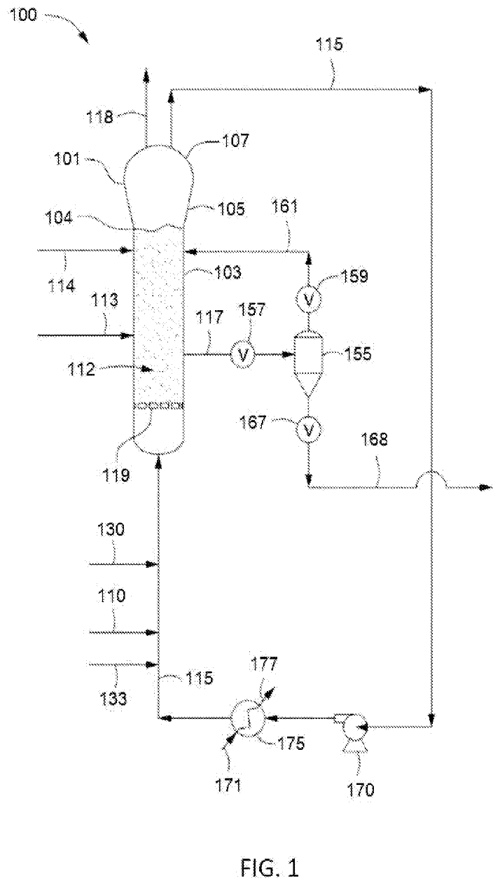

FIG. 1 depicts a flow diagram of an illustrative gas phase polymerization system 100 for making polymers, according to one or more embodiments. The polymerization system 100 can include a reactor 101 in fluid communication with one or more discharge tanks 155 (only one shown), compressors 170 (only one shown), and heat exchangers 175 (only one shown). The polymerization system 100 can also include more than one reactor 101 arranged in series, parallel, or configured independent from the other reactors, each reactor having its own associated discharge tanks 155, compressors 170, and heat exchangers 175, or alternatively, sharing any one or more of the associated discharge tanks 155, compressors 170, and heat exchangers 175. For simplicity and ease of description, the polymerization system 100 will be further described in the context of a single reactor train.

The reactor 101 can include a cylindrical section 103, a transition section 105, and a velocity reduction zone or dome 107. The cylindrical section 103 is disposed adjacent the transition section 105. The transition section 105 can expand from a first diameter that corresponds to the diameter of the cylindrical section 103 to a larger diameter adjacent the dome 107. As mentioned above, the location or junction at which the cylindrical section 103 connects to the transition section 105 is referred to as the “neck” or the “reactor neck” 104. The dome 107 has a bulbous shape. One or more cycle fluid lines 115 and vent lines 118 can be in fluid communication with the top head 107. The reactor 101 can include the fluidized bed 112 in fluid communication with the top head 107.

In general, the height to diameter ratio of the cylindrical section 103 can vary in the range of from about 2:1 to about 5:1. The range, of course, can vary to larger or smaller ratios and depends, at least in part, upon the desired production capacity and/or reactor dimensions. The cross-sectional area of the dome 107 is typically within the range of from about 2 to about 3 multiplied by the cross-sectional area of the cylindrical section 103.

The velocity reduction zone or dome 107 has a larger inner diameter than the fluidized bed 112. As the name suggests, the velocity reduction zone 107 slows the velocity of the gas due to the increased cross-sectional area. This reduction in gas velocity allows particles entrained in the upward moving gas to fall back into the bed, allowing primarily only gas to exit overhead of the reactor 101 through the cycle fluid line 115. The cycle fluid recovered via line 115 can contain less than about 10 wt %, less than about 8 wt %, less than about 5 wt %, less than about 4 wt %, less than about 3 wt %, less than about 2 wt %, less than about 1 wt %, less than about 0.5 wt %, or less than about 0.2 wt % of the particles entrained in fluidized bed 112.

The reactor feed via line 110 can be introduced to the polymerization system 100 at any point. For example, the reactor feed via line 110 can be introduced to the cylindrical section 103, the transition section 105, the velocity reduction zone 107, to any point within the cycle fluid line 115, or any combination thereof. Preferably, the reactor feed 110 is introduced to the cycle fluid in line 115 before or after the heat exchanger 175. In the FIGURE, the reactor feed via line 110 is depicted entering the cycle fluid in line 115 after the heat exchanger 175. The catalyst feed via line 113 can be introduced to the polymerization system 100 at any point. Preferably the catalyst feed via line 113 is introduced to the fluidized bed 112 within the cylindrical section 103.

The cycle fluid via line 115 can be compressed in the compressor 170 and then passed through the heat exchanger 175 where heat can be exchanged between the cycle fluid and a heat transfer medium. For example, during normal operating conditions a cool or cold heat transfer medium via line 171 can be introduced to the heat exchanger 175 where heat can be transferred from the cycle fluid in line 115 to produce a heated heat transfer medium via line 177 and a cooled cycle fluid via line 115. In another example, during idling of the reactor 101 a warm or hot heat transfer medium via line 171 can be introduced to the heat exchanger 175 where heat can be transferred from the heat transfer medium to the cycle fluid in line 115 to produce a cooled heat transfer medium via line 177 and a heated cycle fluid via line 115. The terms “cool heat transfer medium” and “cold heat transfer medium” refer to a heat transfer medium having a temperature less than the fluidized bed 112 within the reactor 101. The terms “warm heat transfer medium” and “hot heat transfer medium” refer to a heat transfer medium having a temperature greater than the fluidized bed 112 within the reactor 101. The heat exchanger 175 can be used to cool the fluidized bed 112 or heat the fluidized bed 112 depending on the particular operating conditions of the polymerization system 100, e.g., reactor start-up, normal operation, idling, and shut down. Illustrative heat transfer mediums can include, but are not limited to, water, air, glycols, or the like. It is also possible to locate the compressor 170 downstream from the heat exchanger 175 or at an intermediate point between several heat exchangers 175.

After cooling, all or a portion of the cycle fluid via line 115 can be returned to the reactor 101. The cooled cycle fluid in line 115 can absorb the heat of reaction generated by the polymerization reaction. The heat transfer medium in line 171 can be used to transfer heat to the cycle fluid in line 115 thereby introducing heat to the polymerization system 100 rather than removing heat therefrom. The heat exchanger 175 can be of any type of heat exchanger. Illustrative heat exchangers can include, but are not limited to, shell and tube, plate and frame, U-tube, and the like. For example, the heat exchanger 175 can be a shell and tube heat exchanger where the cycle fluid via line 115 can be introduced to the tube side and the heat transfer medium can be introduced to the shell side of the heat exchanger 175. If desired, several heat exchangers can be employed, in series, parallel, or a combination of series and parallel, to lower or increase the temperature of the cycle fluid in stages.

Preferably, the cycle gas via line 115 is returned to the reactor 101 and to the fluidized bed 112 through fluid distributor plate (“plate”) 119. The plate 119 is preferably installed at the inlet to the reactor 101 to prevent polymer particles from settling out and agglomerating into a solid mass and to prevent liquid accumulation at the bottom of the reactor 101 as well to facilitate easy transitions between processes which contain liquid in the cycle stream 115 and those which do not and vice versa. Although not shown, the cycle gas via line 115 can be introduced into the reactor 101 through a deflector disposed or located intermediate an end of the reactor 101 and the distributor plate 119.

The catalyst feed via line 113 can be introduced to the fluidized bed 112 within the reactor 101 through one or more injection nozzles (not shown) in fluid communication with line 113. The catalyst feed is preferably introduced as pre-formed particles in one or more liquid carriers (i.e., a catalyst slurry). Suitable liquid carriers can include mineral oil and/or liquid or gaseous hydrocarbons including, but not limited to, propane, butane, isopentane, hexane, heptane octane, or mixtures thereof. A gas that is inert to the catalyst slurry such as, for example, nitrogen or argon can also be used to carry the catalyst slurry into the reactor 101. In one example, the catalyst can be a dry powder. In another example, the catalyst can be dissolved in a liquid carrier and introduced to the reactor 101 as a solution. The catalyst via line 113 can be introduced to the reactor 101 at a rate sufficient to maintain polymerization of the monomer(s) therein. Hydrogen is added via line 114.

Fluid via line 161 can be separated from a polymer product recovered via line 117 from the reactor 101. The fluid can include unreacted monomer(s), hydrogen, induced condensing agents (ICAs), and/or inerts. The separated fluid can be introduced to the reactor 101. The separated fluid can be introduced to the recycle line 115 (not shown). The separation of the fluid can be accomplished when fluid and product leave the reactor 101 and enter the product discharge tanks 155 (one is shown) through valve 157, which can be, for example, a ball valve designed to have minimum restriction to flow when opened. Positioned above and below the product discharge tank 155 can be conventional valves 159, 167. The valve 167 allows passage of product therethrough. For example, to discharge the polymer product from the reactor 101, valve 157 can be opened while valves 159, 167 are in a closed position. Product and fluid enter the product discharge tank 155. Valve 157 is closed and the product is allowed to settle in the product discharge tank 155. Valve 159 is then opened permitting fluid to flow via line 161 from the product discharge tank 155 to the reactor 101. Valve 159 can then be closed and valve 167 can be opened and any product in the product discharge tank 155 can flow into and be recovered via line 168. Valve 167 can then be closed. Although not shown, the product via line 168 can be introduced to a plurality of purge bins or separation units, in series, parallel, or a combination of series and parallel, to further separate gases and/or liquids from the product. The particular timing sequence of the valves 157, 159, 167, can be accomplished by use of conventional programmable controllers which are well known in the art.

Another preferred product discharge system which can be alternatively employed is that disclosed in U.S. Pat. No. 4,621,952. Such a system employs at least one (parallel) pair of tanks comprising a settling tank and a transfer tank arranged in series and having the separated gas phase returned from the top of the settling tank to a point in the reactor near the top of the fluidized bed.

The reactor 101 can be equipped with one or more vent lines 118 to allow venting the bed during start up, idling, and/or shut down. The reactor 101 can be free from the use of stirring and/or wall scraping. The cycle line 115 and the elements therein (compressor 170, heat exchanger 175) can be smooth surfaced and devoid of unnecessary obstructions so as not to impede the flow of cycle fluid or entrained particles.

The conditions for polymerizations vary depending upon the monomers, catalysts, catalyst systems, and equipment availability. The specific conditions are known or readily derivable by those skilled in the art. For example, the temperatures can be within the range of from about −10 °C to about 140 °C, often about 15 °C to about 120 °C, and more often about 70 °C to about 110 °C Pressures can be within the range of from about 10 kPag to about 10,000 kPag, such as about 500 kPag to about 5,000 kPag, or about 1,000 kPag to about 2,200 kPag, for example.

### Catalyst Systems

The term “catalyst system” includes at least one “catalyst component” and at least one “activator,” alternately at least one co-catalyst. The catalyst system can also include other components, such as supports, and is not limited to the catalyst component and/or activator alone or in combination. The catalyst system can include any number of catalyst components in any combination as described, as well as any activator in any combination as described.

The term “catalyst component” includes any compound that, once appropriately activated, is capable of catalyzing the polymerization or oligomerization of olefins. Preferably, the catalyst component includes at least one Group 3 to Group 12 atom and optionally at least one leaving group bound thereto. The term “leaving group” refers to one or more chemical moieties bound to the metal center of the catalyst component that can be abstracted from the catalyst component by an activator, thereby producing the species active towards olefin polymerization or oligomerization. Suitable activators are described in detail below.

As used herein, in reference to Periodic Table “Groups” of Elements, the “new” numbering scheme for the Periodic Table Groups are used as in the CRC Handbook of Chemistry and Physics (David R. Lide, ed., CRC Press 81st ed. 2000).

Suitable metallocene catalyst compounds can include, but are not limited to, metallocenes described in U.S. Pat. Nos. 7,179,876; 7,169,864; 7,157,531; 7,129,302; 6,995,109; 6,958,306; 6,884,748; 6,689,847; 5,026,798; 5,703,187; 5,747,406; 6,069,213; 7,244,795; 7,579,415; U.S. Patent Application Publication No. 2007/0055028; and WO Publications WO 97/22635; WO 00/699/22; WO 01/30860; WO 01/30861; WO 02/46246; WO 02/50088; WO 04/022230; WO 04/026921; and WO 06/019494.

As used herein, the terms “activator” refers to any compound or combination of compounds, supported or unsupported, which can activate a catalyst compound or component, such as by creating a cationic species of the catalyst component. For example, this can include the abstraction of at least one leaving group (the “X” group in the single site catalyst compounds described herein) from the metal center of the catalyst compound/component. Activators can include Lewis acids such as cyclic or oligomeric poly(hydrocarbylaluminum oxides) and so called non-coordinating activators (“NCA”) (alternately, “ionizing activators” or “stoichiometric activators”), or any other compound that can convert a neutral metallocene catalyst component to a metallocene cation that is active with respect to olefin polymerization. Illustrative Lewis acids include, but are not limited to, aluminoxane (e.g., methylaluminoxane “MAO”), modified aluminoxane (e.g., modified methylaluminoxane “MMAO” and/or tetraisobutyldialuminoxane “TIBAO”), and alkylaluminum compounds. Ionizing activators (neutral or ionic) such as tri (n-butyl)ammonium tetrakis(pentafluorophenyl)boron may be also be used. Further, a trisperfluorophenyl boron metalloid precursor may be used. Any of those activators/precursors can be used alone or in combination with the others. There are a variety of methods for preparing aluminoxane and modified aluminoxanes known in the art.

The catalyst compositions can include a support material or carrier. As used herein, the terms “support” and “carrier” are used interchangeably and are any support material, including a porous support material, for example, talc, inorganic oxides, and inorganic chlorides. The catalyst component(s) and/or activator(s) can be deposited on, contacted with, vaporized with, bonded to, or incorporated within, adsorbed or absorbed in, or on, one or more supports or carriers. Other support materials can include resinous support materials such as polystyrene, functionalized or crosslinked organic supports, such as polystyrene divinyl benzene polyolefins or polymeric compounds, zeolites, clays, or any other organic or inorganic support material and the like, or mixtures thereof

Inorganic oxides supports can include Group 2, 3, 4, 5, 13 or 14 metal oxides. The preferred supports include silica, which may or may not be dehydrated, fumed silica, alumina, silica-alumina and mixtures thereof. Other useful supports include magnesia, titania, zirconia, magnesium chloride, montmorillonite, phyllosilicate, zeolites, talc, clays, and the like. Also, combinations of these support materials may be used, for example, silica-chromium, silica-alumina, silica-titania and the like. Additional support materials may include those porous acrylic polymers described in EP 0 767 184, which is incorporated herein by reference.

The polymer product(s) produced in the reactor can be or include any type of polymer or polymeric material. For example, the polymer product can include homopolymers of olefins (e.g., homopolymers of ethylene), and/or copolymers, terpolymers, and the like of olefins, particularly ethylene, and at least one other olefin. Illustrative polymers can include, but are not limited to, polyolefins, polyamides, polyesters, polycarbonates, polysulfones, polyacetals, polylactones, acrylonitrile-butadiene-styrene polymers, polyphenylene oxide, polyphenylene sulfide, styrene-acrylonitrile polymers, styrene maleic anhydride, polyimides, aromatic polyketones, or mixtures of two or more of the above. Suitable polyolefins can include, but are not limited to, polymers comprising one or more linear, branched or cyclic C₂ to C₄₀ olefins, preferably polymers comprising propylene copolymerized with one or more C₃ to C₄₀ olefins, preferably a C₃ to C₂₀ alpha olefin, more preferably C₃ to C₁₀ alpha-olefins. More preferred polyolefins include, but are not limited to, polymers comprising ethylene including but not limited to ethylene copolymerized with a C₃ to C₄₀ olefin, preferably a C₃ to C₂₀ alpha olefin, more preferably propylene and or butene.

### Polymer Products

Preferred polymers include homopolymers or copolymers of C₂ to C₄₀ olefins, preferably C₂ to C₂₀ olefins, preferably a copolymer of an alpha-olefin and another olefin or alpha-olefin (ethylene is defined to be an alpha-olefin for purposes of this invention). Preferably, the polymers are or include homo polyethylene, homo polypropylene, propylene copolymerized with ethylene and or butene, ethylene copolymerized with one or more of propylene, butene or hexene, and optional dienes. Preferred examples include thermoplastic polymers such as ultra low density polyethylene, very low density polyethylene (“VLDPE”), linear low density polyethylene (“LLDPE”), low density polyethylene (“LDPE”), medium density polyethylene (“MDPE”), high density polyethylene (“HDPE”), polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and blends of thermoplastic polymers and elastomers, such as for example, thermoplastic elastomers and rubber toughened plastics.

Polyethylene polymers produced in a gas phase polymerization process are characterized by a number of parameters, including, but not limited to, density, melt index (I₂), high load melt index (I₂₁ or HLMI), melt index ratio (MIR), number average molecular weight (Mₙ), weight average molecular weight (M_{w}), Z-average molecular weight (M_{z}), molecular weight distribution (M_{w}/Mₙ or MWD), the ratio of the Z-average molecular weight to the weight average molecular weight (M_{z}/M_{w}), composition distribution melt index, and branching index (g′). These parameters are related to physical characteristics of polymer chains, including, but not limited to, lengths of polymer chains, distribution of lengths of polymer chains, comonomer distribution among and along polymer chains, and length and number of branches on polymer chains. These physical characteristics of polymer chains lead to different mechanical properties that make different polyethylene polymers suitable for a broad range of end-use applications.

Polymerization conditions in a fluidized bed in a polymerization reaction zone can be controlled both to produce polyethylene polymers having a desired combination of parameters and to maintain the stability of polymerization reaction in a gas phase reactor. Such polymerization conditions include, but are not limited to, reactor temperature, reactor pressure, ethylene monomer feed rate, comonomer type and feed rate, catalyst type and feed rate, comonomer-to-ethylene ratio, rate of addition of hydrogen, an amount of one or more induced condensing agents, an amount of one or more continuity additives, and delta melt initiation temperature (dMIT; see U.S. Pat. No. 7,683,140, the contents of which are fully incorporated by reference herein).

Polyethylene producers typically identify each polyethylene polymer having a particular set of properties by a grade name and/or number. Density and melt index (I₂) are generally key parameters associated with each polyethylene polymer grade. For the producer, each such polyethylene polymer grade is associated with a particular set of polymerization conditions.

### Continuity Additive/Static Control Agent

In gas-phase polyethylene production processes, it may be desirable to use one or more static control agents to aid in regulating static levels in the reactor. As used herein, a static control agent is a chemical composition which, when introduced into a fluidized bed reactor, may influence or drive the static charge (negatively, positively, or to zero) in the fluidized bed. The specific static control agent used may depend upon the nature of the static charge, and the choice of static control agent may vary dependent upon the polymer being produced and the single site catalyst compounds being used.

Control agents such as aluminum stearate may be employed. The static control agent used may be selected for its ability to receive the static charge in the fluidized bed without adversely affecting productivity. Other suitable static control agents may also include aluminum distearate, ethoxylated amines, and anti-static compositions such as those provided by Innospec Inc. under the trade name OCTASTAT. For example, OCTASTAT 2000 is a mixture of a polysulfone copolymer, a polymeric polyamine, and oil soluble sulfonic acid.

Any of the mentioned control agents may be employed either alone or in combination as a control agent. For example, the carboxylate metal salt may be combined with an amine containing control agent (e.g., a carboxylate metal salt with any family member belonging to the KEMAMINE® (available from Crompton Corporation) or ATMER® (available from ICI Americas Inc.) family of products).

Other useful continuity additives include ethyleneimine additives useful in embodiments disclosed herein may include polyethyleneimines having the following general formula: —(CH₂—CH₂—NH)ₙ—, where n may be from about 10 to about 10,000. The polyethyleneimines may be linear, branched, or hyper branched (e.g., forming dendritic or arborescent polymer structures). They can be a homopolymer or copolymer of ethyleneimine or mixtures thereof (referred to as polyethyleneimine(s) hereafter). Although linear polymers represented by the chemical formula —(CH₂—CH₂—NH)ₙ— may be used as the polyethyleneimine, materials having primary, secondary, and tertiary branches can also be used. Commercial polyethyleneimine can be a compound having branches of the ethyleneimine polymer.

### First Polyethylene

A first polyethylene is characterized by a first density and a first melt index (I₂) and is the polymer grade being produced when shutdown of polymerization is required due operational interruption to the reactor feed and/or product withdrawal system. In the context of the method disclosed herein, the first polyethylene may also be referred to as the shutdown grade or polyethylene or the seedbed grade or polyethylene. In some embodiments, the first polyethylene is further characterized by one or more of a first high load melt index (I₂₁ or HLMI), a first melt index ratio (MIR), a first number average molecular weight (M_{z}), a first weight average molecular weight (M_{w}), a first Z-average molecular weight (M_{w}), a first molecular weight distribution (M_{w}/Mₙ or MWD), a first ratio of the Z-average molecular weight to the weight average molecular weight (M_{z}/M_{w}), a first composition distribution melt index, and a first branching index (g′). The same catalyst is used for production of both the first and second polyethylenes.

The first polyethylene is associated with a first set of polymerization conditions including one or more of a first reactor temperature, a first reactor pressure, a first ethylene monomer feed rate, a first comonomer type and feed rate, a first catalyst type and feed rate, a first comonomer/ethylene (C₂^{═}) mol ratio, a first rate of addition of hydrogen, a first hydrogen (H₂)/ethylene (C₂^{═}) mol ratio, a first amount of one or more induced condensing agents, a first delta melt initiation temperature (dMIT), and a first amount of one or more continuity additives. In some embodiments, a polymerization condition parameter includes a tolerance above and below the specified value to form a range for such parameter. Tolerances and/or the ranges are set to accommodate normal fluctuations in a controlled polymerization process while still producing a first polymer that meets the product grade specifications for such polyethylene product.

In some embodiments, a first polyethylene is evaluated for use in the method disclosed herein based on the risk of fouling during a restart of the polymerization process. A first polyethylene has a combination of density and melt index (I₂) that result in the first polyethylene having a first melting temperature (Tₘ), a first kill temperature (Tₖ), and a first operating temperature (Tₒₚ). The risk of fouling during restart of the polymerization process increases as the first melting temperature (Tₘ) decreases, and conversely, the risk of fouling during restart of the polymerization process decreases as the first melting temperature (Tₘ) increases. In some embodiments, the reactor system, including the polymerization zone, the cycle fluid piping, and/or the cycle fluid heat exchanger are controlled to stay below the kill temperature (Tₖ). The first melting temperature (Tₘ) is much more dependent on density than on and melt index (I₂), wherein high density means a higher melting temperature (Tₘ), and a higher melt index (I₂) at a given density means a slightly higher melting temperature (Tₘ),

In some embodiments, the first polyethylene has an operating temperature (Tₒₚ), or first reactor temperature, of less than 180 °F (82.2 °C), in the range of from 180 °F (82.2 °C) to less than 185 °F (85.0 °C), or greater than or equal to 185 °F (85.0 °C). For reducing risk of fouling during restart of the polymerization process, the range of from 180 °F (82.2 °C) to less than 185 °F (85.0 °C) is more preferred than less than 180 °F (82.2 °C), and greater than or equal to 185 °F (85.0 °C) is more preferred than from 180 °F (82.2 °C) to less than 185 °F (85.0 °C).

In some embodiments, a first polyethylene is evaluated for use in the method disclosed herein based on the risk of sheeting during a restart of the polymerization process. Where two polyethylenes are produced with the same or similar densities using the same catalyst, a polyethylene having a lower melt index (I₂) will have a higher risk of sheeting during a restart of the polymerization process than a polyethylene having a higher melt index (I₂). In some embodiments, the risk of sheeting for a particular polyethylene grade is dependent on one or more of the type of catalyst used to make a polyethylene grade, the melt index (I₂) of the polyethylene grade, and particular reactor configurations. An experienced operator of a particular reactor would know the risk of sheeting for particular combinations of catalyst type and melt index (I₂) and set a minimum threshold of melt index for each such combination.

### Second Polyethylene

A second polyethylene is characterized by a second density and a second melt index (I₂) and is the polymer grade being produced (or targeted for production) after restart of polymerization. In the context of the method disclosed herein, the second polyethylene may also be referred to as the startup grade of polyethylene or the target grade or polyethylene. In some embodiments, the second polyethylene is further characterized by one or more of a second high load melt index (I₂₁ or HLMI), a second melt index ratio (MIR), a second number average molecular weight (Mₙ), a second weight average molecular weight (M_{w}), a second Z-average molecular weight (M_{z}), a second molecular weight distribution (M_{w}/Mₙ or MWD), a second ratio of the Z-average molecular weight to the weight average molecular weight (M_{z}/M_{w}), a second composition distribution melt index, and a second branching index (g′). The same catalyst is used for production of both the first and second polyethylenes.

The second polyethylene is associated with a second set of polymerization conditions including one or more of a second reactor temperature, a second reactor pressure, a second ethylene monomer feed rate, a second comonomer type and feed rate, a second catalyst type and feed rate, a second comonomer/ethylene (C₂^{═}) mol ratio, a second rate of addition of hydrogen, a second hydrogen (H₂)/ethylene (C₂^{═}) mol ratio, a second amount of one or more induced condensing agents, a second delta melt initiation temperature (dMIT), and a second amount of one or more continuity additives. In some embodiments, a polymerization condition parameter includes a tolerance above and below the specified value to form a range for such parameter. Tolerances and/or the ranges are set to accommodate normal fluctuations in a controlled polymerization process while still producing a first polymer that meets the product grade specifications for such polyethylene product.

In some embodiments, a second polyethylene has a combination of density and melt index (I₂) that result in the second polyethylene having a first melting temperature (Tₘ), a first kill temperature (Tₖ), and a first operating temperature (Tₒₚ). The risk of sheeting during restart of the polymerization process increases as the first melting temperature (Tₘ) decreases, and conversely, the risk of sheeting during restart of the polymerization process decreases as the first melting temperature (Tₘ) increases.

In some embodiments, the second polyethylene has an operating temperature (Tₒₚ), or second reactor temperature, of less than 180 °F (82.2 °C), in the range of from 180 °F (82.2 °C) to less than 185 °F (85.0 °C), or greater than or equal to 185 °F (85.0 °C). For reducing risk of sheeting during restart of the polymerization process, the range of from 180 °F (82.2 °C) to less than 185 °F (85.0 °C) is more preferred than less than 180 °F (82.2 °C), and greater than or equal to 185 °F (85.0 °C) is more preferred than the range of from 180 °F (82.2 °C) to less than 185 °F (85.0 °C).

### First Polyethylene/Second Polyethylene Combinations

Embodiments of the polymerization process restarts according to the method disclosed herein would be each be applied to a specific reactor configuration using the same catalyst for both the first polyethylene and the second polyethylene. One of ordinary skill in the art having operating experience with the specific polymerization reaction zone and catalyst used to produce multiple grades of polyethylene would also have sufficient knowledge of the fouling and/or sheeting risks associated with each of the multiple grades of polyethylene and the unique set of polymerization conditions associated with each such grade of to assign an agglomeration risk parameter to each of such polyethylene grades. One of ordinary skill in the art having operating experience with the specific polymerization reaction zone and catalyst used to produce multiple grades of polyethylene would also have sufficient knowledge of the fouling and/or sheeting risks associated with each of the multiple grades of polyethylene and the unique set of polymerization conditions associated with each such grade of polyethylene to assign an acceptable agglomeration risk threshold value for a particular combination of reactor configuration, catalyst, and one or more polyethylene grades (e.g., the first and/or second polyethylene associated with the processing interruption and subsequent re-start; or potentially an entire polyethylene grade slate, such as the plurality of polyethylene grades intended for production in a polyethylene production campaign).

The first polyethylene may be assigned a first agglomeration risk parameter, wherein the first agglomeration risk parameter indicates a sensitivity of the first polyethylene to fouling and/or sheeting due to deviations in polymerization conditions in a selected polymerization reaction zone, and the second polyethylene can similarly be assigned a second agglomeration risk parameter, wherein the second agglomeration risk parameter indicates a sensitivity of the second polyethylene to fouling and/or sheeting due to deviations in polymerization conditions in the selected polymerization reaction zone. Preferred combinations of first polyethylenes and second polyethylenes would be those that satisfy the relationship of Equation (1), below:

$$\frac{{R}_{1} + {R}_{2}}{2} \leq {R}_{T} \qquad ( 1 )$$

wherein:
   R₁ is first agglomeration risk parameter, wherein risk increases as R₁ increases;
   R₂ is first agglomeration risk parameter, wherein risk increases as R₂ increases; and
   R_{T} is an agglomeration threshold value for acceptable fouling and/or sheeting risks associated with a particular combination of the selected polymerization reaction zone, the catalyst, and one or more polyethylene grades (such as a polyethylene grade slate).

The absolute values of R₁ and R₂ are not particularly important, so much as the relative value of R₁ and R₂ with respect to each other (and with respect to R_{T}). That is, the ordinarily skilled artisan with the benefit of this disclosure will readily be able to define any scale on which R₁, R₂ and R_{T} can be placed, taking into account the guidance previously given (e.g., where two PEs have similar density and are produced using the same catalyst, the PE with the lower I₂ will indicate a higher risk of sheeting). R₁ and R₂ preferably can be determined based upon empirical evidence (e.g., sheeting actually encountered in running the first and second PE on a given reactor at given polymerization conditions over the course of time), based at least in part upon identity of the polymerization catalyst, the melt index of the polyethylene grade, and the reactor configuration. Essentially, this reflects that the skilled artisan can take into account the average risk of sheeting encountered between the first and second polyethylene; so long as that average is below the desired threshold sheeting risk (R_{T}), then the first and second polyethylene can be used in restart methods in accordance with the present disclosure. This guidance will aid the skilled artisan in selecting which polyethylene grades from among a grade slate can be utilized for efficient restart following unexpected shutdown of a particular given polyethylene grade. In addition to the above relationship of Equation (1), preferably R₁ and R₂ are each less than R_{T}, which would represent the lowest risk of fouling and/or sheeting. For example, the first polyethylene and the second polyethylene can be the same polymer grade (that is, have the same melt index, density, and other properties; and be targeted for production using the same polymerization conditions and same catalyst). A set of transitional polymerization conditions can be used in conjunction with the of first polyethylenes and second polyethylenes indicated by this guidance.

In yet other instances, in addition to the above relationship of Equation (1), one of R₁ or R₂ is less than R_{T}, and the other is greater than R_{T}. Embodiments in accordance with this guidance represent an acceptable risk of fouling and/or sheeting, so long as the average risk of fouling and/or sheeting between the two remains below R_{T}. A set of transitional polymerization conditions can be used in conjunction with these combinations of first polyethylenes and second polyethylenes.

The method disclosed herein provides a framework for managing the risks associated with sheeting and/or fouling during restarts by addressing particular risks related to particular combinations of a first polyethylene and a second polyethylene in addition to risks presented by a first polyethylene and a second polyethylene individually. Risk of fouling, in particular, is mitigated by consideration of the characteristics of the first polyethylene, which functions as the seed be for a reactor restart. Attention on other key parameters, such as, but not limited to, bed level, superficial gas velocity, reactor pressure, rate of catalyst reintroduction, especially during the first few BTOs, can further mitigate risks during reactor restarts.

### Idling the Reactor

On some occasions, production of a first polyethylene under a first set of polymerization conditions must be terminated due to one or more process upsets and/or equipment failures in one or more ancillary systems upstream and/or downstream of the reactor. On these occasions, the polymerization process can be “killed” by the addition of one or more polymerization neutralizers to the polymerization reaction zone. After termination or the polymerization process in the polymerization reaction zone, the addition of catalyst, ethylene monomer, and optional comonomer and/or hydrogen, to the fluidized bed, and the withdrawal of the first polyethylene, from the polymerization reaction zone, are terminated. The polymerization zone is then idled by maintaining recirculation of cycle fluid to maintain a superficial velocity sufficient to maintain fluidization of the fluidized bed to form a fluidized seed bed comprising the first polyethylene.

As noted above, the methods herein can include idling the reactor system for a period. As part of the idling procedure, the pressure within the reactor system can be adjusted. The pressure within the reactor system can be adjusted by removing at least a portion of the gases and/or liquids from within the reactor or adding gases and/or liquids to the reactor. For example, the pressure within the reactor can be reduced by venting or purging at least a portion of the gases and/or liquids from within the reactor system, while still maintaining fluidization within the polymerization zone.

The pressure within the reactor can be reduced from an operating pressure to an idling pressure by removing at least a portion of the gases within the reactor 101 (the “reactor gases”) via line 118. In addition to removing at least a portion of the reactor gases via vent line 118, the amount of polymerizable and/or modifying gases can also be reduced. Should the pressure fall below a desired idling pressure or the pressure within the reactor 101 should be increased nitrogen or other inert gases via line 133 can be introduced thereto.

Prior to introducing polymerization neutralizer via line 130 to the reactor 101 the concentration of the polymerizable and/or modifying components within the reactor 101 such as monomers and/or ICAs can be reduced via the vent line 118, while polymerization continues within the reactor 101. The concentration of ICAs within the reactor can be reduced via vent line 118 to a concentration intermediate an idling concentration and a normal operating concentration via vent line 118.

The superficial velocity of the cycle fluid introduced via line 115 to the reactor 101 can be adjusted from an operational superficial velocity to an idling superficial velocity by controlling the rate of introduction to the reactor 101. For example, the flow rate of the cycle fluid in line 115 can be reduced via one or more valves (not shown) to provide a cycle fluid flow through the reactor 101 at a reduced superficial velocity.

After the polymerization neutralizer via line 130 has been introduced to the reactor 101 and introduction of the reactor feed via line 110, the catalyst feed via line 113 and hydrogen addition via line 114 have been reduced or stopped and the pressure and superficial velocity have been adjusted from to an idling pressure and superficial velocity, the reactor 101 can be maintained at these conditions for a period of time. After the period of time, a reactor restart procedure can be initiated.

During idling of the reactor 101, the concentration of the polymerization neutralizer introduced via line 130 can be monitored. Should the concentration fall below a desired idling concentration then additional polymerization neutralizer via line 130 can be introduced to the reactor 101. The concentration of the polymerization neutralizer can be monitored via one or more gas chromatographs or other detection equipment in a lab or in fluid communication with the polymerization system.

The idling pressure can be less than or greater than the operating pressure. Preferably, the idling pressure is less than the operating pressure. For example, the normal operating pressure within the reactor can range from a low of about 145 psig (1,000 kPag), about 174 psig (1,200 kPag), about 203 psig (1,400 kPag), or about 218 psig (1,500 kPag) to a high of about 261 psig (1,800 kPag), about 319 psig (2,200 kPag), about 334 psig (2,300 kPag), about 348 psig (2,400 kPag), or about 363 psig (2,500 kPag). During idling, however, the pressure can be reduced to a range having a low of about 73 psig (500 kPag), about 87 psig (600 kPag), about 102 psig (700 kPag), about 116 psig (800 kPag), about 131 psig (900 kPag), or about 145 psig (1,000 kPag) to a high of about 87 psig (600 kPag), about 102 psig (700 kPag), about 116 psig (800 kPag), about 131 psig (900 kPag), about 160 psig (1,100 kPag), about 174 psig (1,200 kPag), or about 189 psig (1,300 kPag), or any combination of any upper or lower limit recited herein. The pressure within the reactor can be reduced by venting or purging at least a portion of the gases and/or liquids within the reactor before, when, or after the polymerization neutralizer is introduced to the reactor.

If the pressure within the reactor approaches or falls below a desired idling pressure, gases and/or liquids can be introduced to the reactor to increase the pressure therein. For example, nitrogen can be introduced to the reactor to increase the pressure within the reactor to a desired idling pressure. The idling pressure can be less than the operating pressure, equal to the operating pressure, or greater than the operating pressure of the reactor.

Optionally, the idling procedure can also include adjusting the superficial velocity of cycle fluid flowing through the reactor can be adjusted from an operating superficial velocity to an idling superficial velocity. The pressure drop through the fluidized bed is equal to or slightly greater than the weight of the fluidized bed divided by the cross-sectional area. It is thus dependent on the geometry of the reactor. To maintain a viable fluidized bed in the reactor, the superficial gas velocity through the bed must exceed the minimum flow required for fluidization. During operating conditions, preferably the superficial gas velocity is at least two times the minimum flow velocity. The operating superficial gas velocity can range from a low of about 0.3 m/s, about 0.35 m/s, about 0.4 m/s, or about 0.5 m/s to a high of about 1 m/s, about 1.4 m/s, about 1.8 m/s, or about 2 m/s. Ordinarily, the superficial gas velocity does not exceed 1.5 m/s and usually no more than about 0.8 m/s.

The idling superficial velocity can be less than the operating superficial velocity. For example, a reactor with an operating superficial velocity of around 0.8 m/s of cycle fluid flow therethrough can be reduced to about 0.60 to about 0.70 m/s or about 0.60 to about 0.65 m/s during idling. The superficial velocity can be reduced before, after, and/or at the same time the first polymerization neutralizer is introduced to the reactor.

The use of lower superficial gas velocity during the idling procedure can aid in decreasing catalyst entrainment static and/or solids carryover during idling. Small changes in the superficial gas velocity can result in large changes in entrainment static and/or solids carryover. Thus, reducing or lowering the superficial gas velocity during the idling or start up procedures can decrease the entrainment static and or solids carryover. Reductions in the entrainment static and/or solids carryover can lead to reductions in sheeting and/or fouling in the reactor system. The level of static in the reactor can be measured using a static probe, as described in PCT Publication WO 2008/016478. For example, the level of static in the reactor may be measured using an upper static probe located near the top of the fluidized bed. This upper static probe may provide a measurement of entrainment static, the static at or near the top of the fluidized bed or near the reactor output streams.

Optionally, the temperature within the reactor can be adjusted during the transition. The temperature within the reactor can be reduced, before, after, and/or at the same time the first polymerization neutralizer is introduced to the reactor. The idling temperature of the fluidized bed can be about 85 °C or less, about 83 °C or less, about 80 °C or less, or about 77 °C or less. The idling temperature of the fluidized bed can be maintained at a temperature that can range from about ambient or “room” temperature to about 79 °C, about 82 °C, or about 84 °C Reducing or stopping the polymerization within the reactor can reduce or eliminate the heat produced therefrom, which can reduce the temperature within the reactor. The temperature within the reactor can also be reduced and/or maintained by adjusting the temperature of a heat transfer medium used to adjust the temperature of the cycle fluid, for example.

It is advantageous to ensure that the dew point temperature of the gas composition within the reactor is at least about 3 °C less than the fluidized bed temperature prior to introducing the first polymerization neutralizer. Allowing the fluidized bed temperature to approach too closely to the dew point temperature of the gas composition during a catalyst transition can also lead to sheeting, fouling, and the like. For example, the dew point temperature of the gas composition within the reactor may be at least about 5 °C, 10 °C, 15 °C, 20 °C, or even 25 °C or more less than the fluidized bed temperature. This temperature differential may be maintained for the entire transition or, for example, through the step of purging the reactor with an inert gas or until the second catalyst system is introduced. During the step of purging the reactor with an inert gas, the fluidized bed temperature may advantageously be maintained at between 75 °C and 85 °C, 78 °C and 84′C, 80 °C and 83 °C, 81 °C and 83 °C, or be maintained at about 82 °C.

In some embodiments, during idling the reactor temperature is limited to less than or equal to the kill temperature, less than or equal to the kill temperature minus 5 °F (2.8 °C), less than or equal to the kill temperature minus 10 °F (5.6 °C), or less than or equal to the kill temperature minus 15 °F (8.3 °C), of the first polyethylene.

In some embodiments, during idling cooling water in the cycle fluid heat exchanger is limited to the lower of 194 °F (90.0 °C) or the kill temperature of the first polyethylene minus 5 °F (2.8 °C).

In some embodiments, during idling the cycle fluid compressor discharge temperature is limited to the lower of 202 °F (94.4 °C) or the kill temperature of the first polyethylene plus 3 °F (1.7 °C).

For reactors operating in condensed mode, it is also advantageous to ensure that the dew point temperature of the gas composition within the reactor is at least about 3 °C, about 5 °C, or about 10 °C or more greater than the reactor inlet temperature prior to introducing the first polymerization neutralizer. The reactor inlet temperature is typically measured at the bottom inlet of the reactor, under the distributor plate.

If the ambient temperature outside the reactor is cool, e.g. less than 25 °C the fluidized bed can tend to cool down below a desired idling temperature because of the reduced or lack of heat being generated within the reactor due to a reduced rate or termination of polymerization. To compensate for cooling of the fluidized bed, the temperature of the heat transfer medium can be increased. However, to avoid plate fouling and/or sheeting or other polymer accumulation within the reactor, the temperature of a heat transfer medium used to heat the cycle fluid introduced to the reactor can be monitored and controlled. The temperature of the heat transfer medium can be maintained at a temperature of less than about 95 °C less than about 91 °C, less than about 89 °C, less than about 85 °C, less than about 81 °C, less than about 78 °C, or less than about 75 °C. Increasing the heat transfer medium beyond about 80 °C, about 85 °C, about 90 °C, or about 95 °C could lead to plate fouling or other sheeting within the reactor upon introduction of the cycle fluid thereto.

During normal operation, i.e., polymer production, under a given set of operating conditions the fluidized bed is maintained at essentially a constant height by withdrawing a portion of the bed as polymer product at the rate of formation of the particulate polymer product. Since the rate of heat generation during polymerization is directly related to the rate of product formation, a measurement of the temperature rise of the fluid across the reactor (the difference between inlet cycle fluid temperature and exit cycle fluid temperature) is indicative of the rate of particulate polymer formation at a constant fluid velocity if no or negligible vaporizable liquid is present in the inlet fluid. The temperature rise of the fluid across the reactor, i.e., the temperature of the cycle gas exiting the reactor minus the temperature of the cycle gas introduced to the reactor, can be referred to as “DT” or “ΔT.” A normal or typical DT for the reactor during polymer production can range from a low of about 5 °C, about 10 °C, or about 15 °C to a high of about 40 °C, about 50 °C, or about 55 °C.

During idling of the polymerization system, the DT of the reactor can range from a low of about −15 °C, about −11 °C, or about −8 °C to a high of about −4 °C, about −2 °C, or about 0 °C. The particular DT can depend on the ambient temperature outside the reactor, the temperature of the heat transfer medium, the size of the particular reactor, or any combination thereof. In at least one example, the temperature within the reactor can be allowed to fall to the surrounding ambient temperature, i.e., heat exchangers used to cool the cycle fluid during operation and/or warm during idling can be bypassed or operated at ambient temperature.

The height of the fluidized bed during the transition or during idling of the reactor can vary. The height of the fluidized bed can be based, at least in part, on the particular polymer being produced in the reactor at the time the transition or idling procedure is initiated, the particular polymer to be produced next, or a combination thereof. Adjusting the rate of recovery of the polymer product can be performed in a manner that adjusts the height of the fluidized bed to a desired level. For example, the height of the fluidized bed can be increased by reducing or stopping the amount of polymer product recovered from the reactor while polymerization is continued, i.e., before the first polymerization neutralizer is introduced to the reactor. In another example, the height of the fluidized bed can be decreased by increasing the amount of polymer product recovered from the reactor, reducing the amount of polymerizable components introduced from the feed stream, or a combination thereof

It can be desirable to have differing transition or idling fluidized bed heights depending on the particular polymer within the reactor. During normal operation the reactor can be operated such that the height of the fluidized bed ranges from a low of about −1 m, about 0 m, or about 0.2 m to a high of about 0.5 m, about 1 m, or about 1.5 m relative to the neck of the reactor. The “neck” refers to the junction or connection between a cylindrical section and a transition section of the reactor. During idling of the reactor the height of the fluidized bed can fall or decrease if, for example, the superficial velocity of the cycle fluid flowing through the fluidized bed is reduced. As such, it can also be desirable to raise or increase the fluidized bed height prior to introducing the first polymerization neutralizer. Prior to introducing the first polymerization neutralizer to the reactor and/or stopping the reactor feed and/or the catalyst feed the height of the fluidized bed can be adjusted to about 0 m, about 0.5 m, about 1 m, about 1.25 m, about 1.4 m, about 1.5 m, about 1.6 m, about 1.75 m, about 2 m, or about 2.5 m above the neck of the reactor, or to within a range of any upper or lower value recited herein.

The reactor can remain idle for any desired period of time, i.e., continued circulation of the gases therethrough to maintain a reduced or non-polymerizing fluidized bed therein. The period of time the reactor can be maintained at or in an idled state can range from a few minutes or hours to days or even weeks.

The reactor can also be circulated for a period of time during or after any step of the method. For example, the reactor may be circulated for at least 10 minutes, 15 minutes, 20 minutes, 30 minutes, 60 minutes, 120 minutes, 150 minutes, 6 hours, 8 hours, a week, a month, or more after introducing the first polymerization neutralizer. The reactor may also be circulated for at least 10 minutes, 15 minutes, 20 minutes, 30 minutes, 60 minutes, 120 minutes, 150 minutes, 6 hours, 8 hours, a week, a month, or more after introducing the second polymerization neutralizer.

Following introduction of the first and second polymerization neutralizer, and idling or circulating the reactor for a period if desired, the reactor is purged with an inert gas. The time required for this purge may be 1 hour or more, 2 hours or more, 3 hours or more, or 4 hours or more. The purge reduces the concentration of polymerization neutralizer within the reactor system. This reduction may be done until the amount of the first polymerization neutralizer comprises less than 500 ppm, 100 ppm, 50 ppm, 30 ppm, 20 ppm, 10 ppm, 5 ppm, or 1 ppm based on the weight of the fluidized bed. This reduction may also be done until the amount of the second polymerization neutralizer comprises less than 500 ppm, 100 ppm, 50 ppm, 30 ppm, 20 ppm, 10 ppm, 5 ppm, or 1 ppm based on the weight of the fluidized bed. The concentration of polymerization neutralizer can be reduced by venting a portion of the cycle gas from the reactor. Nitrogen or other inert gases can be introduced to the reactor to maintain a desired volume of cycle gas and pressure within the polymerization system. The reactor feed can also be introduced in addition to or in lieu of the inert gases. Additionally, prior to or during the restart procedure, the amount of hydrocarbon within the fluidized bed may be reduced to less than 20, less than 15, less than 10, less than 5, less than 4, less than 3, less than 2, or less than 1 mol % of the fluidized bed.

### Polymerization Neutralizer

It has been found that metallocene catalysts are particularly sensitive to certain compounds typically used as catalyst kill agents or polymerization neutralizers (these terms are used interchangeably herein). For example, water is an extremely effective polymerization neutralizer for metallocene catalysts. However, it has been found that under certain circumstances when water is used as a polymerization neutralizer with metallocene catalysts during reactor transitions, the metallocene catalyst can interact with the water in a manner that causes severe and rapid sheeting in the reactor. This can potentially lead to a complete reactor shutdown so that the reactor can be opened and cleaned, which may take several days or more, and undermines any efficiency gained by having a fast transition process.

Due to these issues, there has been a tendency to avoid the use of water as a polymerization neutralizer in reactor transitions between metallocene catalysts. The tendency has been to look for and use other compounds. In some cases, those compounds may be less effective polymerization neutralizers than water. When the polymerization neutralizer that is used is less effective, it is possible that residual active metallocene catalyst may remain in the reactor during the reactor transition to a new metallocene catalyst. This can increase the amount of off-grade product that is produced during the transition and upon start up with the new catalyst. It can also increase the time required to complete a catalyst transition. As such, it is desirable to be able to use the most effective polymerization neutralizers available, so long as the compounds do not lead to other adverse effects on the reactor system or resin product.

The methods disclosed herein enable water to be used as a polymerization neutralizer with metallocene catalysts, while eliminating the risk that the metallocene catalyst will interact with the water and cause a catastrophic event. These methods can enable faster reactor transitions with less production of undesirable off-grade product.

The methods disclosed herein comprise first reducing the superficial gas velocity and increasing the height of the fluidized bed within the reactor prior to stopping a feed comprising a first metallocene catalyst. Next, a first polymerization neutralizer is added to the reactor. The first polymerization neutralizer does not comprise water, as it has been found that when the first polymerization neutralizer comprises water the risk of sheeting leading to a catastrophic event is substantially increased. The reactor is circulated for a period of time after introducing the first polymerization neutralizer to allow the reaction between the first polymerization neutralizer and the metallocene catalyst to take place. After this, a second polymerization neutralizer is introduced to the reactor. The second polymerization neutralizer is different from the first polymerization neutralizer, and may comprise water in a preferred method. The reactor is again circulated for a period of time after introducing the second polymerization neutralizer. Following this, the reactor is purged with an inert gas and then a feed comprising a second metallocene catalyst may be introduced to the reactor.

The total amount of polymerization neutralizer (the “total amount” meaning the amount of both the first and second polymerization neutralizer) added to the reactor should be sufficient to reduce or completely stop polymerization therein, without interrupting fluidization within the reactor. An excess amount of polymerization neutralizer, i.e., an amount greater than that necessary to stop polymerization can be used, but more preferably, the amount added is sufficient to reduce the rate of polymerization by about 90%, about 95%, about 98%, about 99%, about 99.9%, about 99.99%, about 99.999%, or 100%. A 99% reduction in the rate of polymerization means that polymerization is occurring at only 1% of the original rate of polymerization prior to the introduction of the polymerization neutralizer. A 100% reduction in the polymerization rate means that no polymerization is occurring within the reactor.

The total amount or concentration of the polymerization neutralizer within the reactor can vary depending on the size of the reactor and the desired time frame for the polymerization interruption. For example, the total amount or concentration of the polymerization neutralizer within the reactor can be at least 1 part per million by volume (“ppmv”), about 5 ppmv, about 10 ppmv, about 30 ppmv, about 50 ppmv, about 100 ppmv, about 250 ppmw, about 500 ppmw, or about 1,000 ppmw, based on the volume of the fluidized bed. In another example, the total amount or concentration of the polymerization neutralizer within the reactor can range from a low of about 1 ppmv, about 2 ppmv, or about 3 ppmv to a high of about 10 ppmv, about 30 ppmv, or about 50 ppmv, based on the volume of the fluidized bed.

The amount of the first polymerization neutralizer that is used may be represented on a ppm by weight basis. For example, the amount may be between 5 ppm and 1000 ppm, based on the weight of the fluidized bed. The amount may range from a low of 5 ppm, 10 ppm, 30 ppm, 50 ppm, 70 ppm, 80 ppm, 90 ppm, 100 ppm, 150 ppm, 250 ppm, or 500 ppm, to a high of 50 ppm, 60 ppm, 70 ppm, 80 ppm, 90 ppm, 100 ppm, 150 ppm, 250 ppm, 500 ppm, or 1000 ppm, including any combination of any low or high value recited herein, based on the weight of the fluidized bed.

The amount of the second polymerization neutralizer that is used may also be represented on a ppm by weight basis. For example, the amount may be between 5 ppm and 1000 ppm, based on the weight of the fluidized bed. The amount may range from a low of 5 ppm, 10 ppm, 30 ppm, 50 ppm, 70 ppm, 80 ppm, 90 ppm, 100 ppm, 150 ppm, 250 ppm, or 500 ppm, to a high of 50 ppm, 60 ppm, 70 ppm, 80 ppm, 90 ppm, 100 ppm, 150 ppm, 250 ppm, 500 ppm, or 1000 ppm, including any combination of any low or high value recited herein, based on the weight of the fluidized bed.

Polymerization neutralizer can be added to the reactor from any location or number of locations within the polymerization system. For example, polymerization neutralizer can be introduced directly to the reactor, with the reactor feed, the catalyst feed, to the cycle fluid, or any combination thereof. Preferably, polymerization neutralizer is introduced directly to the reactor and/or to the cycle fluid.

Suitable polymerization neutralizers for the first or second polymerization neutralizer can include, but are not limited to, one or more Lewis bases such as carbon monoxide, carbon dioxide, or any combination thereof. The first polymerization neutralizer can include carbon monoxide, carbon dioxide, or a combination thereof, but does not comprise water. The second polymerization neutralizer can include carbon monoxide, carbon dioxide, water, or a combination thereof. The second polymerization neutralizer preferably comprises water. For example, the second polymerization neutralizer can be just water or any combination of one or more Lewis bases that includes water. “Water” or “H₂O” herein refers to water in any physical state, including liquid and vapor.

The recovery of polymer product can be adjusted, i.e., reduced, increased and/or stopped, at any time before, after, or at the same time the first polymerization neutralizer is introduced to the reactor. For example, recovery of the polymer product can be stopped when the first polymerization neutralizer is introduced to the reactor. In another example, the polymer product can be stopped within about +/−1 minute, about +/−5 minutes, or about +/−10 minutes of the time the first polymerization neutralizer is introduced to the reactor.

The rate the reactor feed is introduced to the reactor can also be adjusted, i.e., reduced, increased and/or stopped, at any time before, after, or at the same time the polymerization neutralizer is introduced to the reactor. For example, introduction of the reactor feed can be stopped when the first polymerization neutralizer is introduced to the reactor. In another example, introduction of the reactor feed can be stopped within about +/−1 minute, about +/−5 minutes, or about +/−10 minutes of the time the first polymerization neutralizer is introduced to the reactor.

Each particular component of the reactor feed, e.g. monomer(s), induced condensing agents (“ICAs”), hydrogen, and/or inert gases such as nitrogen, can be stopped at the same time or at different times with respect to one another. For example, all components of the reactor feed can be stopped at the same time. In another example, for a reactor feed having monomer(s) and ICA(s), introduction of the ICA(s) can be stopped prior to introduction of the first polymerization neutralizer and introduction of the monomer(s) can be stopped when or after the first polymerization neutralizer is introduced to the reactor. In still another example, for a reactor feed having monomer(s) and ICA(s), both the ICA(s) and the monomer(s) can be stopped before the first polymerization neutralizer is introduced to the reactor and the introduction of the ICA(s) can be stopped before the introduction of the monomer(s) is stopped.

Further, the rate the catalyst feed is introduced to the reactor can be adjusted, i.e., reduced, increased and/or stopped, at any time before, after, or at the same time the first polymerization neutralizer is introduced to the reactor. For example, introduction of the catalyst feed can be stopped when the first polymerization neutralizer is introduced to the reactor. In another example, introduction of the catalyst feed can be stopped within about +/−1 minute, about +/−5 minutes, or about +/−10 minutes of the time the first polymerization neutralizer is introduced to the reactor.

Each particular component of the catalyst feed, e.g., catalyst(s), activator(s), and/or additives, can be stopped at the same time or different times with respect to one another. For example, all components of the catalyst feed can be stopped at the same time. In another example, for a catalyst feed having a first catalyst system and a second catalyst system, introduction of the first catalyst system can be stopped prior to introduction of the first polymerization neutralizer and introduction of the second catalyst system can be stopped when or after the first polymerization neutralizer is introduced to the reactor. In still another example, for a catalyst feed having a first catalyst system and a second catalyst system both the first and second catalyst systems can be stopped before the first polymerization neutralizer is introduced to the reactor and the introduction of the first catalyst system can be stopped before introduction of the second catalyst system is stopped.

### Restarting the Reactor

After restoring normal capabilities of ancillary systems upstream and downstream of the gas phase polymerization reactor, polymerization is reestablished in the polymerization zone by starting the addition of the catalyst, the ethylene monomer, and optionally the comonomer and/or hydrogen to the fluidized bed in the polymerization reaction zone under a transitional set of polymerization conditions, and the withdrawal of a transitional polyethylene for a threshold number of bed turnovers. In some embodiments, the threshold number of bed turnovers is less than or equal to 5, less than or equal to 4, less than or equal to 3, less than or equal to 2.5, or less than or equal to 2.

After the purge, a reactor restart procedure can be initiated. The restart procedure can include re-introducing the reactor feed, reintroducing the catalyst feed, adjusting the rate gases are removed from the reactor via the vent or purge line, adjusting the superficial velocity of the gases or cycle fluid through the reactor, adjusting the temperature of the heat transfer medium used to adjust the temperature of the cycle fluid, adjusting the pressure within the reactor, re-starting recovery of the polymer product, and/or adjusting the height of the fluidized bed within the reactor. The reintroduction of the catalyst and the reactor feed, the vent recovery rate, adjusting the temperature, pressure, and superficial gas velocity within the reactor, restarting polymer product recovery, adjusting the temperature of the heat transfer medium, and/or the height of the fluidized bed can occur in any order or sequence.

The order or sequence of re-starting the reactor can generally follow the order of reducing the concentration of polymerization neutralizer within the reactor, restarting the reactor feed, adjusting the height of the fluidized bed within the reactor, restarting the catalyst feed, and restarting polymer product recovery. The pressure can be adjusted during introduction of the reactor feed, e.g., as the reactor feed is introduced to the reactor the pressure therein can increase. If the introduction of the reactor feed alone is insufficient to increase the pressure to the desired pressure, nitrogen or other non-reactive gases can be added thereto.

The temperature can be adjusted or maintained at a temperature of a threshold value of less than or equal to the kill temperature (Tₖ) of the first polyethylene minus a threshold value for any desired period of time. In some embodiments, the threshold value is less than or equal to the minus 10 °F (5.6 °C), less than or equal to 12.5 °F (6.9 °C), less than or equal to 15 °F (8.3 °C), or less than or equal to 17.5 °F (9.7 °C). When the catalyst is introduced to the reactor and the concentration of polymerization neutralizer has been sufficiently reduced polymerization can begin. The heat generated from the polymerization after restarting can increase the temperature within the reactor. To reduce or maintain a desired temperature within the reactor, the temperature of the heat transfer medium can be adjusted such that the cycle fluid has a desired temperature prior to introduction to the reactor.

In some embodiments, the polymerization zone is maintained at less than or equal to 5 ppm CO. Prior to initiating restart of the polymerization process, CO is reduced to less than or equal to 2 ppm or less than or equal to 1 ppm.

The reactor feed can be reintroduced at a rate less than a normal operating rate, equal to the normal operating rate, or greater than the normal operating rate. The rates of various components of the reactor feed, e.g., monomer(s), ICA(s), and/or hydrogen can be reintroduced at varying rates. Reintroduction of each component in the reactor feed can begin at the same time or different times with respect to one another. For a reactor feed that includes ethylene, hexene, isopentane, and hydrogen, the reintroduction of each component can be started at different times. For example, reintroduction of the hexene can be started, which can be followed by the ethylene, which can be followed by the isopentane, which can then be followed by the hydrogen. Preferably, comonomer feed and/or hydrogen addition are started at the same time or after ethylene feed.

In another example, the hexene, ethylene, and isopentane can all be introduced at about the same time, which can be followed by the reintroduction of hydrogen. In still another example, the introduction of hexene and ethylene can be started, which can be followed by the isopentane and the hydrogen.

The reintroduction of each component of the reactor feed can be continuous or intermittent. The reintroduction of one or more components of the reactor feed can be continuous and the reintroduction of one or more components of the reactor feed can be intermittent. Depending on the particular polymer being produced in the reactor, the particular amount and rate each component is reintroduced can vary during restart and operation of the polymerization system.

As the reactor feed and/or inert gases are reintroduced to the reactor, the pressure within the reactor can be increased to an operating pressure or a pressure intermediate the transition or idling pressure and the operating pressure. For example, if the transition or idling pressure ranges from about 600 kPag to about 800 kPag and the desired operating pressure ranges from about 2,000 kPag to about 2,400 kPag the pressure within the reactor can be increased to an intermediate pressure of from about 1,700 kPag to about 1,900 kPag by the reintroduction of the reactor feed and/or inerts. Once polymerization has restarted, i.e., after reintroduction of the catalyst feed and the reactor feed have been restarted and the concentration of the polymerization neutralizer has sufficiently been decreased, the rate of introducing the reactor feed can be adjusted to the desired operating rates. In another example, the rate of introduction for the reactor feed can be brought to desired operating rates rather than a rate intermediate to idling and normal production.

The superficial velocity of the cycle gas through the reactor can be maintained at the transition or idling rate, adjusted to the operational rate, or adjusted to a rate intermediate the transition or idling rate and the operational rate. Gases or fluid from within the polymerization system can be removed via the vent to maintain a desired reactor pressure and/or to adjust the concentration of one or more components, e.g., monomer(s), ICA(s), hydrogen, and the like. Once the desired pressure and flow rates “restart rates” for each component of the reactor feed are reached the catalyst can be reintroduced to the reactor.

The rate of catalyst initially reintroduced to the reactor can be less than the normal operating rate. A typical initial rate of catalyst feed after an open reactor start-up can range from is less than about 50% of the normal operating rate, or in the range of from about 15% to about 45%, from about 20% to about 40%, or from about 25% to about 35% In some embodiments, a restart according to the method disclosed herein, the initial rate of catalyst feed is about 50% of the initial rate of catalyst feed after an open reactor start-up, or in the range of from 8% to about 22%, from about 10% to about 20%, or from about 12% to about 18% of the normal operating rate. For example, if catalyst were introduced at a rate of 10 kg/hr during normal operation, the amount of catalyst reintroduced upon restarting can be from about 0.8 kg/hr to about 2.2 kg/hr, about 1.0 kg/hr to about 2.0 kg/hr, or about 0.8 kg/hr to about 1.2 kg/hr, about 1.8 kg/hr. Once polymerization (“light off”) has begun within the reactor, the rate of catalyst introduction can be increased to normal operating rates. Preferably the rate of catalyst introduction increased over a period of time. For example, the rate of catalyst introduction can be increased over a period of time of about 0.5 hours, about 1 hour, about 2 hours, about 3 hours, about 4 hours, about 5 hours, or about 6 hours.

Once introduction of the catalyst has been restarted and polymerization has been restarted, polymer product withdrawal can be restarted. The rate of product withdrawal can be less than the normal operating rate and can increase as the amount of polymer production increases. The production of polymer product can increase as the rate of introducing the catalyst and the reactor feed increases. The production of polymer product can also be increased as the concentration of modifying gaseous and/or liquid components such as ICAs in the reactor feed increase within the reactor. Another way to adjust the height of the fluidized bed can be to delay withdrawal of the polymer product until the desired fluidized bed height is reached or to increase the rate of polymer product withdrawal if it is desired to decrease the height of the bed.

The time required to restart the reactor from idling to normal operating conditions can range from a low of about 1 hour, about 3 hours, about 5 hours, or about 7 hours to a high of about 10 hours, about 15 hours, about 20 hours, about 25 hours, or about 30 hours. During restart of the reactor, other typical or normal operating conditions and monitoring procedures can be ran under “modified” or “moderated” conditions or values for a period of time after polymerization is restarted. For example, if the polymerization system is operated in condensed mode, a common technique for monitoring the reactor can include monitoring a stickiness control parameter (“dMIT”) such as a reduced melt initiation temperature or “dMIT” value, which can provide an estimate as to the degree of polymer stickiness within the reactor. Moderated startup or restart conditions can include operating the reactor at a dMIT of about 0 °C or a dMIT within about +/−1 °C, about +/−1.5 °C, or about +/−2 °C for a period of time when the normal dMIT ranges from about 5 °C to about 10 °C Another “modified” restart condition can include operating the polymerization system at a level or concentration of ICAs ranging from a low of about 8.5 mol %, about 9 mol %, or about 9.5 mol % to a high of about 10.5 mol %, about 11 mol %, or about 11.5 mol % when a desired normal level would be greater.

The reactor feed can include any polymerizable hydrocarbon of combination of hydrocarbons. For example, the reactor feed can be any olefin monomer including substituted and unsubstituted alkenes having two to 12 carbon atoms, such as ethylene, propylene, 1-butene, 1-pentene, 1-hexene, 1-heptene, 1-octene, 4-methylpent-1-ene, 1-decene, 1-dodecene, 1-hexadecene, and the like. The reactor feed can also include non-hydrocarbon gas(es) such as nitrogen and/or hydrogen. The reactor feed can enter the reactor at multiple and different locations. For example, monomers can be introduced into the fluidized bed in various ways including direct injection through a nozzle (not shown) into the fluidized bed. The polymer product can thus be a homopolymer or a copolymer, including a terpolymer, having one or more other monomeric units. For example, a polyethylene product could include at least one or more other olefin(s) and/or comonomer(s).

The reactor feed can also include the one or more modifying components such as one or more induced condensing agents (“ICAs”). Illustrative ICAs include, but are not limited to, propane, butane, isobutane, pentane, isopentane, hexane, isomers thereof, derivatives thereof, and combinations thereof. As discussed and described above, the ICAs can be introduced to provide a reactor feed to the reactor having an ICA concentration ranging from a low of about 1 mol %, about 5 mol %, or about 10 mol % to a high of about 25 mol %, about 35 mol %, or about 45 mol %. Typical concentrations of the ICAs can range from about 14 mol %, about 16 mol %, or about 18 mol % to a high of about 20 mol %, about 22 mol %, or about 24 mol %. The reactor feed can include other non-reactive gases such as nitrogen and/or argon. Further details regarding ICAs are described in U.S. Pat. Nos. 5,352,749; 5,405,922; 5,436, 304; and 7,122,607; and WO Publication No. 2005/113615(A2).

As discussed and described above, various systems and/or methods can be used to monitor and/or control the degree or level of fouling within the reactor 101. For example, if the polymerization system 100 is operated in condensed mode, a common technique for monitoring the polymerization can include monitoring a stickiness control parameter (“dMIT”) such as a reduced melt initiation temperature or “dMIT” value, which can provide an estimate as to the degree of polymer stickiness within the reactor 101. Another method for monitoring polymerization can include estimating acoustic emissions within the reactor 101, which can also provide an estimate as to the degree of polymer stickiness within the reactor 101.

The withdrawal of the polymer product via line 117 and introduction of the reactor feed via line 110 and the catalyst feed via line 113 can be reduced or stopped before, after, or simultaneously with the introduction of polymerization neutralizer via line 130. For example, withdrawal of the polymer product via line 117 and introduction of the reactor feed via line 110 and the catalyst feed via line 113 can be stopped when the polymerization neutralizer via line 130 is introduced to the polymerization system 100.

The restart procedure can also include adjusting the height of the fluidized bed 112 from an idling height to a restart height. The restart height of the fluidized bed 112 can be greater than or less than the height of the fluidized bed during idling. Restart height can be lowered by withdrawal of some of the bed from the discharge system. If the bed height is too low, the reactor may have to be emptied and a seedbed reloaded for a normal start-up.

The reactor feed via line 110 can include the same polymerizable and/or modifying components as before initiation of the reactor idling procedure or the reactor feed via line 110 can include different polymerizable and/or modifying components. The pressure within the reactor 101 can be adjusted from the idling pressure to the operating pressure or a pressure intermediate the idling pressure and the operating pressure. For example, the pressure within the reactor 101 can be increased by introducing the reactor feed via line 110 and/or inert gases via line 133. In another example, the pressure within the reactor 101 can be decreased by removing reactor gases via vent line 118. The superficial velocity of the reactor gases through the reactor 101 can be adjusted from the idling superficial velocity to the operating superficial velocity or a superficial velocity intermediate the idling superficial velocity and the operating superficial velocity.

Polymerization within the reactor can be restarted once the concentration of the polymerization neutralizer has been reduced a sufficient amount. Increasing or restarting introduction of the catalyst feed via line 113 can increase the polymerization within the reactor. In some embodiments, the catalyst feed via line 113 can be the same catalyst feed that was introduced to the reactor 101 prior to initiating the reactor idling procedure. In some embodiments, the catalyst feed via line 113 can be a different catalyst feed than was introduced to the reactor 101 prior to initiating the reactor idling procedure.

The withdrawal of the polymer product via line 117 can be increased or restarted before, when, or after polymerization is restarted within the reactor 101. The withdrawal of the polymer product via line 117 can be restarted at a normal operating recovery rate for the desired polymer being produced within the reactor or to a product recovery rate intermediate the normal operating recovery rate and the idling recovery rate.

The temperature within the reactor 101 can be adjusted from an idling temperature to an operating temperature as introduction of the reactor feed via line 110 and the catalyst feed via line 113 is restarted and polymerization is restarted within the reactor. The temperature of the cycle fluid in line 115 can be adjusted via the heat exchanger 175 to provide a cycle gas at a desired temperature. The temperature of the reactor 101 can be adjusted to a normal operating temperature for the polymer product being produced within the reactor 101 or the temperature can be adjusted to a temperature intermediate the normal operating temperature and the idling temperature.

In some embodiments, the transitional set of polymerization conditions comprises a transitional reactor temperature, a transitional reactor pressure, a transitional ethylene monomer feed rate, a transitional comonomer type and feed rate, a transitional catalyst type and feed rate, a transitional comonomer/ethylene (C₂^{═}) mol ratio, a transitional rate of addition of hydrogen, a transitional hydrogen (H₂)/ethylene (C₂^{═}) mol ratio, a transitional amount of one or more induced condensing agents, a transitional dMIT, a transitional amount of one or more continuity additives, or a combination thereof.

In various embodiments, the transitional reactor temperature is in the range of from a minimum reactor temperature sufficient to initiate polymerization to a maximum transitional reactor temperature of a threshold value below the lower of the first reactor temperature and the second reactor temperature. In some embodiments, the threshold value is greater than or equal to 0 °F (0 °C), greater than or equal to about 2.0 °F (1.1 °C), greater than or equal to about 4.0 °F (2.2 °C), greater than or equal to about 6.0 °F (3.3 °C), greater than or equal to about 8.0 °F (4.4 °C), or greater than or equal to about 10.0 °F (5.6 °C), below the lower of the first reactor temperature and the second reactor temperature. For instance, where the first reactor temperature is 200 °F, and the second reactor temperature is 190 °F, the transactional reactor temperature may be in the range from 0 to 10.0 °F below the lower of those two temperatures (i.e., from 0 to 10.0 °F below 190 °F, or from 180 °F to 190 °F). Transitional reactor temperature can in various embodiments be in the range of from about 0 °F (0 °C) to about 16.0 °F (8.9 °C), from about 2.0 °F (1.1 °C) to about 15.0 °F (8.3 °C), from about 4.0 °F (2.2 °C) to about 14.0 °F (7.8 °C), from about 6.0 °F (3.3 °C) to about 13.0 °F (7.2 °C), of from about 8.0 °F (4.4 °C) to about 12.0 °F (6.7 °C), of from about 10 °F (5.6 °C) to about 11.0 °F (6.1 °C), below the lower of the first reactor temperature and the second reactor temperature.

In various embodiments, the transitional reactor pressure is in the range of from a minimum transitional reactor pressure sufficient to initiate polymerization to a maximum transitional reactor pressure of a threshold value below the lower of the first reactor pressure and the second reactor pressure a transitional reactor pressure, wherein for example the threshold value can be greater than or equal to 0.5 bar (50 kPa), 1.0 bar (100 kPa), 1.5 bar (150 kPa), or 2.0 bar (200 kPa) and/or less than or equal to 3.0 bar (300 kPa), 2.5 bar (250 kPa), 2.0 bar (200 kPa), or 1.5 bar (150 kPa), below the lower of the first reactor pressure and the second reactor pressure. In various embodiments, the transitional reactor pressure is less than or equal to 20 barg (2.0 MPag) or in the range of from 18 barg (1.8 MPag) to 20 barg (2.0 MPag) to limit solids carryover into cycle fluid piping and/or equipment.

In various embodiments, a transitional ethylene monomer feed rate is equal to the second ethylene monomer feed rate.

In various embodiments, a transitional comonomer type and feed rate is equal to the second comonomer type and feed rate.

In various embodiments, a transitional catalyst type is the same as the first and second catalyst types, and transitional catalyst feed rate is less than about 50% of the second catalyst feed rate, or in the range of from about 15% to about 45%, from about 20% to about 40%, or from about 25% to about 35%.

In various embodiments, the transitional comonomer/ethylene (C₂) mol ratio is equal to the second comonomer/ethylene (C₂) mol ratio.

In various embodiments, the transitional rate of addition of hydrogen is equal to the second rate of addition of hydrogen.

In various embodiments, the transitional ICA content in the process is in the range of from 5 mol % to 15 mol %, from 7 mol % to 13 mol %, or from 9 mol % to 1 mol %, wherein the mol % is based on mol % iC₅ or equivalent as a mol % of the total ethylene, comonomer, and ICA. The equivalency basis for iC₅ is described in U.S. Pat. Pub. No. US 2022/0119563A1, the contents of which are fully incorporated by reference herein.

In various embodiments, the transitional dMIT is in the range of about −4 °F (−2.2 °C) to about 4 °F (2.2 °C), about −3 °F (−1.7 °C) to about 3 °F (1.7 °C), about −2 °F (−1.1 °C) to about 2 °F (1.1 °C), about −1 °F (−0.6 °C) to about 1 °F (0.6 °C), or about 0 °F (0 °C);

After a threshold number of BTOs, the transitional set of polymerization conditions are ramped to the second set of polymerization conditions and withdrawal of the second polyethylene.

### Metallocene Catalyst

In some embodiments, the catalyst used in the first set of polymerization conditions and the second set of polymerization conditions is a metallocene catalyst, which are particularly susceptible to sheeting and/or chunking triggered by changing polymerization conditions. Metallocene catalysts produce in the gas phase polymerization process produce linear low density polyethylene (LLDPE). LLDPEs made using one or more metallocene catalysts are labeled herein as mLLDPE The mLLDPE can include copolymers of 80 to 99.9 wt % ethylene-derived units, with the balance of units derived from one or more C₃ to C₁₂ α-olefin comonomers (and in particular one or more of butene, hexene, octene; and more preferably hexene). Metallocene catalysts include, but are not limited to: Type 1: an unbridged bis-cyclopentadienyl Group 4 and substituted versions thereof; Type 2: a bridged bis-cyclopentadienyl Group 4 and substituted versions thereof; Type 3: a substituted bulky ligand hafnium transition metal metallocene-type catalyst compound and substituted versions thereof; and Type 4: a dual catalyst system comprising a bridged bis-cyclopentadienyl Group 4 metal catalyst and an unbridged bis-cyclopentadienyl Group 4 metal catalyst.

### Type 1 Metallocene Catalyst

In some embodiments, the metallocene catalyst is an unbridged bis-cyclopentadienyl Group 4 and substituted versions thereof. Such Type 1 catalysts produce polyethylene grades having a narrow composition distribution (i.e., a move uniform distribution of comonomer among polymer chains) and are referred to herein as narrow-CD mLLDPE.

A narrow-CD mLLDPE can, for instance, comprise a flat composition distribution metallocene-catalyzed LLDPE (mLLDPE) that is a copolymer of 80 to 99.9 wt % ethylene-derived units, with the balance of units derived from one or more C₃ to C₁₂ α-olefin comonomer (and in particular one or more of butene, hexene, octene; preferably one of those; and more preferably hexene). The wt % is based on total mass of ethylene-derived units plus comonomer-derived units in the polyethylene. Such polyethylenes are referred to as “flat composition distribution” in recognition that comonomer is incorporated in relatively equal amounts (by wt %) in shorter vs. longer molecular-weight chains within the polymer. These also may be referred to as “narrow-CD” or “narrow-composition-distribution” polyethylenes; or, equivalently, high-CDBI mLLDPEs. Composition distribution refers to the distribution of comonomer among polymer chains of different length (different molecular weight), and CDBI refers to Composition Distribution Breadth Index, which is defined as the weight percent of the copolymer molecules (chains) having a comonomer content within 50% of the median total molar comonomer content, and it is described in U.S. Pat. No. 5,382,630, which is hereby incorporated by reference. The CDBI of a copolymer is readily determined utilizing well known techniques for isolating individual fractions of a sample of the copolymer. One such technique is Temperature Rising Elution Fraction (TREF), as described in Wild, et al., J. Poly. Sci., Poly. Phys. Ed., vol. 20, p. 441 (1982) and U.S. Pat. No. 5,008,204, which are incorporated herein by reference. Thus, a higher value of CDBI indicates a narrow composition distribution (meaning that comonomer is distributed relatively evenly across polymer chains of different molecular weight).

The narrow-CD polyethylene may have CDBI of at least 50%, more preferably at least 60%, such as within the range from 50 to 90%, or 60 to 80%.

A narrow-CD polyethylene may more particularly have ethylene-derived content within the range from a low of any one of 80, 85, 86, 87, 87.5, 88, 90, 91, 92, 93, 94 or 95 wt % to a high of any one of 88, 90, 93, 94, 95, 96, 97, 98, 99, or 99.9 wt %; with ranges from any foregoing low to any foregoing high contemplated, provided the high end is greater than the low end (e.g., 85 to 95 wt %, such as 86 to 92 wt % ethylene-derived units; or 94 to 99 wt % ethylene-derived units). The balance is comprised of the C₃ to C₁₂ α-olefin comonomer-derived units (e.g., hexene).

The narrow-CD mLLDPE can provide reduced softening point relative to formation processes, and furthermore provide excellent sealing, optical, and mechanical properties to a film made therefrom. The narrow-CD mLLDPE preferably also has one or more, preferably all, of the following further properties:
Peak melting temperature within the range from 105 °C to 120 °C, preferably 110 °C or 111 °C to 115 °C or 116 °C Peak melting temperature, also referred to herein by the shorthand “melting point” is determined by using a differential scanning calorimeter (DSC). DSC measurements can be carried out with a TA DSC8000 instrument under N₂ atmosphere with a heating/cooling rate of 10 K/min. The samples are heated from −50 to 300 °C, held for 5 minutes in order to remove the previous thermal history, then cooled down to −50 °C, and then heated again to 300 °C.
Vicat softening temperature (ASTM D1525) within the range from softening point within the range from 70 °C to 130 °C, preferably 90 °C to 110 °C, such as from a low of any one of 70, 75, 80, 85, 90, 95, 96, 97, 98, 99, or 100 °C to a high of any one of 100, 101, 102, 103, 104, 105, 110, 115, 120, 125, or 130 °C (with ranges from any foregoing low to any foregoing high contemplated, provided the high is greater than the low, e.g., 90 °C to 110 °C or 97 °C to 103 °C).
Melt index (MI, also referred to as I₂ or I_{2.16} in recognition of the 2.16 kg loading used in the test) within the range from 0.1 to 5.0 g/10 min (ASTM D1238, 190 °C, 2.16 kg load), such as from a low of any one of 0.1, 0.2, 0.3, 0.4, 0.5, 0.7, or 0.8 g/10 min to a high of any one of 1.0, 1.1, 1.2, 1.5, 2.0, 2.5, 3.0, 3.5, 4.0, 4.5, or 5.0 g/10 min, with ranges from any foregoing low end to any foregoing high end also contemplated.
Long chain branching index (LCB Index, also referred to herein as g′ᵥᵢₛ or g′ index) greater than 0.95, preferably greater than or equal to 0.96 or 0.97.

The narrow-CD mLLDPE can also have one or more, preferably all of the following:
Weight average molecular weight (M_{w}) within the range from 45,000 to 120,000 g/mol, such as from 50,000 to 115,000 g/mol or 60,000 to 110,000 g/mol (with ranges from any foregoing low end to any foregoing high end also contemplated, e.g., 45,000 to 110,000 g/mol);
Number average molecular weight (Mₙ) within the range from 20,000 to 55,000 g/mol, such as within the range from 25,000; 30,000; 35,000; or 40,000 to a high of 30,000; 35,000; 40,000; 45,000; 50,000; or 55,000 g/mol, with ranges from any foregoing low end to any foregoing high end also contemplated (provided the high end is greater than the low end), e.g., from 35,000 to 55,000 g/mol;
Molecular weight distribution (MWD) within the range from 1.5 or 2.0 to 3.5 or 4; and
Density (ASTM D1505) within the range from 0.905 to 0.940 g/cm³, such as within the range from a low end of any one of 0.905, 0.910, 0.911, 0.912, or 0.915 g/cm³ to a high end of any one of 0.913, 0.914, 0.915, 0.920, 0.925, 0.926, 0.928, 0.930, 0.935, or 0.940 g/cm³, with ranges from any foregoing low end to any foregoing high end contemplated (provided the high end is greater than the low end), e.g., 0.910 to 0.915 g/cm³.

Examples of suitable polyethylenes for the narrow-CD mLLDPE include Exceed™ performance polyethylenes available from ExxonMobil Chemical Company, as well as other commercially available mLLDPEs such as Evolue™ SP1510, available from Prime Polymer Co., Ltd.

In some embodiments of the method disclosed herein, the catalyst is a Type 1 metallocene catalyst and the first polyethylene is a first narrow-CD mLLDPE and the second polyethylene is a second narrow-CD mLLDPE. The first narrow-CD mLLDPE and the second narrow-CD mLLDPE can be the same or different narrow-CD mLLDPEs.

In some embodiments, where a Type 1 metallocene catalyst is employed, the first polyethylene is a first narrow-CD mLLDPE, and the second polyethylene is a second narrow-CD mLLDPE. The first narrow-CD mLLDPE has a first density in the range of from 0.910 g/cm³ to 0.930 g/cm³, and a first melt index (I₂) is in the range of from 0.80 dg/min. to 5.0 dg/min. The second narrow-CD mLLDPE has a second density is in the range of from 0.910 g/cm³ to 0.930 g/cm³, and a second melt index (I₂) is in the range of from 0.80 dg/min. to 5.0 dg/min.; or a combination thereof.

In some embodiments, the first polyethylene is a first narrow-CD mLLDPE, having associated with it a first set of polymerization conditions comprising a first reactor temperature, a first reactor pressure, a first ethylene monomer feed rate, a first comonomer type and feed rate, a first catalyst type and feed rate, a first comonomer/ethylene (C₂^{═}) mol ratio, a first rate of addition of hydrogen, a first hydrogen (H₂)/ethylene (C₂^{═}) mol ratio, a first amount of one or more induced condensing agents, a first delta melt initiation temperature (dMIT), a first amount of one or more continuity additives, or a combination thereof.

In some embodiments, the second polyethylene is a second narrow-CD mLLDPE, having associated with it a second set of polymerization conditions comprising a second reactor temperature, a second reactor pressure, a second ethylene monomer feed rate, a second comonomer type and feed rate, a second catalyst type and feed rate, a second comonomer/ethylene (C₂^{═}) mol ratio, a second rate of addition of hydrogen, a second hydrogen (H₂)/ethylene (C₂^{═}) mol ratio, a second amount of one or more induced condensing agents, a second delta melt initiation temperature (dMIT), a second amount of one or more continuity additives, or a combination thereof.

In various embodiments, the transitional set of polymerization conditions can comprise a transitional reactor temperature, a transitional reactor pressure, a transitional ethylene monomer feed rate, a transitional comonomer type and feed rate, a transitional catalyst type and feed rate, a transitional comonomer/ethylene (C₂^{═}) mol ratio, a transitional rate of addition of hydrogen, a transitional hydrogen (H₂)/ethylene (C₂^{═}) mol ratio, a transitional amount of one or more induced condensing agents, a transitional dMIT, a transitional amount of one or more continuity additives, or a combination thereof.

In various embodiments, the transitional reactor temperature is in the range of from a minimum reactor temperature sufficient to initiate polymerization to a maximum transitional reactor temperature of a threshold value below the lower of the first reactor temperature and the second reactor temperature. For instance, the threshold value can be greater than or equal to 0 °F (0 °C), greater than or equal to about 1.4 °F (0.75 °C), greater than or equal to about 2.7 °F (1.5 °C), greater than or equal to about 4. °F (2.25 °C), greater than or equal to about 5.4 °F (3.0 °C), or greater than or equal to about 6.8 °F (3.75 °C), below the lower of the first reactor temperature and the second reactor temperature. In various embodiments, transitional reactor temperature can be in the range of from about 0 °F (0 °C) to about 10 °F (5.6 °C), from about 1.2 °F (0.66 °C) to about 9.0 °F (5.0 °C), from about 2.4 °F (1.32 °C) to about 8.0 °F (4.5 °C), from about 3.6 °F (2.0 °C) to about 7.0 °F (3.9 °C), of from about 4.8 °F (2.6 °C) to about 6.0 °F (3.3 °C), of from about 6.0 °F (3.3 °C) to about 4.9 °F (2.7 °C), below the lower of the first reactor temperature and the second reactor temperature.

Further, the transitional reactor pressure can be in the range of from a minimum transitional reactor pressure sufficient to initiate polymerization to a maximum transitional reactor pressure of a threshold value below the lower of the first reactor pressure and the second reactor pressure a transitional reactor pressure, wherein for example the threshold value can be greater than or equal to 0.5 bar (50 kPa), 1.0 bar (100 kPa), 1.5 bar (150 kPa), or 2.0 bar (200 kPa) below the lower of the first reactor pressure and the second reactor pressure and/or less than or equal to 3.0 bar (300 kPa), 2.5 bar (250 kPa), 2.0 bar (200 kPa), or 1.5 bar (150 kPa) below the lower of the first reactor pressure and the second reactor pressure. In some embodiments, the transitional reactor pressure is less than or equal to 20 barg (2.0 MPag) or in the range of from 18 barg (1.8 MPag) to 20 barg (2.0 MPag) to limit solids carryover into cycle fluid piping and/or equipment.

In various embodiments, a transitional ethylene monomer feed rate is equal to the second ethylene monomer feed rate.

In various embodiments, a transitional comonomer type and feed rate is equal to the second comonomer type and feed rate.

In various embodiments, a transitional catalyst type is the same as the first and second catalyst types, and transitional catalyst feed rate is less than about 50% of the second catalyst feed rate, or in the range of from about 15% to about 45%, from about 20% to about 40%, or from about 25% to about 35%.

In various embodiments, the transitional comonomer/ethylene ((C₂^{═})) mol ratio is equal to the second comonomer/ethylene (C₂^{═}) mol ratio.

In various embodiments, the transitional rate of addition of hydrogen is equal to the second rate of addition of hydrogen.

In various embodiments, the transitional ICA content in the process is in the range of from 5 mol % to 15 mol %, from 7 mol % to 13 mol %, or from 9 mol % to 11 mol %, wherein the mol % is based on mol % iC₅ or equivalent as a mol % of the total ethylene, comonomer, and ICA.

In various embodiments, the transitional dMIT is in the range of about −4 °F (−2.2 °C) to about 4 °F (2.2 °C), about −3 °F (−1.7 °C) to about 3 °F (1.7 °C), about −2 °F (−1.1 °C) to about 2 °F (1.1 °C), about −1 °F (−0.6 °C) to about 1 °F (0.6 °C), or about 0 °F (0 °C);

### Type 2 Metallocene Catalyst

In some embodiments, the metallocene catalyst is a bridged bis-cyclopentadienyl Group 4 and substituted versions thereof, as disclosed in one or more of U.S. Pat. Nos. 6,255,426 and 6,476,171, the contents of which are fully incorporated by reference herein. Such Type 2 catalysts produce polyethylene grades having some long-chain branching (as compared to the highly linear structure of most mLLDPEs), and are referred to herein as “LCB-mLLDPE.”

Long chain branched mLLDPEs (“LCB mLLDPE”) are considered long-chain-branched as compared to other linear low-density polyethylenes, and in particular as compared to other metallocene LLDPEs; whereas their total long-chain branching will still be less than LDPEs with very high degrees of long-chain branching.) This small amount of LCB can be evidenced through, e.g., a high melt index ratio (MIR) and/or particular rheology characteristics as shown through data obtained by small angle oscillatory shear (SAOS) experiments (for instance, ratio of η_{0.01}/η₁₀₀, the complex viscosity recorded at shear rates of 0.01 and 100 rad/s, respectively). Another useful parameter for indicating the presence of LCB is illustrated in FIG. 4: Van Gurp Palmen (VGP) plots. In particular, polyethylene copolymers (even LLDPE) with some LCB will exhibit an inflection point in their VGP curve, while LLDPE without any LCB present show no such inflection point. See, for example, the Enablem brand LLDPEs, examples of LCB-mLLDPEs, in FIG. 4, as compared to the XP8318, which is an example of the narrow-MWD BOCD-mLLDPEs discussed below.

Yet another useful parameter illustrating presence of some LCB can be seen in the melt index ratio. Melt index ratio (MIR) is the ratio of high load melt index (HLMI, ASTM D1238 at 190 °C, 21.6 kg) to melt index (MI₂, ASTM D1238 at 190 °C, 2.16 kg).

Accordingly, LCB-mLLDPEs useful for the present compositions can have one or more of the following properties (which can be useful indicia of moderate LCB):
MIR within the range from a low of any one of 20, 25, 26, 27, 28, 29, 30, or 31 to a high of any one of 40, 35, 34, 33, 32, 31, or 30 with ranges from any of the foregoing lows to any of the foregoing highs contemplated herein (e.g., 27 to 33, such as 28 to 32, or 29 to 31).
Complex shear viscosity (η*) @0.01 rad/sec and 190 °C in the range of 5,000 to 12,000 Pa s; or from a low of any one of 5,000; 6,000; 7,000; 8,000; 9,000; 10,000; or 11,000 Pa s, to a high of any one of 12,000; 11,000, 10,000; 9,000; 8,000; 7,000; or 6,000 Pa·s, with ranges from any low end to any high end contemplated (e.g., 6,000 to 8,000 Pa s).
Complex shear viscosity (η*) @100 rad/sec and 190 °C within the range from 900 to 2000 Pa·s; such as from a low end of any one of 900; 1,000; 1,100; or 1,200 Pa s to a high end of any one of 1,200; 1,300; 1,400; 1,500; or 2,000 Pa s, with ranges from any foregoing low to any foregoing high also contemplated (e.g., 1,100 to 1,300 Pa·s).
Shear thinning ratio (η* @0.01/100) less than 15, or in the range of 3 to 15, or 4 to 12, or 5 to 10, or 5.5 to 8.
An inflection point in a Van Gurp Palmen plot of phase angle vs. complex modulus (Pa) of the LCB-mLLDPE.

Finally, yet another indicator of LCB can be seen in the LCB index (g′ or alternatively g′vis), which for LCB-mLLDPE could be less than 1, such as within the range from 0.9 to 0.99 or 0.94 to 0.98, although still substantially higher than g′ for heavily-LCB polyethylene, such as LDPE made using free radical polymerization.

Suitable mLLDPEs with the aforementioned moderate LCB are preferably copolymers of 80, 85, 88, 90, 92, 93, 94, or 95 to 6, 97, 98, or 99 wt % ethylene-derived units, with the balance derived from one or more C₃ to C₁₂ α-olefins (and in particular one or more of butene, hexene, octene; preferably one of those; and more preferably hexene). The wt % is based on total mass of ethylene-derived units plus comonomer-derived units in the polyethylene.

Suitable LCB mLLDPEs can also have a CDBI greater than or equal to 60%, preferably greater than or equal to 70%, such as within the range from a low of any one of 60, 70, or 75% to a high of 80, 85, 90, 95, or 99%, with ranges from any foregoing low end to any foregoing high end contemplated. Composition Distribution Breadth Index (“CDBI”) is defined as the weight percentage of the copolymer molecules having a comonomer content within 50% of the median total molar comonomer content. The CDBI of a copolymer is readily determined utilizing well known techniques for isolating individual fractions of a sample of the copolymer. One such technique is Temperature Rising Elution Fraction (TREF), as described in Wild, et al., J. Poly. Sci., Poly. Phys. Ed., Vol. 20, p. 441 (1982) and U.S. Pat. No. 5,008,204, which are fully incorporated herein by reference.

Suitable LCB mLLDPEs can also have a MWD (Mw/Mn) within the range of 2.5 to 5.5, such as within the range of 3 or 3.5 to 4.5 or 5.

Suitable LCB mLLDPEs can further have a Melt Index (I₂, determined per ASTM D1238 at 190 °C, 2.16 kg load) within the range of 0.1 to 3.0 g/10 min, or can range from a low of any one of 0.1, 0.15, 0.2, or 0.22 to a high of any one of 0.30, 0.40, 0.50, 0.60, 0.70, 0.80, 0.90, 1.0, 1.5, 2.0, 2.2, 2.5, 2.7, or 3.0 g/10 min; with ranges from any foregoing low end to any foregoing high end also contemplated (provided the high end is greater than the low end), e.g., from 0.1 to 2.5 g/10 min; 0.15 to 1.0 g/10 min; or 0.2 to 0.50 g/10 min.

High load melt index (HLMI, or I₂₁, determined per ASTM D1238 at 190 °C, 21.6 kg load) can be within the range from 10 to 75 g/10 min, such as from 12 to 70 g/10 min.
Density of the LCB-mLLDPE can be within the range from 0.900 to 0.940 g/cm³, such as from a low of any one of 0.905, 0.910, 0.920, or 0.925 g/cm³ to a high of any one of 0.930, 0.932, 0.933, 0.934, 0.935, or 0.940 g/cm³, with ranges from any forgoing low to any foregoing high contemplated herein (e.g., 0.910 to 0.935 g/cm³).

These LCB-mLLDPEs can be referred to as a “first mLLDPE” in compositions described herein. Some particular examples of such first mLLDPEs having the foregoing unique combination of properties include certain Enable™ and Exceed™ XP brand polyethylenes from ExxonMobil Chemical Company, such as Exceed™ XP 6026, Enable™ 2010, Enable™ 2703, Enable™ 3505, Enable™ 4002, and Enable™ 4009 performance polyethylenes. Other commercial examples include Dow Innate™ ST70, Dow Agility™ 2001, Dow Elite™ 5940, Dowlex™ 2038.68G, Dow Elite™ AT 6401, Dow Attanem 4701G, Marlex™ TR130, and Nova Surpass™ 117/116.

In some embodiments of the method disclosed herein, the catalyst is a Type 2 metallocene catalyst and the first polyethylene is a first LCB-mLLDPE and the second polyethylene is a second LCB-mLLDPE. The first LCB-mLLDPE and the second LCB-mLLDPE can be the same or different LCB-mLLDPEs.

Thus, where a Type 2 metallocene catalyst is employed, the first polyethylene can be a first LCB-mLLDPE, and the second polyethylene can be a second LCB-mLLDPE. The first LCB-mLLDPE in these instance could have a first density in the range of from 0.918 g/cm³ to 0.940 g/cm³, and a first melt index (I₂) is in the range of from 0.20 dg/min. to 1.2 dg/min. The second LCB-mLLDPE could have a second density is in the range of from from 0.918 g/cm³ to 0.940 g/cm³, and a second melt index (I₂) is in the range of from 0.20 dg/min. to 1.2 dg/min.; or a combination thereof.

The first polyethylene can be, for example, a first LCB-mLLDPE, having associated with it a first set of polymerization conditions comprising a first reactor temperature, a first reactor pressure, a first ethylene monomer feed rate, a first comonomer type and feed rate, a first catalyst type and feed rate, a first comonomer/ethylene (C₂^{═}) mol ratio, a first rate of addition of hydrogen, a first hydrogen (H₂)/ethylene (C₂^{═}) mol ratio, a first amount of one or more induced condensing agents, a first delta melt initiation temperature (dMIT), a first amount of one or more continuity additives, or a combination thereof.

Also or instead, the second polyethylene could be a second LCB-mLLDPE, having associated with it a second set of polymerization conditions comprising a second reactor temperature, a second reactor pressure, a second ethylene monomer feed rate, a second comonomer type and feed rate, a second catalyst type and feed rate, a second comonomer/ethylene (C₂^{═}) mol ratio, a second rate of addition of hydrogen, a second hydrogen (H₂)/ethylene (C₂^{═}) mol ratio, a second amount of one or more induced condensing agents, a second delta melt initiation temperature (dMIT), a second amount of one or more continuity additives, or a combination thereof.

The transitional set of polymerization conditions can comprise a transitional reactor temperature, a transitional reactor pressure, a transitional ethylene monomer feed rate, a transitional comonomer type and feed rate, a transitional catalyst type and feed rate, a transitional comonomer/ethylene (C₂) mol ratio, a transitional rate of addition of hydrogen, a transitional hydrogen (H₂)/ethylene (C₂^{═}) mol ratio, a transitional amount of one or more induced condensing agents, a transitional dMIT, a transitional amount of one or more continuity additives, or a combination thereof.

In this regard, the transitional reactor temperature can be in the range of from a minimum reactor temperature sufficient to initiate polymerization to a maximum transitional reactor temperature of a threshold value below the lower of the first reactor temperature and the second reactor temperature. In some embodiments, the threshold value is greater than or equal to 0 °F (0 °C), greater than or equal to about 2.3 °F (1.3 °C), greater than or equal to about 4.5 °F (2.5 °C), greater than or equal to about 6.8 °F (3.8 °C), greater than or equal to about 9.0 °F (5.0 °C), or greater than or equal to about 11.3 °F (6.3 °C), below the lower of the first reactor temperature and the second reactor temperature. In some embodiments, transitional reactor temperature is in the range of from about 0 °F (0 °C) to about 16.9 °F (9.4 °C), from about 2.0 °F (1.1 °C) to about 15.1 °F (8.4 °C), from about 4.0 °F (2.2 °C) to about 13.4 °F (7.4 °C), from about 5.9 °F (3.3 °C) to about 11.6 °F (6.5 °C), of from about 7.9 °F (4.4 °C) to about 9.9 °F (5.5 °C), of from about 9.9 °F (5.5 °C) to about 8.1°T (4.5 °C), below the lower of the first reactor temperature and the second reactor temperature.

Similarly, the transitional reactor pressure can be in the range of from a minimum transitional reactor pressure sufficient to initiate polymerization to a maximum transitional reactor pressure of a threshold value below the lower of the first reactor pressure and the second reactor pressure a transitional reactor pressure, wherein in some embodiments, the threshold value is greater than or equal to 0.5 bar (50 kPa), 1.0 bar (100 kPa), 1.5 bar (150 kPa), or 2.0 bar (200 kPa) below the lower of the first reactor pressure and the second reactor pressure, and/or less than or equal to 3.0 bar (300 kPa), 2.5 bar (250 kPa), 2.0 bar (200 kPa), or 1.5 bar (150 kPa), below the lower of the first reactor pressure and the second reactor pressure. In some embodiments, the transitional reactor pressure is less than or equal to 20 barg (2.0 Mpag) or in the range of from 18 barg (1.8 Mpag) to 20 barg (2.0 Mpag) to limit solids carryover into cycle fluid piping and/or equipment.

Optionally, a transitional ethylene monomer feed rate is equal to the second ethylene monomer feed rate.

In various embodiments, a transitional comonomer type and feed rate is equal to the second comonomer type and feed rate.

In various embodiments, a transitional catalyst type is the same as the first and second catalyst types, and transitional catalyst feed rate is less than about 50% of the second catalyst feed rate, or in the range of from about 15% to about 45%, from about 20% to about 40%, or from about 25% to about 35%.

In various embodiments, the transitional comonomer/ethylene (C₂^{═}) mol ratio is equal to the second comonomer/ethylene (C₂^{═}) mol ratio.

In various embodiments, the transitional rate of addition of hydrogen is equal to the second rate of addition of hydrogen.

In various embodiments, the transitional ICA content in the process is in the range of from 5 mol % to 15 mol %, from 7 mol % to 13 mol %, or from 9 mol % to 11 mol %, wherein the mol % is based on mol % iC₅ or equivalent as a mol % of the total ethylene, comonomer, and ICA.

In various embodiments, the transitional dMIT is in the range of about −4 °F (−2.2 °C) to about 4 °F (2.2 °C), about −3 °F (−1.7 °C) to about 3 °F (1.7 °C), about −2 °F (−1.1 °C) to about 2 °F (1.1 °C), about −1 °F (−0.6 °C) to about 1 °F (0.6 °C), or about 0 °F (0 °C);

### Type 3 Metallocene Catalyst

In some embodiments, the metallocene catalyst is a substituted bulky ligand hafnium transition metal metallocene-type catalyst compound and substituted versions thereof, as disclosed in one or more of U.S. Pat. Nos. U.S. Pat. Nos. 9,181,362, 6,242,545, 7,078,467, RE40751 11,214,659, and 9,695,290; and U.S. Pub. Nos. 2015/240000, 2015/259445, and 2015/284523, the contents of which are fully incorporated by reference herein. Such Type 3 catalysts produce polyethylene grades having narrow MWD with a broad orthogonal comonomer distribution (“BOCD”), which may be referred to herein as Narrow MWD BOCD-mLLDPEs.

As mentioned above, a suitable mLLDPE can have a narrow molecular weight distribution (MWD) with broad orthogonal composition distribution (BOCD). The molecular weight distribution (MWD) or (M_{z}/M_{w}) can range from about 2.0 to about 4.5, from about 2.2 to about 4.5, from about 3.0 to about 4.0, or from about 2.5 to about 4.0. The weight average molecular weight (M_{w}) can range from about 15,000 to about 400,000 g/mol, from about 20,000 to about 250,000 g/mol, from about 20,000 to about 200,000 g/mol, from about 25,000 to about 150,000 g/mol, from about 150,000 to about 400,000 g/mol, from about 200,000 to about 400,000 g/mol, or from about 250,000 to about 350,000 g/mol. The z-average molecular weight (M) to weight average molecular weight (M_{w}) ratio can be greater than about 1.5, or greater than about 1.7, or greater than about 2.0. In some embodiments, this ratio is from about 1.7 to about 3.5, from about 2.0 to about 3.0, or from about 2.2 to about 3.0.

The term “orthogonal comonomer distribution” is used herein to mean across the molecular weight range of the polymer, comonomer contents for the various polymer fractions are not substantially uniform and a higher molecular weight fraction thereof generally has a higher comonomer content than that of a lower molecular weight fraction. The term “substantially uniform comonomer distribution” is used herein to mean that comonomer content of the polymer fractions across the molecular weight range of the ethylene-based polymer vary by <10.0 wt %. In some embodiments, a substantially uniform comonomer distribution may refer to <8.0 wt %, <5.0 wt %, or <2.0 wt %. Both a substantially uniform and an orthogonal comonomer distribution may be determined using fractionation techniques such as gel permeation chromatography-differential viscometry (GPC-DV), temperature rising elution fraction-differential viscometry (TREF-DV) or cross-fractionation techniques.

The broadness of the composition distribution of the polymer may be characterized by T₇₅−T₂₅. TREF is measured using an analytical size TREF instrument (Polymerchar, Spain), with a column of the following dimensions: inner diameter (ID) 7.8 mm, outer diameter (OD) 9.53 mm, and column length of 150 mm. The column may be filled with steel beads. 0.5 mL of a 4 mg/ml polymer solution in orthodichlorobenzene (ODCB) containing 2 g BHT/4 L were charge onto the column and cooled from 140 °C to −15 °C at a constant cooling rate of 1.0 °C/min Subsequently, ODCB may be pumped through the column at a flow rate of 1.0 ml/min, and the column temperature may be increased at a constant heating rate of 2 °C/min to elute the polymer. The polymer concentration in the eluted liquid may then be detected by means of measuring the absorption at a wavenumber of 2941 cm⁻¹ using an infrared detector. The concentration of the ethylene-α-olefin copolymer in the eluted liquid may be calculated from the absorption and plotted as a function of temperature. As used herein, T₇₅−T₂₅ values refer to where T₂₅ is the temperature in degrees Celsius at which 25% of the eluted polymer is obtained and T₇₅ is the temperature in degrees Celsius at which 75% of the eluted polymer is obtained via a TREF analysis.

By “broad orthogonal comonomer distribution” or BOCD, it is meant that a substantially higher degree of short chain branching is present on longer molecular-weight polymer chains than on shorter molecular-weight polymer chains within the copolymer. Suitable narrow-MWD mLLDPEs with BOCD can have a T₇₅−T₂₅ value from 5 to 10, alternatively, a T₇₅−T₂₅ value from 5.5 to 10, and alternatively, a T₇₅−T₂₅ value from 5.5 to 8, alternatively, a T₇₅−T₂₅ value from 6 to 10, and alternatively, a T₇₅−T₂₅ value from 6 to 8, where T₂₅ is the temperature in degrees Celsius at which 25% of the eluted polymer is obtained and T₇₅ is the temperature in degrees Celsius at which 75% of the eluted polymer is obtained via temperature rising elution fractionation (TREF).

These mLLDPEs can have a CDBI of less than about 40%, or less than about 35%, or less than about 30%, or less than about 25%. The CDBI can also range from a low of about 15%, 20%, or 25% to a high of about 30%, 35%, or 40%, and it is further noted that composition distribution is such that higher molecular weight chains of these mLLDPEs have greater wt % of comonomer than lower molecular weight chains of the mLLDPEs.

These mLLDPEs can have 70.0 wt % to 100.0 wt % of units derived from ethylene. The lower limit on the range of ethylene content may be from 70.0 wt %, 75.0 wt %, 80.0 wt %, 85.0 wt %, 90.0 wt %, 92.0 wt %, 94.0 wt %, 95.0 wt %, 96.0 wt %, 97.0 wt %, 98.0 wt %, or 99.0 wt % based on the wt % of polymer units derived from ethylene. These mLLDPEs can also have an upper ethylene limit of 80.0 wt %, 85.0 wt %, 90.0 wt %, 92.0 wt %, 94.0 wt %, 95.0 wt %, 96.0 wt %, 97.0 wt %, 98.0 wt %, 99.0 wt %, 99.5 wt %, or 100.0 wt %, based on polymer units derived from ethylene. Less than 30.0 wt % of polymer units can be derived from a C₃-C₂₀ olefin, preferably, an alpha-olefin, e.g., hexene or octene. The lower limit on the range of C₃-C₂₀ olefin-content can be 25.0 wt %, 20.0 wt %, 15.0 wt %, 10.0 wt %, 8.0 wt %, 6.0 wt %, 5.0 wt %, 4.0 wt %, 3.0 wt %, 2.0 wt %, 1.0 wt %, or 0.5 wt %, based on polymer units derived from the C₃-C₂₀ olefin. The upper limit on the range of C₃-C₂₀ olefin-content can be 20.0 wt %, 15.0 wt %, 10.0 wt %, 8.0 wt %, 6.0 wt %, 5.0 wt %, 4.0 wt %, 3.0 wt %, 2.0 wt %, or 1.0 wt %, based on polymer units derived from the C₃ to C₂₀ olefin.

These mLLDPEs can have a density in accordance with ASTM D-4703 and ASTM D-1505/ISO 1183 of from about 0.900 g/cm³ to about 0.940 g/cm³, from about 0.910 g/cm³ to about 0.935 g/cm³, from about 0.900 g/cm³ to about 0.930 g/cm³, from about 0.900 g/cm³ to about 0.925 g/cm³, from about 0.900 g/cm³ to about 0.923 g/cm³, from about 0.900 g/cm³ to about 0.920 g/cm³, from about 0.912 g/cm³ to about 0.919 g/cm³, from about 0.912 g/cm³ to about 0.918 g/cm³, from about 0.914 g/cm³ to about 0.918 g/cm³, or from about 0.915 g/cm³ to about 0.918 g/cm³.

These mLLDPEs can have a melt index (MI) or (I_{2.16}) as measured by ASTM D-1238-E (190 °C/2.16 kg) of about 0.1 g/10 min to about 5.0 g/10 min, about 0.1 g/10 min to about 3.0 g/10 min, about 0.1 g/10 min to about 2.0 g/10 min, about 0.1 g/10 min to about 1.2 g/10 min, about 0.2 g/10 min to about 1.5 g/10 min, about 0.2 g/10 min to about 1.1 g/10 min, about 0.3 g/10 min to about 1.0 g/10 min, about 0.4 g/10 min to about 1.0 g/10 min, about 0.5 g/10 min to about 1.0 g/10 min, about 0.6 g/10 min to about 1.0 g/10 min, about 0.7 g/10 min to about 1.0 g/10 min, or about 0.75 g/10 min to about 0.95 g/10 min.

These mLLDPEs can have a melt index ratio (MIR) (I_{21.6}/I_{2.16}) (as defined below) of from about 20.0 to about 35.0, from about 22 to about 38, from about 20 to about 32, from about 25 to about 32 or from about 28 to about 31.

These mLLDPEs can also have at least a first peak and a second peak in a comonomer distribution analysis, wherein the first peak has a maximum at a log(M_{w}) value of from 4.0 to 5.4, or from 4.3 to 5.0, or from 4.5 to 4.7, and a TREF elution temperature of from 70.0 °C to 100.0 °C, or from 80.0 °C to 95.0 °C, or from 85.0 °C to 90.0 °C The second peak in the comonomer distribution analysis has a maximum at a log(M_{w}) value of 5.0 to 6.0, 5.3 to 5.7, or 5.4 to 5.6; and a TREF elution temperature of 40.0 °C to 60.0 °C, 45.0 °C to 60.0 °C, or 48.0 °C to 54.0 °C.

In any of the embodiments described above, a suitable mLLDPE can have a narrow MWD with broad orthogonal composition distribution with one or more of the following properties: a melt index (MI) (190 °C/2.16 kg) of from about 0.1 g/10 min to about 5.0 g/10 min; a melt index ratio (MIR) of from about 25 to about 32; a M_{w} of from about 20.000 to about 200,000 g/mol; a M_{w}/Mₙ of from about 2.0 to about 4.5; and a density of from about 0.900 g/cm³ to about 0.940 g/cm³.

Commercially available examples of such second mLLDPEs having the foregoing unique combination of properties include Exceed XP™ resins from ExxonMobil Chemical Company.

In some embodiments of the method disclosed herein, the catalyst is a Type 3 metallocene catalyst and the first polyethylene is a first narrow MWD BOCD-mLLDPE and the second polyethylene is a second narrow MWD BOCD-mLLDPE. The first narrow MWD BOCD-mLLDPE and the second narrow MWD BOCD-mLLDPE can be the same or different narrow MWD BOCD-mLLDPE.

In some embodiments, where a Type 3 metallocene catalyst is employed, the first polyethylene is a first narrow MWD BOCD-mLLDPE, and the second polyethylene is a second narrow MWD BOCD-mLLDPE. The first narrow MWD BOCD-mLLDPE has a first density in the range of from 0.910 g/cm³ to 0.920 g/cm³, and a first melt index (I₂) is in the range of from 0.10 dg/min. to 4.0 dg/min. The second broad MWD BOCD-mLLDPE has a second density is in the range of from 0.910 g/cm³ to 0.920 g/cm³, and a second melt index (I₂) is in the range of from 0.20 dg/min. to 1.2 dg/min.; or a combination thereof.

In various embodiments, the first polyethylene is a narrow MWD BOCD-mLLDPE, having associated with it a first set of polymerization conditions comprising a first reactor temperature, a first reactor pressure, a first ethylene monomer feed rate, a first comonomer type and feed rate, a first catalyst type and feed rate, a first comonomer/ethylene (C₂^{═}) mol ratio, a first rate of addition of hydrogen, a first hydrogen (H₂)/ethylene (C₂^{═}) mol ratio, a first amount of one or more continuity additives, or a combination thereof.

In various embodiments, the second polyethylene is a second narrow MWD BOCD-mLLDPE, having associated with it a second set of polymerization conditions comprising a second reactor temperature, a second reactor pressure, a second ethylene monomer feed rate, a second comonomer type and feed rate, a second catalyst type and feed rate, a second comonomer/ethylene (C₂^{═}) mol ratio, a second rate of addition of hydrogen, a second hydrogen (H₂)/ethylene (C₂^{═}) mol ratio, a second amount of one or more induced condensing agents, a second delta melt initiation temperature (dMIT), a second amount of one or more continuity additives, or a combination thereof.

In various embodiments, the transitional set of polymerization conditions comprises a transitional reactor temperature, a transitional reactor pressure, a transitional ethylene monomer feed rate, a transitional comonomer type and feed rate, a transitional catalyst type and feed rate, a transitional comonomer/ethylene (C₂^{═}) mol ratio, a transitional rate of addition of hydrogen, a transitional hydrogen (H₂)/ethylene (C₂^{═}) mol ratio, a transitional amount of one or more continuity additives, or a combination thereof.

In various embodiments, the transitional reactor temperature is in the range of from a minimum reactor temperature sufficient to initiate polymerization to a maximum transitional reactor temperature of a threshold value below the lower of the first reactor temperature and the second reactor temperature. The threshold value can for example be greater than or equal to 0 °F (0.0 °C), greater than or equal to about 0.9 °F (0.5 °C), greater than or equal to about 1.8 °F (1.0 °C), greater than or equal to about 2.7 °F (1.5 °C), greater than or equal to about 3.6 °F (2.0 °C), or greater than or equal to about 4.5 °F (2.5 °C), below the lower of the first reactor temperature and the second reactor temperature. In yet further examples, transitional reactor temperature can be in the range of from about 0 °F (0 °C) to about 6.8 °F (8.9 °C), from about 0.8 °F (0.4 °C) to about 6.1 °F (8.3 °C), from about 1.6 °F (0.9 °C) to about 5.4 °F (7.8 °C), from about 2.4 °F (1.3 °C) to about 4.6 °F (7.2 °C), of from about 3.2 °F (1.8 °C) to about 5.4 °F (3.9 °C), of from about 4.0 °F (2.2 °C) to about 4.6 °F (3.2 °C), below the lower of the first reactor temperature and the second reactor temperature.

In various embodiments, the transitional reactor pressure is in the range of from a minimum transitional reactor pressure sufficient to initiate polymerization to a maximum transitional reactor pressure of a threshold value below the lower of the first reactor pressure and the second reactor pressure a transitional reactor pressure. In some embodiments, the transitional reactor pressure is less than or equal to 20 barg (2.0 Mpag) or in the range of from 18 barg (1.8 Mpag) to 20 barg (2.0 Mpag) to limit solids carryover into cycle fluid piping and/or equipment.

In various embodiments, a transitional ethylene monomer feed rate is equal to the second ethylene monomer feed rate.

In various embodiments, a transitional comonomer type and feed rate is equal to the second comonomer type and feed rate.

In various embodiments, a transitional catalyst type is the same as the first and second catalyst types, and transitional catalyst feed rate is less than about 50% of the second catalyst feed rate, or in the range of from about 15% to about 45%, from about 20% to about 40%, or from about 25% to about 35%.

In various embodiments, the transitional comonomer/ethylene (C₂) mol ratio is equal to the second comonomer/ethylene (C₂^{═}) mol ratio.

In various embodiments, the transitional rate of addition of hydrogen is equal to the second rate of addition of hydrogen.

### Type 4 Metallocene Catalyst

In some embodiments, the metallocene catalyst is a dual catalyst system comprising a bridged bis-cyclopentadienyl Group 4 metal catalyst and an unbridged bis-cyclopentadienyl Group 4 metal catalyst, as disclosed in one or more of U.S. Pat. Nos. 10,611,867, 10,808,053, and 11,274,196; WIPO Publication WO2019/108327; and U.S. Pub. No. 2021/0238321, the contents of which are fully incorporated by reference herein (and which further include description of relevant mLLDPEs). Such Type 4 catalysts produce polyethylene grades having broad MWD with a broad orthogonal comonomer distribution (“BOCD”), which are referred to herein as a “Broad-BOCD-mLLDPE.”

As mentioned above, other suitable mLLDPEs can have a broad molecular weight distribution (MWD) with a broad orthogonal composition distribution (BOCD). The MWD of these mLLDPEs can range, for example, from about 6.0 to about 10.0, from about 6.4 to about 9.5, from about 6.0 to about 9.0, from about 6.5 to about 10.0, or from 7.0 to 8.5.

These mLLDPEs can have a density in accordance with ASTM D-4703 and ASTM D-1505/ISO 1183 of from about 0.900 g/cm³ to about 0.940 g/cm³, from about 0.910 to about 0.935 g/cm³, from about 0.910 g/cm³ to about 0.930 g/cm³, from about 0.900 g/cm³ to about 0.925 g/cm³, from about 0.900 g/cm³ to about 0.933 g/cm³, from about 0.900 g/cm³ to about 0.920 g/cm³, from about 0.912 g/cm³ to about 0.919 g/cm, from about 0.912 g/cm³ to about 0.938 g/cm³, from about 0.914 g/cm³ to about 0.928 g/cm³, or from about 0.915 g/cm³ to about 0.938 g/cm³.

These mLLDPEs can have a branching index (as defined herein) of g′ᵥᵢₛ≥0.95, ≥0.96, ≥0 97, ≥0.98, ≥0.99 or 1.0, for example, from 0.95 to 1.0, from 0.96 to 1.0, from 0.97 to 0.995, from 0.98 to 0.998, from 0.98 to 0.99, from 0.99 to 1.0. Preferably, the g′ᵥᵢₛ is ≥0.98 or ≥0.995.

Suitable Broad MWD BOCD-mLLDPEs can have a BOCD characterized in that the T₇₅−T₂₅ value is 15 °C or greater, 17.5 °C or greater, 20 °C or greater, 25 °C or greater, 30 °C or greater, 35 °C or greater, 40 °C or greater, or 45 °C or greater, wherein T₂₅ is the temperature (°C) at which 25% of the eluted polymer is obtained and T₇₅ is the temperature (°C) at which 75% of the eluted polymer is obtained in a TREF experiment. For instance, the T₇₅−T₂₅ value for these Broad MWD BOCD-mLLDPEs can be within the range from 30 °C or 35 °C to 55 °C, 55 °C, 60 °C, or 65 °C (with ranges from any foregoing low end to any foregoing high end contemplated).

These mLLDPEs can have a CDBI of less than about 40%, or less than about 35%, or less than about 34%, or less than about 33%. The CDBI can also range from a low of about 15%, 20%, or 25% to a high of about 35%, 37%, or 40%, and the composition distribution (or comonomer distribution) is such that the mLLDPE has a greater amount (wt %) of comonomer incorporated in its longer (higher molecular weight) polymer chains than the amount (wt %) of comonomer incorporated in its shorter (lower molecular weight) polymer chains. As noted already, GPC analytical methods are suitable for determining relative amounts of comonomer incorporation at high and low polymer chains. For an example of some such polymers and discussion of the incorporation of comonomer along their chains, see, e.g., PCT/US2021/072552, filed 22 Nov. 2021, entitled “Medium Density Polyethylene Compositions with Broad Orthogonal Composition Distribution”, and hereby incorporated by reference.

In some embodiments of the method disclosed herein, the catalyst is a Type 4 metallocene catalyst and the first polyethylene is a first broad MWD BOCD-mLLDPE and the second polyethylene is a second broad MWD BOCD-mLLDPE. The first broad MWD BOCD-mLLDPE and the second broad MWD BOCD-mLLDPE can be the same or different broad MWD BOCD-mLLDPE.

For example, the catalyst can be a Type 4 metallocene catalyst and the first polyethylene can be a first broad MWD BOCD-mLLDPE and the second polyethylene can be a second broad MWD BOCD-mLLDPE. The first broad MWD BOCD-mLLDPE and the second broad MWD BOCD-mLLDPE can be the same or different broad MWD BOCD-mLLDPE.

In some embodiments, where a Type 4 metallocene catalyst is employed, the first polyethylene is a first broad MWD BOCD-mLLDPE, and the second polyethylene is a second broad MWD BOCD-mLLDPE. The first broad MWD BOCD-mLLDPE has a first density in the range of from 0.915 g/cm³ to 0.930 g/cm³, and a first melt index (I₂) is in the range of from 0.60 dg/min. to 2.5 dg/min. The second broad MWD BOCD-mLLDPE has a second density is in the range of from 0.915 g/cm³ to 0.930 g/cm³, and a second melt index (I₂) is in the range of from 0.60 dg/min. to 2.5 dg/min.; or a combination thereof.

In various embodiments, the first polyethylene is a broad MWD BOCD-mLLDPE, having associated with it a first set of polymerization conditions comprising a first reactor temperature, a first reactor pressure, a first ethylene monomer feed rate, a first comonomer type and feed rate, a first catalyst type and feed rate, a first comonomer/ethylene (C₂^{═}) mol ratio, a first rate of addition of hydrogen, a first hydrogen (H₂)/ethylene (C₂^{═}) mol ratio, a first amount of one or more continuity additives, or a combination thereof.

In various embodiments, the second polyethylene is a second broad MWD BOCD-mLLDPE, having associated with it a second set of polymerization conditions comprising a second reactor temperature, a second reactor pressure, a second ethylene monomer feed rate, a second comonomer type and feed rate, a second catalyst type and feed rate, a second comonomer/ethylene (C₂^{═}) mol ratio, a second rate of addition of hydrogen, a second hydrogen (H₂/ethylene (C₂^{═}) mol ratio, a second amount of one or more induced condensing agents, a second delta melt initiation temperature (dMIT), a second amount of one or more continuity additives, or a combination thereof.

In various embodiments, the transitional set of polymerization conditions comprises a transitional reactor temperature, a transitional reactor pressure, a transitional ethylene monomer feed rate, a transitional comonomer type and feed rate, a transitional catalyst type and feed rate, a transitional comonomer/ethylene (C₂^{═}) mol ratio, a transitional rate of addition of hydrogen, a transitional hydrogen (H₂)/ethylene (C₂^{═}) mol ratio, a transitional amount of one or more continuity additives, or a combination thereof.

In various embodiments, the transitional reactor temperature is in the range of from a minimum reactor temperature sufficient to initiate polymerization to a maximum transitional reactor temperature of a threshold value below the lower of the first reactor temperature and the second reactor temperature. For instance, the threshold value can be greater than or equal to 0 °F (0 °C), greater than or equal to about 2.0 °F (1.1 °C), greater than or equal to about 4.0 °F (2.2 °C), greater than or equal to about 6.0 °F (3.3 °C), greater than or equal to about 8.0 °F (4.4 °C), or greater than or equal to about 10.0 °F (5.6 °C), below the lower of the first reactor temperature and the second reactor temperature. In yet further examples, transitional reactor temperature can be in the range of from about 0 °F (0 °C) to about 16.0 °F (8.9 °C), from about 2.0 °F (1.1 °C) to about 15.0 °F (8.3 °C), from about 4.0 °F (2.2 °C) to about 14.0 °F (7.8 °C), from about 6.0 °F (3.3 °C) to about 13.0 °F (7.2 °C), of from about 8.0 °F (4.4 °C) to about 12.0 °F (6.7 °C), of from about 10 °F (5.6 °C) to about 11.0 °F (6.1 °C), below the lower of the first reactor temperature and the second reactor temperature.

In various embodiments, the transitional reactor pressure is in the range of from a minimum transitional reactor pressure sufficient to initiate polymerization to a maximum transitional reactor pressure of a threshold value below the lower of the first reactor pressure and the second reactor pressure a transitional reactor pressure, wherein for instance the threshold value can be greater than or equal to 0.5 bar (50 kPa), 1.0 bar (100 kPa), 1.5 bar (150 kPa), or 2.0 bar (200 kPa) below the lower of the first reactor pressure and the second reactor pressure and/or less than or equal to 3.0 bar (300 kPa), 2.5 bar (250 kPa), 2.0 bar (200 kPa), or 1.5 bar (150 kPa), below the lower of the first reactor pressure and the second reactor pressure. The transitional reactor pressure potentially can be less than or equal to 20 barg (2.0 Mpag) or in the range of from 18 barg (1.8 Mpag) to 20 barg (2.0 Mpag) to limit solids carryover into cycle fluid piping and/or equipment.

In various embodiments, a transitional ethylene monomer feed rate is equal to the second ethylene monomer feed rate.

In various embodiments, a transitional comonomer type and feed rate is equal to the second comonomer type and feed rate.

In various embodiments, a transitional catalyst type is the same as the first and second catalyst types, and transitional catalyst feed rate is less than about 50% of the second catalyst feed rate, or in the range of from about 15% to about 45%, from about 20% to about 40%, or from about 25% to about 35%.

In various embodiments, the transitional comonomer/ethylene (C₂^{═}) mol ratio is equal to the second comonomer/ethylene (C₂^{═}) mol ratio.

In various embodiments, the transitional rate of addition of hydrogen is equal to the second rate of addition of hydrogen.

### CERTAIN EMBODIMENTS

A method for restarting a gas phase polymerization process after a processing interruption is disclosed herein. The gas phase polymerization process comprises adding a catalyst, an ethylene monomer, and optionally a comonomer, to a fluidized bed in a polymerization reaction zone under a first set of polymerization conditions and withdrawing a first polyethylene having a first density and first melt index (I₂). The method disclosed herein is applicable when the polymerization process must be shut down due to an upset in an ancillary system upstream and/or downstream of the reactor while the cycle fluid recirculation compressor is still operational. In a first set of embodiments, after such shutdown of a gas phase polymerization process, a method for restarting the polymerization process without emptying and/or opening the reactor comprises:
a) terminating the polymerization reaction using a polymerization neutralizer:
b) terminating:
   i) the addition of the catalyst, the ethylene monomer, and the optional comonomer to the fluidized bed, and
   ii) the withdrawal of the first polyethylene;
c) idling the polymerization zone by maintaining recirculation of a cycle fluid through the polymerization reaction zone to maintain a superficial velocity sufficient to maintain fluidization of the fluidized bed;
d) starting:
   i) the addition of the catalyst, the ethylene monomer, and optionally the comonomer to the fluidized bed in the polymerization reaction zone under a transitional set of polymerization conditions; and
   ii) the withdrawal of a transitional polyethylene for a threshold number of bed turnovers; and
e) adjusting the rate of addition of the catalyst, the ethylene monomer, and optionally the comonomer to the fluidized bed in the polymerization reaction zone under a second set of polymerization conditions; and
f) withdrawing a second polyethylene having a second density and second melt index (I₂), all of which may be the same as or different from the first polyethylene, the first density, and the first melt index (I₂), respectively.

In further embodiments of the first set of embodiments, the method for restarting the polymerization process is further characterized by the following parameters:
a) the first density is in the range of from 0.910 g/cm³ to 0.940 g/cm³, and the first melt index (I₂) is in the range of from 0.10 dg/min. to 5.0 dg/min.;
b) the second density is in the range of from 0.910 g/cm³ to 0.940 g/cm³, and the first melt index (I₂) is in the range of from 0.10 dg/min. to 5.0 dg/min.; or
c) a combination thereof.

In further embodiments of the first set of embodiments, in addition to any or all of the foregoing, the method for restarting the polymerization process is further characterized by the following parameters:
a) the first set of polymerization conditions comprises:
   i) a first reactor temperature;
   ii) a first reactor pressure;
   iii) a first ethylene monomer feed rate,
   iv) a first comonomer type and feed rate,
   v) a first catalyst type and feed rate,
   vi) a first comonomer/ethylene (C₂^{═}) mol ratio;
   vii) a first rate of addition of hydrogen;
   viii) a first hydrogen (H₂)/ethylene (C₂^{═}) mol ratio;
   ix) a first amount of one or more induced condensing agents;
   x) a first delta melt initiation temperature (dMIT);
   xi) a first amount of one or more continuity additives; or
   xii) a combination of any two or more of the foregoing (i)-(xi);
   wherein the first set of polymerization conditions implemented in a selected polymerization reaction zone produces the first polyethylene; and
b) the second set of polymerization conditions comprises:
   i) a second reactor temperature;
   ii) a second reactor pressure;
   iii) a second ethylene monomer feed rate,
   iv) a second comonomer type and feed rate,
   v) a second catalyst type and feed rate,
   vi) a second comonomer/ethylene (C₂) mol ratio;
   vii) a second rate of addition of hydrogen:
   viii) a second hydrogen (H₂)/ethylene (C₂^{═}) mol ratio;
   ix) a second amount of one or more induced condensing agents;
   x) a second delta melt initiation temperature (dMIT);
   xi) a second amount of one or more continuity additives; or
   xii) a combination of any two or more of the foregoing (i)-(ix);
   wherein the second set of polymerization conditions implemented in the selected polymerization reaction zone produces the second polyethylene.

In further embodiments of the first set of embodiments, in addition to any or all of the foregoing, the method for restarting the polymerization process is further characterized by any one or more of the following parameters:
a) a transitional reactor temperature in the range of.
   i) from a minimum transitional reactor temperature sufficient to initiate polymerization and a maximum transitional reactor temperature, which is a threshold value below the lower of the first reactor temperature and the second reactor temperature, wherein in some embodiments, the threshold value is greater than or equal to 0 °F (0 °C), greater than or equal to about 2.0 °F (1.1 °C), greater than or equal to about 4.0 °F (2.2 °C), greater than or equal to about 6.0 °F (3.3 °C), greater than or equal to about 8.0 °F (4.4 °C), or greater than or equal to about 10.0 °F (5.6 °C) below the lower of the first reactor temperature and the second reactor temperature; or
   ii) from about 0 °F (0 °C) to about 16.0 °F (8.9 °C), from about 2.0 °F (1.1 °C) to about 15.0 °F (8.3 °C), from about 4.0 °F (2.2 °C) to about 14.0 °F (7.8 °C), from about 6.0 °F (3.3 °C) to about 13.0 °F (7.2 °C), of from about 8.0 °F (4.4 °C) to about 12.0 °F (6.7 °C), of from about 10 °F (5.6 °C) to about 11.0 °F (6.1 °C), below the lower of the first reactor temperature and the second reactor temperature;
b) a transitional reactor pressure:
   i) in the range of from a minimum transitional reactor pressure sufficient to initiate polymerization and a maximum transitional reactor pressure, which is a threshold value below the lower of the first reactor pressure and the second reactor pressure, wherein in some embodiments, the threshold value is greater than or equal to 0.5 bar (50 kPa), 1.0 bar (100 kPa), 1.5 bar (150 kPa), or 2.0 bar (200 kPa) and/or less than or equal to 3.0 bar (300 kPa), 2.5 bar (250 kPa), 2.0 bar (200 kPa), or 1.5 bar (150 kPa) below the lower of the first reactor pressure and the second reactor pressure; or
   ii) less than or equal to 20 barg (2.0 Mpag) or in the range of from 18 barg (1.8 Mpag) to 20 barg (2.0 Mpag) to limit solids carryover into cycle fluid piping and/or equipment;
c) a transitional ethylene monomer feed rate equal to the second ethylene monomer feed rate;
d) a transitional comonomer type and feed rate equal to the second comonomer type and feed rate;
e) a transitional catalyst type the same as the first and second catalyst types, and transitional catalyst feed rate less than about 50% of the second catalyst feed rate, or in the range of from about 15% to about 45%, from about 20% to about 40%, or from about 25% to about 35%;
f) a transitional comonomer/ethylene (C₂^{═}) mol ratio equal to the second comonomer/ethylene (C₂) mol ratio;
g) a transitional comonomer/ethylene flow ratio equal to the second comonomer/ethylene flow ratio;
h) a transitional hydrogen/ethylene (C₂^{═}) mol ratio equal to the second hydrogen/ethylene (C₂^{═}) mol ratio;
i) a transitional hydrogen/ethylene flow ratio equal to the second hydrogen/ethylene flow ratio;
j) a transitional rate of addition of hydrogen equal to the second rate of addition of hydrogen;
k) a transitional ICA content in the process in the range of from 5 mol % to 15 mol %, from 7 mol % to 13 mol %, or from 9 mol % to 11 mol %, wherein the mol % is based on mol % iC₅ or equivalent as a mol % of the total ethylene, comonomer, and ICA;
l) a transitional dMIT in the range of about −4 °F (−2.2 °C) to about 4 °F (2.2 °C), about −3 °F (−1.7 °C) to about 3 °F (1.7 °C), about −2 °F (−1.1 °C) to about 2 °F (1.1 °C), about −1 °F (−0.6 °C) to about 1 °F (0.6 °C), or about 0 °F (0 °C); and
m) a combination of any two or more of the foregoing (a)-(l).

A second set of embodiments comprises any or all of the first set of embodiments, wherein the catalyst is an unbridged bis-cyclopentadienyl Group 4 and substituted versions thereof. The second set of embodiments can be further characterized by the following parameters:
a) the first density is in the range of from 0.910 g/cm³ to 0.930 g/cm³, and the first melt index (I₂) is in the range of from 0.80 dg/min. to 5.0 dg/min.;
b) the second density is in the range of from 0.910 g/cm³ to 0.930 g/cm³, and the first melt index (I₂) is in the range of from 0.80 dg/min. to 5.0 dg/min.; or
c) a combination thereof.

In further embodiments of the second set of embodiments, in addition to any or all of the foregoing limitations of the second set of embodiments, the method for restarting the polymerization process is further characterized by the following parameters:
a) the first set of polymerization conditions comprises:
   i) a first reactor temperature;
   ii) a first reactor pressure;
   iii) a first ethylene monomer feed rate,
   iv) a first comonomer type and feed rate,
   v) a first catalyst type and feed rate,
   vi) a first comonomer/ethylene (C₂) mol ratio;
   vii) a first rate of addition of hydrogen;
   viii) a first hydrogen (H₂)/ethylene (C₂^{═}) mol ratio;
   ix) a first amount of one or more induced condensing agents;
   x) a first delta melt initiation temperature (dMIT);
   xi) a first amount of one or more continuity additives; or
   xii) a combination of any two or more of the foregoing (i)-(xi);
   wherein the first set of polymerization conditions implemented in a selected polymerization reaction zone produces the first polyethylene; and
b) the second set of polymerization conditions comprises:
   i) a second reactor temperature;
   ii) a second reactor pressure;
   iii) a second ethylene monomer feed rate,
   iv) a second comonomer type and feed rate,
   v) a second catalyst type and feed rate,
   vi) a second comonomer/ethylene (C₂) mol ratio;
   vii) a second rate of addition of hydrogen;
   viii) a second hydrogen (H₂/ethylene (C₂^{═}) mol ratio;
   ix) a second amount of one or more induced condensing agents;
   x) a second delta melt initiation temperature (dMIT);
   xi) a second amount of one or more continuity additives; or
   xii) a combination of any two or more of the foregoing (i)-(xi);
   wherein the second set of polymerization conditions implemented in the selected polymerization reaction zone produces the second polyethylene.

In further embodiments of the second set of embodiments, in addition to any or all of the foregoing limitation of the second set of embodiments, the method for restarting the polymerization process is further characterized by one or more of the following parameters:
a) a transitional reactor temperature in the range of:
   i) from a minimum transitional reactor temperature sufficient to initiate polymerization and a maximum transitional reactor temperature, which is a threshold value below the lower of the first reactor temperature and the second reactor temperature, wherein in some embodiments, the threshold value is greater than or equal to 0 °F (0 °C), greater than or equal to about 1.4 °F (0.75 °C), greater than or equal to about 2.7 °F (1.5 °C), greater than or equal to about 4.1 °F (2.25 °C), greater than or equal to about 5.4 °F (3.0 °C), or greater than or equal to about 6.8 °F (3.75 °C) below the lower of the first reactor temperature and the second reactor temperature; or
   ii) from about 0 °F (0 °C) to about 10 °F (5.6 °C), from about 1.2 °F (0.66 °C) to about 9.0 °F (5.0 °C), from about 2.4 °F (1.32 °C) to about 8.0 °F (4.5 °C), from about 3.6 °F (2.0 °C) to about 7.0 °F (3.9 °C), of from about 4.8 °F (2.6 °C) to about 6.0 °F (3.3 °C), of from about 6.0 °F (3.3 °C) to about 4.9 °F (2.7 °C), below the lower of the first reactor temperature and the second reactor temperature;
b) a transitional reactor pressure:
   i) in the range of from a minimum transitional reactor pressure sufficient to initiate polymerization and a maximum transitional reactor pressure, which is a threshold value below the lower of the first reactor pressure and the second reactor pressure, wherein in some embodiments, the threshold value is greater than or equal to 0.5 bar (50 kPa), 1.0 bar (100 kPa), 1.5 bar (150 kPa), or 2.0 bar (200 kPa) and/or less than or equal to 3.0 bar (300 kPa), 2.5 bar (250 kPa), 2.0 bar (200 kPa), or 1.5 bar (150 kPa) below the lower of the first reactor pressure and the second reactor pressure; or
   ii) less than or equal to 20 barg (2.0 Mpag) or in the range of from 18 barg (1.8 Mpag) to 20 barg (2.0 Mpag) to limit solids carryover into cycle fluid piping and/or equipment;
c) a transitional ethylene monomer feed rate equal to the second ethylene monomer feed rate;
d) a transitional comonomer type and feed rate equal to the second comonomer type and feed rate;
e) a transitional catalyst type the same as the first and second catalyst types, and transitional catalyst feed rate less than about 50% of the second catalyst feed rate, or in the range of from about 15% to about 45%, from about 20% to about 40%, or from about 25% to about 35%;
f) a transitional comonomer/ethylene ((C₂^{═})) mol ratio equal to the second comonomer/ethylene (C₂^{═}) mol ratio;
g) a transitional comonomer/ethylene flow ratio equal to the second comonomer/ethylene flow ratio;
h) a transitional hydrogen/ethylene (C₂) mol ratio equal to the second hydrogen/ethylene (C₂^{═}) mol ratio;
i) a transitional hydrogen/ethylene flow ratio equal to the second hydrogen/ethylene flow ratio;
j) a transitional rate of addition of hydrogen equal to the second rate of addition of hydrogen;
k) a transitional ICA content in the process in the range of from 5 mol % to 15 mol %, from 7 mol % to 13 mol %, or from 9 mol % to 11 mol %, wherein the mol % is based on mol % iC₅ or equivalent as a mol % of the total ethylene, comonomer, and ICA:
l) a transitional dMIT in the range of about −4 °F (−2.2 °C) to about 4 °F (2.2 °C), about −3 °F (−1.7 °C) to about 3 °F (1.7 °C), about −2 °F (−1.1 °C) to about 2 °F (1.1 °C), about −1 °F (−0.6 °C) to about 1 °F (0.6 °C), or about 0 °F (0 °C); and
m) a combination of any two or more of the foregoing (a)-(l).

A third set of embodiments comprises any or all of the first set of embodiments, wherein the catalyst is a bridged bis-cyclopentadienyl Group 4 and substituted versions thereof. The third set of embodiments can be further characterized by the following parameters:
a) the first density is in the range of from 0.918 g/cm³ to 0.940 g/cm³, and the first melt index (I₂) is in the range of from 0.20 dg/min. to 1.2 dg/min.;
b) the second density is in the range of from 0.918 g/cm³ to 0.940 g/cm³, and the first melt index (I₂) is in the range of from 0.20 dg/min. to 1.2 dg/min.; or
c) a combination thereof.

In further embodiments of the third set of embodiments, in addition to any or all of the foregoing limitation of the third set of embodiments, the method for restarting the polymerization process is further characterized by the following parameters:
a) the first set of polymerization conditions comprises:
   i) a first reactor temperature;
   ii) a first reactor pressure;
   iii) a first ethylene monomer feed rate,
   iv) a first comonomer type and feed rate,
   v) a first catalyst type and feed rate,
   vi) a first comonomer/ethylene (C₂^{═}) mol ratio;
   vii) a first rate of addition of hydrogen;
   viii) a first hydrogen (H)/ethylene (C₂) mol ratio;
   ix) a first amount of one or more induced condensing agents;
   x) a first delta melt initiation temperature (dMIT);
   xi) a first amount of one or more continuity additives; or
   xii) a combination of any two or more of the foregoing (i)-(xi);
   wherein the first set of polymerization conditions implemented in a selected polymerization reaction zone produces the first polyethylene; and
b) the second set of polymerization conditions comprises:
   i) a second reactor temperature;
   ii) a second reactor pressure;
   iii) a second ethylene monomer feed rate,
   iv) a second comonomer type and feed rate,
   v) a second catalyst type and feed rate,
   vi) a second comonomer/ethylene (C₂^{═}) mol ratio;
   vii) a second rate of addition of hydrogen;
   viii) a second hydrogen (H₂)/ethylene (C₂^{═}) mol ratio;
   ix) a second amount of one or more induced condensing agents;
   x) a second delta melt initiation temperature (dMIT);
   xi) a second amount of one or more continuity additives; or
   xii) a combination of any two or more of the foregoing (i)-(xi);
   wherein the second set of polymerization conditions implemented in the selected polymerization reaction zone produces the second polyethylene.

In further embodiments of the third set of embodiments, in addition to any or all of the foregoing limitation of the third set of embodiments, the method for restarting the polymerization process is further characterized by one or more of the following parameters:
a) a transitional reactor temperature in the range of:
   i) from a minimum transitional reactor temperature sufficient to initiate polymerization and a maximum transitional reactor temperature, which is a threshold value below the lower of the first reactor temperature and the second reactor temperature, wherein in some embodiments, the threshold value is greater than or equal to 0 °F (0 °C), greater than or equal to about 2.3 °F (1.3 °C), greater than or equal to about 4.5 °F (2.5 °C), greater than or equal to about 6.8 °F (3.8 °C), greater than or equal to about 9.0 °F (5.0 °C), or greater than or equal to about 11.3 °F (6.3 °C) below the lower of the first reactor temperature and the second reactor temperature; or
   ii) from about 0 °F (0 °C) to about 16.9 °F (9.4 °C), from about 2.0 °F (1.1 °C) to about 15.1 °F (8.4 °C), from about 4.0 °F (2.2 °C) to about 3.4 °F (7.4 °C), from about 5.9 °F (3.3 °C) to about 11.6 °F (6.5 °C), of from about 7.9 °F (4.4 °C) to about 9.9 °F (5.5 °C), of from about 9.9 °F (5.5 °C) to about 8.1 °F (4.5 °C), below the lower of the first reactor temperature and the second reactor temperature;
b) a transitional reactor pressure:
   i) in the range of from a minimum transitional reactor pressure sufficient to initiate polymerization and a maximum transitional reactor pressure, which is a threshold value below the lower of the first reactor pressure and the second reactor pressure, or
   ii) less than or equal to 20 barg (2.0 Mpag) or in the range of from 18 barg (1.8 Mpag) to 20 barg (2.0 Mpag) to limit solids carryover into cycle fluid piping and/or equipment;
c) a transitional ethylene monomer feed rate equal to the second ethylene monomer feed rate;
d) a transitional comonomer type and feed rate equal to the second comonomer type and feed rate;
e) a transitional catalyst type the same as the first and second catalyst types, and transitional catalyst feed rate less than about 50% of the second catalyst feed rate, or in the range of from about 15% to about 45%, from about 20% to about 40%, or from about 25% to about 35%;
f) a transitional comonomer/ethylene (C₂^{═}) mol ratio equal to the second comonomer/ethylene (C₂~) mol ratio;
g) a transitional comonomer/ethylene flow ratio equal to the second comonomer/ethylene flow ratio;
h) a transitional hydrogen/ethylene (C₂^{═}) mol ratio equal to the second hydrogen/ethylene (C₂^{═}) mol ratio;
i) a transitional hydrogen/ethylene flow ratio equal to the second hydrogen/ethylene flow ratio;
j) a transitional rate of addition of hydrogen equal to the second rate of addition of hydrogen;
k) a transitional ICA content in the process in the range of from 5 mol % to 15 mol %, from 7 mol % to 13 mol %, or from 9 mol % to 11 mol %, wherein the mol % is based on mol % iC₅ or equivalent as a mol % of the total ethylene, comonomer, and ICA:
l) a transitional dMIT in the range of about −4 °F (−2.2 °C) to about 4 °F (2.2 °C), about −3 °F (−1.7 °C) to about 3 °F (1.7 °C), about −2 °F (−1.1 °C) to about 2 °F (1.1 °C), about −1 °F (−0.6 °C) to about 1 °F (0.6 °C), or about 0 °F (0 °C); and
m) a combination of any two or more of the foregoing (a)-(l).

A fourth set of embodiments comprises any or all of the first set of embodiments, wherein the catalyst is a substituted bulky ligand hafnium transition metal metallocene-type catalyst compound and substituted versions thereof. The fourth set of embodiments can be further characterized by the following parameters:
a) the first density is in the range of from 0.910 g/cm³ to 0.920 g/cm³, and the first melt index (I₂) is in the range of from 0.10 dg/min. to 4.0 dg/min.;
b) the second density is in the range of from 0.910 g/cm³ to 0.920 g/cm³, and the first melt index (I₂) is in the range of from 0.10 dg/min. to 4.0 dg/min.; or
c) a combination thereof.

In further embodiments of the fourth set of embodiments, in addition to any or all of the foregoing limitation of the fourth set of embodiments, the method for restarting the polymerization process is further characterized by the following parameters:
a) the first set of polymerization conditions comprises:
   i) a first reactor temperature;
   ii) a first reactor pressure;
   iii) a first ethylene monomer feed rate,
   iv) a first comonomer type and feed rate,
   v) a first catalyst type and feed rate,
   vi) a first comonomer/ethylene (C₂^{═}) mol ratio;
   vii) a first rate of addition of hydrogen;
   viii) a first hydrogen (H₂)/ethylene (C₂^{═}) mol ratio;
   ix) a first amount of one or more induced condensing agents;
   x) a first delta melt initiation temperature (dMIT);
   xi) a first amount of one or more continuity additives; or
   xii) a combination of any two or more of the foregoing (i)-(xi);
   wherein the first set of polymerization conditions implemented in a selected polymerization reaction zone produces the first polyethylene; and
b) the second set of polymerization conditions comprises:
   i) a second reactor temperature;
   ii) a second reactor pressure;
   iii) a second ethylene monomer feed rate,
   iv) a second comonomer type and feed rate,
   v) a second catalyst type and feed rate,
   vi) a second comonomer/ethylene (C₂^{═}) mol ratio;
   vii) a second rate of addition of hydrogen:
   viii) a second hydrogen (H₂)/ethylene (C₂^{═}) mol ratio;
   ix) a second amount of one or more induced condensing agents;
   x) a second delta melt initiation temperature (dMIT);
   xi) a second amount of one or more continuity additives; or
   xii) a combination of any two or more of the foregoing (i)-(xi);
   wherein the second set of polymerization conditions implemented in the selected polymerization reaction zone produces the second polyethylene.

In further embodiments of the fourth set of embodiments, in addition to any or all of the foregoing limitation of the fourth set of embodiments, the method for restarting the polymerization process is further characterized by one or more of the following parameters:
a) a transitional reactor temperature in the range of.
   i) from a minimum transitional reactor temperature sufficient to initiate polymerization and a maximum transitional reactor temperature, which is a threshold value below the lower of the first reactor temperature and the second reactor temperature, wherein in some embodiments, the threshold value is greater than or equal to 0 °F (0.0 °C), greater than or equal to about 0.9 °F (0.5 °C), greater than or equal to about 1.8 °F (1.0 °C), greater than or equal to about 2.7 °F (1.5 °C), greater than or equal to about 3.6 °F (2.0 °C), or greater than or equal to about 4.5 °F (2.5 °C) below the lower of the first reactor temperature and the second reactor temperature; or
   ii) from about 0 °F (0 °C) to about 6.8 °F (8.9 °C), from about 0.8 °F (0.4 °C) to about 6.1 °F (8.3 °C), from about 1.6 °F (0.9 °C) to about 5.4 °F (7.8 °C), from about 2.4 °F (1.3 °C) to about 4.6 °F (7.2 °C), of from about 3.2 °F (1.8 °C) to about 5.4 °F (3.9 °C), of from about 4.0 °F (2.2 °C) to about 4.6 °F (3.2 °C), below the lower of the first reactor temperature and the second reactor temperature;
b) a transitional reactor pressure:
   i) in the range of from a minimum transitional reactor pressure sufficient to initiate polymerization and a maximum transitional reactor pressure, which is a threshold value below the lower of the first reactor pressure and the second reactor pressure, wherein in some embodiments, the threshold value is greater than or equal to 0.5 bar (50 kPa), 1.0 bar (100 kPa), 1.5 bar (150 kPa), or 2.0 bar (200 kPa) and/or less than or equal to 3.0 bar (300 kPa), 2.5 bar (250 kPa), 2.0 bar (200 kPa), or 1.5 bar (150 kPa below the lower of the first reactor pressure and the second reactor pressure); or
   ii) less than or equal to 20 barg (2.0 Mpag) or in the range of from 18 barg (1.8 Mpag) to 20 barg (2.0 Mpag) to limit solids carryover into cycle fluid piping and/or equipment;
c) a transitional ethylene monomer feed rate equal to the second ethylene monomer feed rate;
d) a transitional comonomer type and feed rate equal to the second comonomer type and feed rate;
e) a transitional catalyst type the same as the first and second catalyst types, and transitional catalyst feed rate less than about 50% of the second catalyst feed rate, or in the range of from about 15% to about 45%, from about 20% to about 40%, or from about 25% to about 35%;
f) a transitional comonomer/ethylene (C₂^{═}) mol ratio equal to the second comonomer/ethylene (C₂^{═}) mol ratio;
g) a transitional comonomer/ethylene flow ratio equal to the second comonomer/ethylene flow ratio;
h) a transitional hydrogeniethylene (C₂^{═}) mol ratio equal to the second hydrogen/ethylene (C₂^{═}) mol ratio;
i) a transitional hydrogen/ethylene flow ratio equal to the second hydrogen/ethylene flow ratio;
j) a transitional rate of addition of hydrogen equal to the second rate of addition of hydrogen; and
k) a combination of any two or more of the foregoing (a)-(j).

A fifth set of embodiments comprises any or all of the first set of embodiments, wherein the catalyst is a dual catalyst system comprising a bridged bis-cyclopentadienyl Group 4 metal catalyst and an unbridged bis-cyclopentadienyl Group 4 metal catalyst. The fifth set of embodiments can be further characterized by the following parameters:
a) the first density is in the range of from 0.915 g/cm³ to 0.930 g/cm³, and the first melt index (I₂) is in the range of from 0.60 dg/min. to 2.5 dg/min.;
b) the second density is in the range of from 0.915 g/cm³ to 0.930 g/cm³, and the first melt index (I₂) is in the range of from 0.60 dg/min. to 2.5 dg/min.; or
c) a combination thereof.

In further embodiments of the fifth set of embodiments, in addition to any or all of the foregoing limitation of the fifth set of embodiments, the method for restarting the polymerization process is further characterized by the following parameters:
a) the first set of polymerization conditions comprises:
   i) a first reactor temperature;
   ii) a first reactor pressure;
   iii) a first ethylene monomer feed rate,
   iv) a first comonomer type and feed rate,
   v) a first catalyst type and feed rate,
   vi) a first comonomer/ethylene (C₂^{═}) mol ratio;
   vii) a first rate of addition of hydrogen;
   viii) a first hydrogen (H₂)/ethylene(C₂^{═}) mol ratio;
   ix) a first amount of one or more induced condensing agents;
   x) a first delta melt initiation temperature (dMIT);
   xi) a first amount of one or more continuity additives; or
   xii) a combination of any two or more of the foregoing (i)-(xi);
   wherein the first set of polymerization conditions implemented in a selected polymerization reaction zone produces the first polyethylene; and
b) the second set of polymerization conditions comprises:
   i) a second reactor temperature;
   ii) a second reactor pressure;
   iii) a second ethylene monomer feed rate,
   iv) a second comonomer type and feed rate,
   v) a second catalyst type and feed rate,
   vi) a second comonomer/ethylene (C₂) mol ratio;
   vii) a second rate of addition of hydrogen;
   viii) a second hydrogen (H₂)/ethylene (C₂^{═}) mol ratio;
   ix) a second amount of one or more induced condensing agents;
   x) a second delta melt initiation temperature (dMIT);
   xi) a second amount of one or more continuity additives; or
   xii) a combination of any two or more of the foregoing (i)-(xi);
   wherein the second set of polymerization conditions implemented in the selected polymerization reaction zone produces the second polyethylene.

In further embodiments of the fifth set of embodiments, in addition to any or all of the foregoing limitation of the fifth set of embodiments, the method for restarting the polymerization process is further characterized by one or more of the following parameters:
a) a transitional reactor temperature in the range of:
   i) from a minimum transitional reactor temperature sufficient to initiate polymerization and a maximum transitional reactor temperature, which is a threshold value below the lower of the first reactor temperature and the second reactor temperature, wherein in some embodiments, the threshold value is greater than or equal to 0 °F (0 °C), greater than or equal to about 1.4 °F (0.75 °C), greater than or equal to about 2.7 °F (1.5 °C), greater than or equal to about 4.1 °F (2.25 °C), greater than or equal to about 5.4 °F (3.0 °C), or greater than or equal to about 6.8 °F (3.75 °C), below the lower of the first reactor temperature and the second reactor temperature; or
   ii) from about 0 °F (0 °C) to about 10 °F (5.6 °C), from about 1.2 °F (0.66 °C) to about 9.0 °F (5.0 °C), from about 2.4 °F (1.32 °C) to about 8.0 °F (4.5 °C), from about 3.6 °F (2.0 °C) to about 7.0 °F (3.9 °C), of from about 4.8 °F (2.6 °C) to about 6.0 °F (3.3 °C), of from about 6.0 °F (3.3 °C) to about 4.9 °F (2.7 °C), below the lower of the first reactor temperature and the second reactor temperature;
b) a transitional reactor pressure:
   i) in the range of from a minimum transitional reactor pressure sufficient to initiate polymerization and a maximum transitional reactor pressure, which is a threshold value below the lower of the first reactor pressure and the second reactor pressure, or
   ii) less than or equal to 20 barg (2.0 Mpag) or in the range of from 18 barg (1.8 Mpag) to 20 barg (2.0 Mpag) to limit solids carryover into cycle fluid piping to and/or equipment;
c) a transitional ethylene monomer feed rate equal to the second ethylene monomer feed rate;
d) a transitional comonomer type and feed rate equal to the second comonomer type and feed rate;
e) a transitional catalyst type the same as the first and second catalyst types, and transitional catalyst feed rate less than about 50% of the second catalyst feed rate, or in the range of from about 15% to about 45%, from about 20% to about 40%, or from about 25% to about 35%;
f) a transitional comonomer/ethylene ((C₂^{═})) mol ratio equal to the second comonomer/ethylene (C₂^{═}) mol ratio;
g) a transitional comonomer/ethylene flow ratio equal to the second comonomer/ethylene flow ratio;
h) a transitional hydrogen/ethylene (C₂^{═}) mol ratio equal to the second hydrogen/ethylene (C₂^{═}) mol ratio;
i) a transitional hydrogeniethylene flow ratio equal to the second hydrogen/ethylene flow ratio;
j) a transitional rate of addition of hydrogen equal to the second rate of addition of hydrogen;
k) a combination thereof.

### Test Methods/Polymer Characterization

Density (g/cm³): Density measurements were made following ASTM D-1505.

Dynamic Mechanical Analysis (DMA) rheological measurements (e.g. small-strain (10%) oscillatory shear measurements) were carried out on a dynamic Rheometrics SR5 Stress rotational rheometer with 25 mm diameter parallel plates in a frequency sweep mode under full nitrogen blanketing. The polymer samples are appropriately stabilized with the antioxidant additives and then inserted into the test fixture for at least one minute preheating to ensure the normal force decreasing back to zero. All DMA experiments are conducted at 10% strain, 0.05 to 100 rad/s and 190 °C Orchestrator Software is used to determine the viscoelastic parameters including the storage modulus (G′), loss modulus (G″), phase angle (δ), complex modulus (G″) and complex viscosity (η*). The values of storage modulus G′ were estimated at a constant value of loss modulus G″ at 500 Pa at 190 °C (G′ at G″ (500 Pa). This is to characterize and discriminate the viscoelastic properties of the comparative and inventive copolymers. This test technique provides an opportunity to study the various characteristics of a polymer melt where the elastic and viscous modulus (G′ and G″), viscosity (η*), and tan 6 as a function of dynamic oscillation (frequency) are generated to provide information on the rheological behavior in correlation with the molecular architecture.

Gel permeation chromatography (“GPC”) 4D Methodology.
a) Unless otherwise indicated, the distribution and the moments of molecular weight (M_{w}, Mₙ, M_{z}, M_{w}/Mₙ, etc.), the comonomer content (C₂, C₃, C₆, etc.), the branching index (g′), and CCDI (M_{w}-specific, 5-95, and Mₙ-M_{z}) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (“TCB”) with 300 ppm antioxidant butylated hydroxytoluene (“BHT”) is used as the mobile phase. The TCB mixture is filtered through a 0.1-μm Teflon filter and degassed with an online degasser before entering the GPC instrument. The nominal flow rate is 1.0 ml/min. and the nominal injection volume is 200 μl. The whole system including transfer lines, columns, and detectors are contained in an oven maintained at 145 °C Given amount of polymer sample is weighed and sealed in a standard vial with 80-μl flow marker (heptane) added to it. After loading the vial in the autosampler, polymer is automatically dissolved in the instrument with 8 ml added TCB solvent. The polymer is dissolved at 160 °C with continuous shaking for about 1 hour for most polyethylene samples or 2 hours for polypropylene samples. The TCB densities used in concentration calculation are 1.463 g/mli at room temperature and 1.284 g/ml at 145 °C The sample solution concentration is from 0.2 to 2.0 mg/ml, with lower concentrations being used for higher molecular weight samples. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed to polystyrene (PS) standards ranging from 700 to 10M g/mole. The MW at each elution volume is calculated with following equation:

$$log M = \frac{log ( {K}_{PS} / K )}{α + 1} + \frac{{α}_{PS} + 1}{α + 1} log {M}_{PS} ,$$

where the variables with subscript “PS” stand for polystyrene while those without a subscript are for the test samples. In this method, α_{PS}=0.67 and K_{PS}=0.000175, while a and K for other materials are as calculated and published in literature (Sun, T. et al. Macromolecules 2001, 34, 6812), except that for purposes of this invention and claims thereto, α=0.695 and K=0.000579 for linear ethylene polymers, α=0.705 and K=0.0002288 for linear propylene polymers, α=0.695 and K=0.000181 for linear butene polymers, a is 0.695 and K is 0.000579×(1−0.0087×w2b+0.000018×(w2b)²) for ethylene-butene copolymer where w2b is a bulk weight percent of butene comonomer, a is 0.695 and K is 0.000579×(1−0.0075×w2b) for ethylene-hexene copolymer where w2b is a bulk weight percent of hexene comonomer, and a is 0.695 and K is 0.000579×(1−0.0077×w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dl/g unless otherwise noted.
b) The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1000 total carbons (“CH3/1000TC”) as a function of molecular weight. The short-chain branch (“SCB”) content per 1000TC (“SCB/1000TC”) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

w2=f*SCB/1000TC.
c) The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits} .$$

d) Then the same calibration of the CH₂ and CH₃ signal ratio, as mentioned previously in obtaining the CH₃/1000TC as a function of molecular weight, is applied to obtain the bulk CH₃/1000TC. A bulk methyl chain ends per 1000TC (“bulk CH₃end/1000TC”) is obtained by weight-averaging the chain-end correction over the molecular-weight range. Then

w2b=f*bulk CH3/1000TC,

bulk SCB/1000TC=bulk CH3/1000TC−bulk CH3end/1000TC,

and bulk SCB/1000TC is converted to bulk w2 in the same manner as described above.
e) The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions, Huglin, M. B., Ed.; Academic Press, 1972.):

$$\frac{{K}_{0} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K₀ is the optical constant for the system:

$${K}_{0} = \frac{4 {π}^{2} {{n}^{2} ( dn / dc )}^{2}}{{λ}^{4} {N}_{\hat{}}} .$$

where N_{A} is Avogadro's number, and (dn/dc) is the refractive index increment for the system. The refractive index, n=1.500 for TCB at 145 °C and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.
f) A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, q, for the solution flowing through the viscometer is calculated from their outputs. The intrinsic viscosity, ηₛ, at each point in the chromatogram is calculated from the equation [ηs]=ηₛ/c, where c is concentration and is determined from the IR5 broadband channel output. The viscosity MW at each point is calculated as M=K_{PS}M^{aps+1}/[η], where αₚₛ is 0.67 and Kₚₛ is 0.000175.
g) The branching index (g′ᵥᵢₛ) is calculated using the output of the GPC-IR5-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}} .$$

where the summations are over the chromatographic slices, i, between the integration limits.
h) The branching index g′ᵥⱼₛ is defined as g′ᵥⱼₛ=([η]_{avg})/(KMᵥ^{α}), where Mᵥ is the viscosity-average molecular weight based on molecular weights determined by LS analysis and the K and a are for the reference linear polymer, which are, for purposes of this invention and claims thereto, α=0.695 and K=0.000579 for linear ethylene polymers, α=0.705 and K=0.0002288 for linear propylene polymers, α=0.695 and K=0.000181 for linear butene polymers, α=0.695 and K is 0.000579×(1−0.0087 w2b+0.000018×(w2b)²) for ethylene-butene copolymer where w2b is a bulk weight percent of butene comonomer, a is 0.695 and K is 0.000579*(1−0.0075×w2b) for ethylene-hexene copolymer where w2b is a bulk weight percent of hexene comonomer, and a is 0.695 and K is 0.000579*(1−0.0077×w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dl/g unless otherwise noted. Calculation of the w2b values is as discussed above.

High load melt index (g/10 min. or dg/min.): HLMI, also referred to as I₂₁ or I_{21.6} in recognition of the 21.6 kg loading used in the test, was measured according to ASTM D-1238, 190 °C, 21.6 kg.

Melt index (g/10 min. or dg/min.): MI, also referred to as I₂ or I_{2.16} in recognition of the 2.16 kg loading used in the test, was measured according to ASTM D-1238, 190 °C, 2.16 kg.

Small angle oscillatory shear (“SAOS”) frequency sweep melt rheology experiments were performed at 190 °C using a 25 mm cone)(1° and plate configuration on a MCR301 controlled strain/stress rheometer (Anton Paar GmbH). Sample test disks (25 mm diameter, 1 mm thickness) were prepared via compression molding of pellets (which where necessary can be made from fiber samples) at 190 °C using a Schwaben Than laboratory press (200T). Typical cycle for sample preparation is 1 minute without pressure followed by 1.5 minute under pressure (50 bars) and then cooling during 5 minutes between water cooled plates. The sample was first equilibrated at 190 °C for 13 min to erase any prior thermal and crystallization history. An angular frequency sweep was next performed from 500 rad/s to 0.0232 rad/s using 6 points/decade and a strain value of 10% lying in the linear viscoelastic region determined from strain sweep experiments. All experiments were performed in a nitrogen atmosphere to minimize any degradation of the sample during rheological testing.

### EXAMPLES

The following examples are included to demonstrate some embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Experimental Materials

Materials used in Examples 1-4 are shown in Table 1 below.

TABLE 1

| Polyethylene | Density | MI | |
|---|---|---|---|
| Grade | (g/cm³) | (dg/min*) | Catalyst |
| A | 0.912 | 1.0 | Type 1 |
| B | 0.915 | 3.5 | Type 1 |
| C | 0.918 | 1.0 | Type 1 |
| D | 0.918 | 4.5 | Type 1 |
| E | 0.918 | 1.0 | Type 3 |
| F | 0.935 | 0.50 | Type 2 |
| G | 0.927 | 0.30 | Type 2 |

*2.16 kg @ 190 °C

### Example 1

In comparative Example 1, prior to implementing the method disclosed herein, a commercial scale polyethylene gas phase reactor was transitioning from polyethylene grade A to polyethylene grade B. During the transition, there was a high flow excursion on the rate of hydrogen addition to the reactor, which is an example of an operational interruption as described herein. Response to the excursion was insufficient to prevent a shutdown of the polymerization zone triggered by exceeding the kill temperature (Tk) for the relevant polyethylene grade. According to operating guidelines at the time of this shutdown, the reactor was opened for removal of the slumped bed of polymer grade A, due to known fouling risks associated with polymer grade A, and reloading of the reactor with a grade having a lower fouling risk.

### Examples 2-5

Examples 2-5 show the process parameters and results achieved when the method described herein was implemented. The columns in Tables 2-5 show, for Examples 2-5, respectively, the time window for measurement of each process parameter (e.g., 1^{st}, 2^{nd}, 3^{rd}, and 4^{th} time windows), polyethylene (PE) grades before (in row 1 of the 2^{nd} column) and after (in rows 3-5 of the 2^{nd} column) shutdown of the polymerization process (noting that row 2 corresponds to the 2^{nd} time window, during which the reactor was idled and no PE grade produced), reactor temperature (Rx T), reactor pressure (P), catalyst addition rate (Cat. Rate), PE product withdrawal rate (Prod. Rate), fouling of the distributor plate (% loss of original flow area through distributor plate), PE melt index, I₂, (MI), and bed turnovers for the relevant time window.

The rows in in Tables 2-5 show, for Examples 2-5, respectively, the relevant time windows for which process parameters were measured. The time window for row 1 is (1) hour before shutdown of the polymerization process. The values in row 1 for the process parameters are average values for the time window, except for BTOs, which is a total for the time window. The time window 2 (in row 2) is the time for which the reactor was idled while maintaining a fluidized bed (after time window 1). The values in row 2 are the maximum recorded values of the process parameters measured during the idling time window. The time window for row 3 is the first two (2) BTOs after restart of the polymerization process. The values in row 3 are the maximum recorded values of the process parameters measured during the initial two (2) BTOs. The time window for row 4 of each of Tables 2-5 is the first ten (10) BTOs after restart of the polymerization process, which includes the first two BTOs from row 3 (i.e., the time window for row 4 includes the time window for row 3, plus an additional ~8 BTOs after restart). The values in row 4 for the process parameters are average values for the cumulative time window, except for BTOs, which is a total for the time window.

### Inventive Example 2

Table 2 below shows the results for inventive Example 2. Prior to the unplanned shutdown of the polymerization process, the reactor was producing PE grade A, a PE grade which had previously been deemed to have an unacceptable risk of fouling as discussed in comparative Example 1. After the unplanned shutdown, the reactor was not opened and the bed was not dumped; instead, idling was begun. After idling, the process was successfully restarted in accordance with the methods disclosed herein to produce PE grade C. Fouling before shutdown (row 1) was 22.5%. Fouling after restart and establishment of stable, on-spec operations show fouling at 24.4%. Following the method disclosed herein, distributor plate fouling increased by less than 2%, while opening of the reactor and dumping of the bed was avoided entirely.

TABLE 2

| | | Rx T | Rx P | Cat. | | | | | |
|---|---|---|---|---|---|---|---|---|---|
| Time | | (°F) | (barg) | Rate | Prod. Rate | Fouling | MI | Dens. | |
| Window | PE | (°C) | (MPa) | (kg/h) | (tn/hr) (t/h)* | (%) | (dg/min) | (g/cm³) | BTOs |
| 1 | A | 176.0 | 22.0 | 7.0 | 79.4 | 22.5 | 1.00 | 0.9104 | 47.6 |
| | | 80.0 | 2.20 | | 72.0 | | | | |
| 2 | n/a | 173.7 | 15.1 | n/a | n/a | n/a | n/a | n/a | n/a |
| | | 78.7 | 1.51 | | | | | | |
| 3 | C | 173.8 | 20.0 | 9.1 | 49.8 | 27.7 | 0.99 | 0.9108 | 1.9 |
| | | 78.8 | 2.00 | | 45.2 | | | | |
| 4 | C | 185.7 | 22.0 | 11.4 | 72.2 | 24.4 | 0.91 | 0.9168 | 10.4 |
| | | 85.4 | 2.20 | | 65.5 | | | | |

*tn = ton; t = metric ton

### Comparative Example 3

Table 3 below shows the results for comparative Example 3. Prior to the unplanned shutdown of the polymerization process, the reactor was producing PE grade D. In this example, the cycle fluid recycle compressor was shut off for a few hours during idling, allowing the bed to slump. After idling, the process was restarted to produce PE grade D. Fouling before shutdown (row 1) was 9.4%. Fouling after restart and establishment of stable, on-spec operations show fouling at 25.2%. Not following the method disclosed herein, distributor plate fouling increased by about 16%. Without wishing to be bound by any particular theory, it is believed that reactor peak temperatures higher than required by the method disclosed herein during time windows 2 and/or 3 resulted in an unfavorably high fouling rate.

TABLE 3

| | | Rx T | Rx P | Cat. | | | | | |
|---|---|---|---|---|---|---|---|---|---|
| Time | | (°F) | (barg) | Rate | Prod. Rate | Fouling | MI | Dens. | |
| Window | PE | (°C) | (MPa) | (kg/h) | (tn/hr) (t/h)* | (%) | (dg/min) | (g/cm³) | BTOs |
| 1 | D | 186.8 | 309.1 | 9.9 | 89.1 | 9.4 | 0.94 | 0.9172 | 2.9 |
| | | 86.0 | 30.91 | | 80.8 | | | | |
| 2 | n/a | 189.4 | 304.7 | 0.0 | n/a | n/a | n/a | n/a | n/a |
| | | 87.4 | 30.47 | | | | | | |
| 3 | D | 192.0 | 299.6 | 12.2 | 99.4 | 18.7 | 0.94 | 0.9172 | 4.4 |
| | | 88.9 | 29.96 | | 90.2 | | | | |
| 4 | D | 187.7 | 304.0 | 15.2 | 102.1 | 25.2 | 0.94 | 0.9172 | 10.2 |
| | | 86.5 | 30.40 | | 92.6 | | | | |

*tn = ton; t = metric ton

### Inventive Example 4

Table 4 below shows the results for inventive Example 4. Prior to the unplanned shutdown of the polymerization process, the reactor was producing PE grade E. In this example, the cycle fluid recycle compressor was shut off for a few hours during idling as in comparative Example 3, allowing the bed to slump. After idling, the process was restarted to produce PE grade E. Fouling before shutdown (row 1) was 22.4%. Fouling after restart and establishment of stable, on-spec operations show fouling at 22.9%. Following the method disclosed herein, distributor plate fouling increased by only about 0.5%.

TABLE 4

| | | Rx T | Rx P | Cat. | | | | | |
|---|---|---|---|---|---|---|---|---|---|
| Time | | (°F) | (barg) | Rate | Prod. Rate | Fouling | MI | Dens. | |
| Window | PE | (°C) | (MPa) | (kg/h) | (tn/hr) (t/h)* | (%) | (dg/min) | (g/cm³) | BTOs |
| 1 | E | 172.2 | 19.6 | 3.4 | 24.2 | 22.4 | 0.90 | 0.9174 | 6.3 |
| | | 77.9 | 1.96 | | 22.0 | | | | |
| 2 | n/a | 180.5 | 15.1 | n/a | n/a | n/a | n/a | n/a | n/a |
| | | 82.5 | 1.51 | | | | | | |
| 3 | E | 170.0 | 20.0 | 6.4 | 25.2 | 22.8 | 1.24 | 0.9197 | 2.2 |
| | | 76.6 | 2.00 | | 22.9 | | | | |
| 4 | E | 170.2 | 20.1 | 5.1 | 27.1 | 22.9 | 0.47 | 0.9149 | 5.6 |
| | | 78.8 | 2.01 | | 24.6 | | | | |

*tn = ton; t = metric ton

### Inventive Example 5

Table 5 below shows the results for inventive Example 5. Prior to the unplanned shutdown of the polymerization process, the reactor was producing PE grade F, a PE grade which had previously been deemed to have an unacceptable risk of fouling analogous to comparative Example 1. After idling, the process was successfully restarted using the method disclosed herein to produce PE grade 6. Fouling before shutdown (row 1) was 24.6%. Fouling after restart and establishment of stable, on-spec operations show fouling at 26.3%. Following the method disclosed herein, distributor plate fouling increase by less than 2%.

TABLE 5

| | | Rx T | Rx P | Cat. | | | | | |
|---|---|---|---|---|---|---|---|---|---|
| Time | | (°F) | (barg) | Rate | Prod. Rate | Fouling | MI | Dens. | |
| Window | PE | (°C) | (MPa) | (kg/h) | (tn/hr) (t/h)* | (%) | (dg/min) | (g/cm³) | BTOs |
| 1 | F | 194.9 | 287.8 | 29.0 | 80.2 | 24.6 | 0.46 | 0.9348 | 54.3 |
| | | | | | 72.8 | | | | |
| 2 | n/a | 180.5 | 285.0 | n/a | n/a | n/a | n/a | n/a | n/a |
| 3 | G | 185.2 | 290.7 | 15.0 | 85.4 | 23.6 | 0.47 | 0.9348 | 2.0 |
| | | | | | 77.5 | | | | |
| 4 | G | 191.7 | 289.6 | 20.5 | 108.4 | 26.3 | 0.27 | 0.9279 | 10.3 |
| | | | | | 98.3 | | | | |

*tn = ton; t = metric ton

Although the present invention and its advantages have been described in detail, it should be understood that various changes, substitutions and alterations can be made herein without departing from the spirit and scope of the invention as defined by the appended claims. Ranges for various characteristics and attributes disclosed herein are listed as sequentially narrowing ranges. However, it should be understood that any lower endpoint of any ranges can be paired with any upper endpoint for the same characteristic or attribute, and such pairings are also intended to be disclosed herein. All patents, test procedures, and other documents cited in this application are fully incorporated herein by reference for all jurisdictions in which such incorporation is permitted. Moreover, the scope of the present application is not intended to be limited to the particular embodiments of the processes, machines, means, methods, and/or steps described in the specification. As one of the ordinary skill in the art will readily appreciate from the disclosure of the present invention, processes, machines, means, methods, and/or steps, presently existing or later to be developed that perform substantially the same function or achieve substantially the same result as the corresponding embodiments described herein, may be utilized according to the present invention. Accordingly, the appended claims are intended to include within their scope such processes, machines, means, methods, and/or steps.

What is claimed is:

1. A method for restarting a gas phase polymerization process after a processing interruption, wherein the gas phase polymerization process comprises adding a catalyst, an ethylene monomer, and optionally a comonomer and/or hydrogen, to a fluidized bed in a polymerization reaction zone under a first set of polymerization conditions and withdrawing a first polyethylene having a first density and first melt index (I₂), the method comprising:
a) terminating the polymerization reaction using a polymerization neutralizer;
b) terminating:
i) the addition of the catalyst, the ethylene monomer, and the optional comonomer and/or hydrogen to the fluidized bed; and
ii) the withdrawal of the first polyethylene;
c) idling the polymerization zone by maintaining recirculation of a cycle fluid through the polymerization reaction zone to maintain a superficial velocity sufficient to maintain fluidization of the fluidized bed;
d) starting:
i) the addition of the catalyst, the ethylene monomer, and optionally the comonomer and/or hydrogen to the fluidized bed in the polymerization reaction zone under a transitional set of polymerization conditions; and
ii) the withdrawal of a transitional polyethylene for a threshold number of bed turnovers; and
e) adjusting the rate of addition of the catalyst, the ethylene monomer, and optionally the comonomer and/or hydrogen to the fluidized bed in the polymerization reaction zone under a second set of polymerization conditions; and
f) withdrawing a second polyethylene having a second density and second melt index (I₂), all of which may be the same as or different from the first polyethylene, the first density, and the first melt index (I₂), respectively.

2. The method of claim 1, wherein:
a) the first polyethylene has a first agglomeration risk parameter, wherein the first agglomeration risk parameter indicates a sensitivity of the first polyethylene to fouling and/or sheeting due to deviations in polymerization conditions in the polymerization reaction zone;
b) the second polyethylene has a second agglomeration risk parameter, wherein the second agglomeration risk parameter indicates a sensitivity of the second polyethylene to fouling and/or sheeting due to deviations in polymerization conditions in the polymerization reaction zone; and
c) the first polyethylene and the second polyethylene are selected to satisfy the equation:
$$\frac{{R}_{1} + {R}_{2}}{2} \leq {R}_{T}$$
wherein:
R₁ is first agglomeration risk parameter, wherein risk increases as R₁ increases;
R₂ is first agglomeration risk parameter, wherein risk increases as R₂ increases; and
R_{T} is an agglomeration threshold value for acceptable fouling and/or sheeting risks associated with a particular combination of the selected polymerization reaction zone, the catalyst, and one or more polyethylene grades.

3. The method of claim 1, wherein:
a) the first set of polymerization conditions comprises:
i) a first reactor temperature;
ii) a first reactor pressure;
iii) a first ethylene monomer feed rate;
iv) a first catalyst feed rate;
v) a first comonomer/ethylene (C₂^{═}) mol ratio;
vi) a first comonomer/ethylene flow ratio;
vii) a first hydrogen/ethylene (C₂^{═}) mol ratio;
viii) a first hydrogen/ethylene flow ratio
ix) a first rate of addition of hydrogen; or
x) a combination thereof,
wherein the first set of polymerization conditions implemented in the polymerization reaction zone produces the first polyethylene; and
b) the second set of polymerization conditions comprises:
i) a second reactor temperature
ii) a second reactor pressure;
iii) a second ethylene monomer feed rate;
iv) a second catalyst feed rate;
v) a second comonomer/ethylene (C₂^{═}) mol ratio;
vi) a second comonomer/ethylene flow ratio;
vii) a second hydrogen/ethylene (C₂^{═}) mol ratio;
viii) a second hydrogen/ethylene flow ratio
ix) a second rate of addition of hydrogen; or
x) a combination thereof,
wherein the second set of polymerization conditions implemented in the polymerization reaction zone produces the second polyethylene.

4. The method of claim 1, wherein the transitional set of polymerization conditions comprises one or more of:
a) a transitional reactor temperature in the range from a low of a minimum transitional reactor temperature sufficient to initiate polymerization to a high of a maximum transitional reactor temperature, which is a threshold value below the lower of the first reactor temperature and the second reactor temperature;
b) a transitional reactor pressure in the range from a low of a minimum transitional reactor pressure sufficient to initiate polymerization to a high of a maximum transitional reactor pressure, which is a threshold value below the lower of the first reactor pressure and the second reactor pressure;
c) a transitional ethylene monomer feed rate equal to the second ethylene monomer feed rate;
d) a transitional catalyst feed rate less than about 50% of the second catalyst feed rate;
e) a transitional comonomer/ethylene (C₂^{═}) mol ratio equal to the second comonomer/ethylene (C₂^{═}) mol ratio;
f) a transitional comonomer/ethylene flow ratio equal to the second comonomer/ethylene flow ratio;
g) a transitional hydrogen/ethylene (C₂^{═}) mol ratio equal to the second hydrogen/ethylene (C₂^{═}) mol ratio;
h) a transitional hydrogen/ethylene flow ratio equal to the second hydrogen/ethylene flow ratio; and
i) a transitional rate of addition of hydrogen equal to the second rate of addition of hydrogen.

5. The method of claim 1, wherein the transitional set of polymerization conditions is maintained for a threshold number of bed turnovers.

6. The method of claim 5, wherein the threshold number of bed turnovers is in the range of from 2 to 5.

7. The method of claim 1, wherein the catalyst is an unbridged bis-cyclopentadienyl Group 4 and substituted versions thereof.

8. The method of claim 7, wherein:
a) the transitional reactor temperature has a threshold value greater than or equal to about 1.4 °F (0.75 °C) below the lower of the first reactor temperature and the second reactor temperature; and
b) the transitional reactor pressure has a threshold value greater than or equal to 0.5 bar (50 kPa) below the lower of the first reactor pressure and the second reactor pressure.

9. The method of claim 7, wherein the transitional set of polymerization conditions further comprises:
a) a transitional induced condensing agent (ICA) content in the process in the range of from 5 mol % to 15 mol %, wherein the mol % is based on mol % iC₅ or equivalent as a mol % of the total ethylene, comonomer, and ICA;
b) a transitional delta melt initiation temperature (dMIT) in the range of about −4 °F (−2.2 °C) to about 4 °F (2.2 °C).

10. The method of claim 7, wherein:
a) the first density is in the range of from 0.905 g/cm³ to 0.940 g/cm³, and the first melt index (I₂) is in the range of from 0.10 dg/min. to 5.0 dg/min.;
b) the second density is in the range of from 0.905 g/cm³ to 0.940 g/cm³, and the first melt index (I₂) is in the range of from 0.10 dg/min. to 5.0 dg/min.; or
c) a combination thereof.

11. The method of claim 1, wherein the catalyst is a bridged bis-cyclopentadienyl Group 4 and substituted versions thereof.

12. The method of claim 11, wherein:
a) the transitional reactor temperature has a threshold value greater than or equal to about 2.3 °F (1.3 °C) below the lower of the first reactor temperature and the second reactor temperature; and
b) the transitional reactor pressure has a threshold value greater than or equal to 0.5 bar (50 kPa) below the lower of the first reactor pressure and the second reactor pressure.

13. The method of claim 11, wherein the transitional set of polymerization conditions further comprises:
a) a transitional induced condensing agent (ICA) content in the process in the range of from 5 mol % to 15 mol %, wherein the mol % is based on mol % iC₅ or equivalent as a mol % of the total ethylene, comonomer, and ICA;
b) a transitional delta melt initiation temperature (dMIT) in the range of about −4 °F (−2.2 °C) to about 4 °F (2.2 °C).

14. The method of claim 11, wherein:
a) the first density is in the range of from 0.905 g/cm³ to 0.940 g/cm³, and the first melt index (I₂) is in the range of from 0.10 dg/min. to 3.0 dg/min.;
b) the second density is in the range of from 0.905 g/cm³ to 0.940 g/cm³, and the first melt index (I₂) is in the range of from 0.10 dg/min. to 3.0 dg/min.; or
c) a combination thereof.

15. The method of claim 1, wherein the catalyst is a substituted bulky ligand hafnium transition metal metallocene-type catalyst compound and substituted versions thereof.

16. The method of claim 15, wherein:
a) the transitional reactor temperature has a threshold value greater than or equal to about 0.9 °F (0.5 °C) below the lower of the first reactor temperature and the second reactor temperature; and
b) the transitional reactor pressure has a threshold value greater than or equal to 0.5 bar (50 kPa) below the lower of the first reactor pressure and the second reactor pressure.

17. The method of claim 15, wherein:
a) the first density is in the range of from 0.900 g/cm³ to 0.940 g/cm³, and the first melt index (I₂) is in the range of from 0.10 dg/min. to 5.0 dg/min.;
b) the second density is in the range of from 0.900 g/cm³ to 0.940 g/cm³, and the first melt index (I₂) is in the range of from 0.10 dg/min. to 5.0 dg/min.; or
c) a combination thereof.

18. The method of claim 1, wherein the catalyst is a dual catalyst system comprising a bridged bis-cyclopentadienyl Group 4 metal catalyst and an unbridged bis-cyclopentadienyl Group 4 metal catalyst.

19. The method of claim 18, wherein:
a) the transitional reactor temperature has a threshold value greater than or equal to about 1.4 °F (0.75 °C) below the lower of the first reactor temperature and the second reactor temperature, and
b) the transitional reactor pressure has a threshold value greater than or equal to 0.5 bar (50 kPa) below the lower of the first reactor pressure and the second reactor pressure.

20. The method of claim 18, wherein:
a) the first density is in the range of from 0.900 g/cm³ to 0.940 g/cm³, and the first melt index (I₂) is in the range of from 0.60 dg/min. to 2.5 dg/min.; and
b) the second density is in the range of from 0.900 g/cm³ to 0.940 g/cm³, and the first melt index (I₂) is in the range of from 0.60 dg/min. to 2.5 dg/min.
